(19) United States
(12) Patent Application Publication
(10) Pub. No.: US 2023/0012175 A1
(43) Pub. Date: Jan. 12, 2023

(54) Threshing Status Management System, Method, and Program, and Recording Medium for Threshing State Management Program, Harvester Management System, Harvester, Harvester Management Method and Program, and Recording Medium for Harvester Management Program, Work Vehicle, Work Vehicle Management Method, System, and Program, and Recording Medium for Work Vehicle Management Program, Management System, Method, and Program, and Recording Medium for Management Program

(71) Applicant: Kubota Corporation, Osaka-shi (JP)

(72) Inventors: Shunsuke Edo, Sakai-shi (JP); Jun Adachi, Sakai-shi (JP); Yuki Oda, Sakai-shi (JP); Takehiro Nakanishi, Sakai-shi (JP); Toshiaki Fujita, Sakai-shi (JP); Takanori Hori, Sakai-shi (JP); Haruyuki Teranishi, Sakai-shi (JP)

(21) Appl. No.: 17/785,362

(22) PCT Filed: Oct. 29, 2020
(86) PCT No.: PCT/JP2020/040647

§ 371 Date: Jun. 14, 2022

(30) Foreign Application Priority Data
Dec. 26, 2019 (JP) 2019-237127
Dec. 26, 2019 (JP) 2019-237128
Dec. 26, 2019 (JP) 2019-237131
Dec. 26, 2019 (JP) 2019-237132

(51) Int. Cl. A01D 41/127; G06V 20/10; G06V 10/82; G06V 10/774; G06V 20/56

(52) U.S. Cl. CPC A01D 41/1273; G06V 20/188; G06V 10/82; G06V 10/774; G06V 20/56

(57) ABSTRACT

A threshing state management system includes an image capture unit 80 that captures an image of a threshed material threshed by a threshing apparatus, a state detection neural network 72 that outputs a threshing processing state in the threshing apparatus based on image input data generated based on the captured image from the image capture unit 80, a parameter determination unit 73 that determines a control parameter of the threshing apparatus based on the threshing processing state, and a threshing control unit TU that controls the threshing apparatus based on the control parameter.

### CROSS-REFERNCE TO RELATED APPLICATIONS

This application is the United States national phase of International Application No. PCT/JP2020/040647 filed Oct. 29, 2020, and claims priority to Japanese Patent Application Nos. 2019-237127, 2019-237128, 2019-237131, 2019-237132 filed Dec. 26, 2019, the disclosures of which are hereby incorporated by reference in their entirety.

### BACKGROUND OF THE INVENTION

### Field of the Invention

The present invention relates to a technique for managing the state of a threshing apparatus for performing threshing processing on reaped grain culms.

The present invention also relates to a technique for managing crop loss in a harvester including a harvesting section for harvesting a crop in a field and a storage section for storing the harvested material harvested by the harvesting section.

The present invention also relates to a technique for performing ground work on a predetermined work target.

Furthermore, the present invention relates to a technique for managing a work vehicle that performs ground work on a predetermined work target.

### Description of Related Art

In recent years, threshing control for a combine harvester using AI technology has been proposed. For example, in threshing control for a combine harvester according to US Patent Application Publication No. 2018/0271015 (Patent Document 1), a reinforced learning model is used in which threshing control is performed by calculating adjustment values for a vehicle speed, a sieve opening degree, a winnower rotation speed, and the like based on measured values obtained by a sorting loss sensor, a grain quality sensor, and the like.

Also, a combine reaps planted grain culms, threshes the reaped grain culms, sorts the grains, and stores the sorted grains The threshed material obtained by the threshing drum includes grains, rachis branches (grains with branches), straw waste, straw, and the like, and the grains sorted from the threshed material by the sorting section are conveyed to a grain tank and stored. Note that threshed material other than normal grains (rachis branches, straw waste, etc.) is collectively referred to as non-grains in the present specification. Straw and straw waste are discharged from the body rear portion from the threshing drum or the sorting section. Ideally, it is preferable that only the threshed material other than the grains are discharged from the threshing drum to the outside of the body of the combine, but grains are also discharged together with the threshed material. Such grain loss is called threshing drum loss. Furthermore, not only the grains but also defective grains such as rachis branches and straw waste are mixed in with the threshed material that falls from the threshing drum to the sorting section. The defective grains and straw waste mixed in the sorting section are returned to the threshing processing as a secondary material. Such generation of a secondary material in the sorting section is called sorting loss. In this specification, the threshing drum loss and the sorting loss are collectively referred to as threshing loss. In the combine, the operation devices of the threshing apparatus are adjusted in such a manner as to reduce this threshing loss.

Japanese Patent Application Laid-Open No. 2017-176060 (Patent Document 2) discloses a combine in which feedback control is performed with use of loss amounts calculated by a threshing drum loss sensor and a shaking loss sensor, and a debris transport valve, a chaff sieve, and the vehicle speed are adjusted such that the loss amount falls within a target range. The threshing drum loss sensor, which senses the amount of grains by detecting the load associated with contact with the grains, detects the amount of grains falling from the terminal end of the receiving net laid below the threshing drum. The shaking loss sensor, which is a pressure-sensitive sensor, detects the amount of grains falling from the rear portion of a shake sorting apparatus onto a secondary material collection section.

Japanese Patent Application Laid-Open No. 2013-027340 (Patent Document 3) discloses a combine in which a photographed image of grains stored in the grain tank is subjected to image processing to inspect the state of the grains, mixing-in of foreign matter, and the like, and based on the inspection result, the debris transport valve and the chaff sieve of the threshing apparatus are adjusted.

Also, conventionally, a work vehicle for performing ground work has been used. Examples of this type of work vehicle include a combine that includes a threshing apparatus for threshing the grain culms reaped while traveling, as described in Patent Document 3, and a grain tank for storing the grains threshed by the threshing apparatus.

The combine described in Patent Document 3 is constituted by including a mounting plate for mounting grains in a grain tank, two light sources for emitting light toward both sides of the mounting plate, and an image capture unit that captures a first image of the grains on the mounting plate when light is emitted from one of the two light sources and a second image of the grains on the mounting plate when light is emitted from the other of the two light sources. An image processing means extracts an image showing foreign matter from the first image, calculates the quantity of foreign matter, and calculates the quantity of damaged unhulled rice and the number of rachis branches based on the second image. An adjusting means adjusts the angle of the chaff sieve and the opening and closing of a debris transport valve and a processing drum valve based on the calculated quantity of foreign matter, the quantity of damaged unhulled rice, and the quantity of rachis branches.

### Patent Documents

Patent Document 1: US Patent Application Publication No. 2018/0271015

Patent Document 2: Japanese Patent Application Laid-Open No. 2017-176060

Patent Document 3: Japanese Patent Application Laid-Open No. 2013-027340

In the reinforced learning model for threshing control mounted in the combine according to Patent Document 1, measured values of a large number of sensors for detecting the state of the combine are input, and the appropriate adjustment value for a large number of operating constituent components is output. Due to the operating constituent components being controlled based on this adjustment value, the threshing performance is improved, and as a result, the harvesting performance is improved. However, the number of sensors that measure the measured values input to the reinforced learning model is large, and the calculation load in the sensor signal processing becomes large.

In view of this, there is a need for a technique that enables favorable threshing control even if the number of detection sensors that detect the threshing state is small.

In the threshing control in Patent Document 2, an instantaneous threshing loss amount is measured by a threshing loss sensor composed of the threshing drum loss sensor and the shaking loss sensor, and if the measured value deviates from a target range, the threshing apparatus is adjusted. However, the threshing processing amount changes from moment to moment, and for example, if the threshing processing amount is large, the amount of threshing loss inevitably increases, and therefore if the threshing apparatus is adjusted based on the instantaneous threshing loss amount, there is a problem in that appropriate threshing control is not necessarily achieved.

In the threshing control in Patent Document 3, inspection of the state of grains, mixing-in of foreign matter, and the like is performed by performing image processing on a captured image captured by a camera. This threshing control is advantageous in that the camera installation space is smaller than the installation space of the mechanically-operated threshing loss sensor shown in Patent Document 1. However, this threshing control has the same problem as Patent Document 3 due to the amount of mixed-in foreign matter, which is to be inspected here, also being detected as the instantaneous threshing loss amount.

In view of this, a technique for appropriately managing crop loss is required.

As described above, the technique described in Patent Document 3 calculates the quantity of foreign matter, the quantity of unhulled rice, and the quantity of rachis branches when the harvested grains are conveyed into the grain tank, and adjusts the angle of the chaff sieve and the opening and closing of the debris transport valve and the processing drum valve based on the quantity of foreign matter, the quantity of damaged unhulled rice, and the quantity of rachis branches. For this reason, since the amount of foreign matter, unhulled rice, and rachis branches mixed in the grain tank is not zero, there is room for improvement in reducing the amount of foreign matter, unhulled rice, and rachis branches mixed in the grain tank. That is, there is room for improvement in the work vehicle (e.g., combine) performing ground work (e.g., harvesting work) on a predetermined work target (e.g., a field).

In view of this, a technique capable of appropriately performing ground work is required.

As described above, the technique described in Patent Document 3 calculates the quantity of foreign matter, the quantity of unhulled rice, and the quantity of rachis branches when the harvested grains are conveyed into the grain tank, and adjusts the angle of the chaff sieve and the opening and closing of the debris transport valve and the processing drum valve based on the quantity of foreign matter, the quantity of damaged unhulled rice, and the quantity of rachis branches. On the other hand, in various devices, periodic maintenance is performed to prevent deterioration and failure of various components, but it is not easy for the user to easily distinguish when maintenance is to be performed.

In view of this, a technique for managing a work vehicle capable of performing ground work is required.

### SUMMARY OF THE INVENTION

The threshing state management system according to the present invention, which manages a state of a threshing apparatus for performing threshing processing on grain culms reaped while traveling, includes: an image capture unit configured to capture an image of threshed material threshed by the threshing apparatus; a state detection neural network configured to output a threshing processing state in the threshing apparatus based on image input data generated based on a captured image from the image capture unit; a parameter determination unit configured to determine a control parameter of the threshing apparatus based on the threshing processing state; and a threshing control unit configured to control the threshing apparatus based on the control parameter.

According to this configuration, image input data (a group of pixel values of a captured image, a group of representative values of pixel values in a section obtained by dividing the captured image into a predetermined number, etc.) generated from the captured image of the threshed material processed by the threshing apparatus is input, whereby the threshing processing state is output. The threshing processing state includes, for example, grains and non-grains (non-defined grains such as crushed grains, rachis branches, straw waste, etc.) in the threshed material, the amount of threshed material, threshing loss, and the like. Although an expert in threshing processing can estimate the threshing processing state by viewing the threshed material in the threshing apparatus, the state detection neural network of the present invention performs this estimation more accurately and more rapidly. The parameter determination unit receives input of the threshing processing state output from the state detection neural network, and if the current threshing processing state is to be further improved, determines the control parameter of the threshing apparatus such that the improvement can be realized. The threshing control unit controls the threshing apparatus based on the determined control parameter.

As a factor that affects the threshing processing state, the threshing processing state is more accurately estimated by taking into consideration not only the setting state of the operating constituent component of the threshing apparatus, but also the traveling state such as the speed (vehicle speed) of the body of the combine and the engine speed. Due to this, in one preferred embodiment of the present invention, a travel state sensor configured to detect a travel state is included, in which state input data indicating the travel state generated based on a detection signal from the travel state sensor is input to the state detection neural network.

In one preferred embodiment of the present invention, the state detection neural network is trained using, as training data, a training captured image captured during the threshing processing and an estimated threshing processing state estimated based on the training captured image. The estimated threshing processing state artificially estimated based on the training captured image by an expert in threshing processing or the like is used as the correct answer data of the training data. The state detection neural network trained with use of such training data can estimate a threshing processing state equivalent to that of an expert in threshing processing.

In one preferred embodiment of the present invention, the parameter determination unit is a control neural network configured to receive input of a feature amount vector indicating the threshing processing state, and to output the control parameter. In this configuration, the parameter determination unit that receives the threshing processing state from the state detection neural network is also configured by the neural network, and therefore feature amount vectors that are mutually easy to handle can be used as the respective outputs and inputs as the threshing processing state. That is, the feature amount vector serving as the output of the state detection neural network becomes the input of the control neural network. In this configuration, the state detection neural network and the control neural network can be connected. In the connected state detection neural network and control neural network, batch learning is possible by using the training captured image and the control parameter set that is optimal for the threshing processing state indicated by the training captured image as training data.

In order to estimate the threshing processing state with use of the captured image of the threshed material processed by the threshing apparatus, it is preferable to capture images of the threshed material at a plurality of positions and in a plurality of directions. This is because when such a plurality of captured images are used, the amount of information for estimation increases. Due to this, in one of the preferred embodiments of the present invention, the image capture unit includes a plurality of cameras having respectively different image capture fields of view, and the one state detection neural network corresponds to the plurality of cameras, and all of the image input data corresponding to the captured images from the plurality of cameras is input to the state detection neural network.

In the threshing apparatus, there is a region where a small amount of non-grains (straw waste, etc.) is mixed in with a large amount of grains and a region where a small amount of grains are mixed in with a large amount of non-grains If a plurality of captured images in which such a region is the image capture field of view are used as image input data of the state detection neural network, there is a possibility that estimation of the threshing processing state will become inaccurate. Due to this, in one preferred embodiment, the image capture unit includes a plurality of cameras having respectively different image capture fields of view, and a plurality of the state detection neural networks are included in such a manner as to correspond to the respective plurality of cameras, and individual pieces of image input data corresponding to the captured images from the plurality of cameras are respectively input to the state detection neural networks corresponding to the cameras that are image capture sources, and the threshing processing states that are respectively output from the state detection neural networks are provided to the parameter determination unit.

Also, the threshing state management method according to the present invention is a threshing state management method for managing a state of a threshing apparatus for performing threshing processing on grain culms reaped while traveling, the threshing state management method including: an image capture step of capturing, by an image capture unit, an image of threshed material threshed by the threshing apparatus; a threshing processing state output step of outputting, by a state detection neural network, a threshing processing state in the threshing apparatus, based on image input data generated based on a captured image from the image capture unit; a parameter determination step of determining a control parameter of the threshing apparatus based on the threshing processing state; and a control step of controlling, by a threshing control unit, the threshing apparatus based on the control parameter.

With such a threshing sorting method as well, favorable threshing control is possible.

Also, the threshing state management program according to the present invention is a threshing state management program for managing a state of a threshing apparatus for performing threshing processing on grain culms reaped while traveling, the threshing state management program causing a computer to execute: an image capture function of capturing, by an image capture unit, an image of threshed material threshed by the threshing apparatus; a threshing processing state output function of outputting, by a state detection neural network, a threshing processing state in the threshing apparatus, based on image input data generated based on a captured image from the image capture unit; a parameter determination function of determining a control parameter of the threshing apparatus based on the threshing processing state; and a control function of controlling, by a threshing control unit, the threshing apparatus based on the control parameter.

Favorable threshing control is possible by causing a computer in which such a threshing state management program to execute the threshing state management program.

Also, a recording medium on which the threshing state management program according to the present invention is recorded is a recording medium on which is recorded a threshing state management program for managing a state of a threshing apparatus for performing threshing processing on grain culms reaped while traveling, the threshing state management program causing a computer to execute: an image capture function of capturing, by an image capture unit, an image of threshed material threshed by the threshing apparatus; a threshing processing state output function of outputting, by a state detection neural network, a threshing processing state in the threshing apparatus, based on image input data generated based on a captured image from the image capture unit; a parameter determination function of determining a control parameter of the threshing apparatus based on the threshing processing state; and a control function of controlling, by a threshing control unit, the threshing apparatus based on the control parameter.

Favorable threshing control is possible by installing a threshing state management program on a computer via such a recording medium and causing the computer to realize the threshing state management program.

A harvester management system according to the present invention, which manages harvest loss in a harvester including a harvesting section for harvesting a crop in a field and a storage section for storing the harvested material harvested the harvesting section, includes: a harvest amount measurement unit configured to measure a harvest amount of the harvested material; a loss amount calculation unit configured to calculate a loss amount indicating an amount of loss that occurs while the harvested material is conveyed from the harvesting section to the storage section; and a loss rate calculation unit configured to calculate a loss rate, which is the loss amount per unit harvest amount, based on the harvest amount and the loss amount.

According to this configuration, the harvest amount measured by the harvest amount measurement unit and the loss amount calculated by the loss amount calculation unit are provided to the loss rate calculation unit. The loss rate calculation unit sequentially calculates the loss rate, which is the loss amount per unit harvest amount during harvesting work. When the loss rate is sequentially calculated in this manner, it is possible to control the harvester based on the loss rate. Since the loss rate is a value obtained by dividing the loss amount by the yield, in harvester control based on the loss rate, even if sudden variation in the loss rate occurs, there is less influence on the control, compared to control performed based on direct variation in the loss amount. As a result, harvester control based on the loss rate solves the problems that can occur in the control based on the instantaneous loss amount.

In one preferred embodiment of the present invention, a detection unit configured to detect the loss in a loss region where the loss occurs is included, in which the loss amount calculation unit outputs the loss amount based on a detection result from the detection unit. In this configuration, a detection unit that specifies an already-known loss region where loss occurs while the harvested material is conveyed from the harvesting unit to the storage unit, and detects the loss in the loss region is provided, and therefore, the detection unit can quickly detect the loss in the specified loss region without receiving hardly any adverse influence, such as a disturbance.

Conventionally, the threshing loss in the threshing apparatus has been measured by an impact sensor, which has a drawback that the installation space is large, but in the present invention, in order to solve such a problem, it is proposed that the loss amount is calculated with use of a captured image in the loss region and a neural network, which is a machine learning unit. That is, in one preferred embodiment of the invention, an image capture unit configured to capture an image of the loss region in which the loss occurs is included as the detection unit, and the loss amount calculation unit is included as a neural network configured to output the loss amount based on image input data generated based on the captured image from the image capture unit. This neural network is a machine learning model that is trained such that the loss amount is output based on the ratio of the actual harvested material (e.g., grains) and false harvested material (e.g., non-grains such as rachis branches and straw waste) shown in the photographed image. At that time, in order to improve the reliability of the neural network, it is preferable that the image input data obtained by carrying out pre-processing such as normalization on the sequentially-sent captured images is input as the input data of the neural network.

In one preferred embodiment of the present invention, the neural network is trained using, as training data, training image input data generated based on a training captured image captured during harvesting work performed by the harvester and an estimated loss amount (estimated amount obtained by a skilled professional or expert in harvesting) actually estimated based on the training captured image. That is, at the time of training, the training image input data generated based on the training captured image captured during the harvesting work is used as the input training data, and the loss amount artificially estimated based on the training captured image is used as the output training data (correct answer data). In this configuration, the captured image captured during the actual harvesting work is used as the training captured image, and the estimated loss amount actually estimated by the skilled professional or expert in threshing based on this training captured image is used as the correct answer data, and therefore the threshing control performed based on the loss amount output from the trained neural network is supported by the judgment of a skilled professional or expert in threshing.

One loss region that is suitable for checking loss is an area where a small amount of false harvested material is mixed in with a large amount of actual harvested material, and another one is a region where a small amount of actual harvested material is mixed in with a large amount of false harvested material. For this reason, if image input data obtained based on captured images in which these two different regions are the imaging fields of view is used as the input of the same neural network, there is a possibility that it will be difficult to calculate the loss amount. Due to this, in one preferred embodiment of the present invention, the image capture unit includes a plurality of cameras having respectively different image capture fields of view, and includes a plurality of the neural networks in such a manner as to correspond to the respective plurality of cameras, and the individual pieces of image input data corresponding to the captured images from the plurality of cameras are input to the respective neural networks corresponding to the cameras that are image capture sources. In this configuration, the loss amount in each region is output by a dedicated neural network configured to be suitable for each of the captured images in different regions. Since the loss amounts in different regions are calculated with use of the optimum captured images and dedicated neural networks, highly reliable loss amounts can be obtained.

In the image capture of the loss region where the loss occurs, the amount of information obtained from the captured image increases due to images of the harvested material in the area being captured at various positions and in various image capture directions. Due to this, in one preferred embodiment of the present invention, the image capture unit includes a plurality of cameras having respectively different image capture fields of view, and the one neural network corresponds to the plurality of cameras, and all of the image input data corresponding to the captured images from the plurality of cameras is input to the neural network. In this configuration, a more highly-reliable loss amount is output based on captured images of the harvested material captured at various positions and from various directions.

In one preferred embodiment of the invention, the harvester includes a threshing apparatus configured to perform threshing processing on the harvested material, the harvest amount measurement unit measures a yield, which is an amount of grains obtained from the harvested material, as the harvest amount, and the loss amount calculation unit calculates an amount of threshing loss in the threshing apparatus as the loss amount. In the threshing processing, which is one harvest material processing in the harvester, the harvested culms are separated into grains and straw while passing through the threshing drum. Threshed material such as grain that has fallen down from the threshing drum is further sorted. Straw is sent to the rear of the threshing drum and released from the rear of the body of the combine. At that time, the amount of grains (actual harvested material) mixed in with the straw (false harvested material) sent out from the rear of the threshing drum corresponds to the threshing drum loss, and if the amount of the mixed-in grains is large, it means that the threshing drum loss is large. Also, as a result of the sorting processing, the amount of grains (actual harvested material) that are released to the outside of the machine mixed in with non-grains (false harvested material) as a result of the threshed material that fell from the threshing drum undergoing sorting processing corresponds to the sorting loss, and if the amount of grains released to the outside of the machine is large, it means that the sorting loss is large. Sorting loss and threshing drum loss are collectively referred to as threshing loss. Therefore, it is effective to adopt the threshing loss as the loss amount.

Since the definitions of sorting loss and threshing drum loss are different, if the sorting loss and the threshing drum loss are to be calculated based on captured images, captured images captured in respectively different threshing areas (loss regions) are used. For this reason, in one preferred embodiment of the present invention, the loss region in which the loss occurs includes a threshing drum terminal end region and a sieve case rear end region, and in yet another embodiment, the loss region in which the loss occurs includes a discharging section region where non-grains (straw, straw waste, etc.) other than grains are discharged from the threshing apparatus.

Appropriate control of the harvester is realized when the operation devices of the harvester are automatically adjusted such that the loss rate calculated with use of the loss amount calculated by the neural network (sorting loss amount, threshing drum loss amount, etc.) falls within an allowable range. For this reason, in one preferred embodiment of the present invention, a parameter determination unit configured to determine a control parameter of the harvester based on the loss amount is included. Of course, the parameter determination unit may also determine the control parameter of the harvester based on a combination of the loss amount and the loss rate, or only the loss rate.

The present invention described above is also applied to a harvester. Such a harvester includes: a harvesting section configured to harvest a crop in a field; a storage section configured to store a harvested material harvested by the harvesting section; a harvest amount measurement unit configured to measure a harvest amount of the harvested material; a loss amount calculation unit configured to calculate a loss amount indicating an amount of loss that occurs while the harvested material is conveyed from the harvesting section to the storage section; and a loss rate calculation unit configured to calculate a loss rate, which is the loss amount per unit harvest amount, based on the harvest amount and the loss amount. The harvester according to the present invention can also obtain the above-mentioned various actions and effects.

In one preferred embodiment of the harvester according to the invention, a traveling apparatus, a conveying apparatus configured to convey the harvested material, and a threshing apparatus configured to perform threshing processing on the harvested material are included, and a parameter determination unit is included which is configured to determine a control parameter of at least one of the traveling apparatus, the harvesting section, the conveying apparatus, and the threshing apparatus based on the loss rate. With this configuration, the harvester can improve its harvesting performance due to each operation device being automatically adjusted such that the loss rate falls within the allowable range.

The present invention is also applied to a harvester management method adopted in the above-mentioned harvester management system. Such a harvester management method includes: measuring a harvest amount of a harvested material while performing harvesting work by a harvester including a harvesting section configured to harvest a crop in a field and a storage section configured to store the harvested material harvested by the harvesting section; calculating a loss amount indicating an amount of loss that occurs while the harvested material is conveyed from the harvesting section to the storage section, while the harvesting work is performed by the harvester; and calculating a loss rate, which is the loss amount per unit harvest amount, based on the harvest amount and the loss amount, while the harvesting work is performed by the harvester. The harvester management method according to the present invention can also obtain the above-mentioned various actions and effects.

In one preferred embodiment of the harvester management method according to the present invention, a control parameter of the harvester is determined based on the loss rate while the harvesting work is performed by the harvester. According to this harvester management method, each operation device of the harvester is automatically adjusted such that the loss rate falls within the allowable range, and the harvesting performance is improved.

Also, the harvester management program according to the present invention causes a computer to execute: a measurement function of measuring a harvest amount of a harvested material while harvesting work is performed by a harvester including a harvesting section configured to harvest a crop in a field and a storage section configured to store the harvested material harvested by the harvesting section; a loss amount calculation function of calculating a loss amount indicating an amount of loss that occurs while the harvested material is conveyed from the harvesting section to the storage section, while the harvesting work is performed by the harvester; and a loss rate calculation function of calculating a loss rate, which is the loss amount per unit harvest amount, based on the harvest amount and the loss amount, while the harvesting work is performed by the harvester.

It is possible to appropriately manage harvested material loss by causing a computer in which such a harvester management program is installed to execute the harvester management program.

Also, a recording medium on which the harvester management program according to the present invention is recorded has a harvester management program recorded thereon, the harvester management program being for causing a computer to execute: a measurement function of measuring a harvest amount of a harvested material while harvesting work is performed by a harvester including a harvesting section configured to harvest a crop in a field and a storage section configured to store the harvested material harvested by the harvesting section; a loss amount calculation function of calculating a loss amount indicating an amount of loss that occurs while the harvested material is conveyed from the harvesting section to the storage section, while the harvesting work is performed by the harvester; and a loss rate calculation function of calculating a loss rate, which is the loss amount per unit harvest amount, based on the harvest amount and the loss amount, while the harvesting work is performed by the harvester.

It is possible to appropriately manage harvested material loss by installing a harvester management program on a computer via such a recording medium and causing the computer to realize the harvester management program.

A characteristic configuration of a work vehicle according to the present invention is a work vehicle for performing ground work on a predetermined work target, the work vehicle including: a first information acquisition unit configured to acquire first information including a work condition of the work target in the ground work carried out in the past, a device setting value for setting a capability of a device used in the past ground work, and a work result of the ground work performed in the past ground work; a second information acquisition unit configured to acquire second information including a work condition of the work target in the ground work to be carried out in the future; and a device setting value calculation unit configured to calculate the device setting value for the device to be used in the ground work to be carried out in the future, based on the first information and the second information.

With such a characteristic configuration, appropriate device setting values can be easily set for the device to be used in the ground work to be carried out in the future based on the work conditions, the equipment setting values, and the work results in the ground work carried out in the past and the work conditions in the ground work to be carried out in the future. Accordingly, the ground work can be suitably performed.

Also, it is preferable to include: a setting value instruction unit configured to apply the calculated device setting value to the device when the ground work is to be carried out in the future, in which the setting value instruction unit applies the device setting value in the case where a work site where the past ground work was carried out and a work site where the ground work is to be carried out in the future are the same.

With such a configuration, if the work site is the same, the device setting value calculated by the calculation unit can be automatically set. Accordingly, it is possible to simplify the setting of the device setting value.

Also, it is preferable that the device setting value calculation unit continuously calculates the device setting value while the ground work is being carried out.

With such a configuration, it is possible to set device setting value in real time and set an appropriate device setting value even in the same work site.

Also, it is preferable that the device setting value calculation unit automatically calculates the device setting value as the ground work is carried out.

With such a configuration, the calculated device setting value can be automatically set, and therefore the labor required for the setting can be reduced.

Also, it is preferable that the work condition of the work target includes position information indicating a position of a work site where the ground work is to be performed.

With such a configuration, for example, it is possible to manage appropriate device setting values and work results for each position in the work site, and therefore it is possible to appropriately set the device setting values to be used in the ground work to be carried out in the future.

Also, it is preferable that the ground work is threshing work for performing threshing processing on reaped grain culms reaped in a field, and the device setting value is a control parameter of a threshing apparatus configured to perform the threshing processing.

Also, it is preferable that the calculation of the device setting value for the device to be used in the ground work to be carried out in the future is performed by inputting the first information and the second information to a neural network that has undergone training to calculate the device setting value based on the first information and the predetermined work condition.

With such a configuration, it is possible to calculate the device setting value more appropriately. Accordingly, it becomes possible to more suitably perform the ground work.

Also, the work vehicle management method according to the present invention is a work vehicle management method for managing a work vehicle for performing ground work on a predetermined work target, the work vehicle management method including: a first information acquisition step of acquiring first information including a work condition of the work target in the ground work carried out in the past, a device setting value for setting a capability of a device used in the past ground work, and a work result of the ground work performed in the past ground work; a second information acquisition step of acquiring second information including a work condition of the work target in the ground work to be carried out in the future; and a device setting value calculation step of calculating the device setting value for the device to be used in the ground work to be carried out in the future, based on the first information and the second information.

With such a work vehicle management method as well, it is possible to suitably perform ground work.

Also, the work vehicle management system according to the present invention is a work vehicle management system for managing a work vehicle for performing ground work on a predetermined work target, the work vehicle management system including: a first information acquisition unit configured to acquire first information including a work condition of the work target in the ground work carried out in the past, a device setting value for setting a capability of a device used in the past ground work, and a work result of the ground work performed in the past ground work; a second information acquisition unit configured to acquire second information including a work condition of the work target in the ground work to be carried out in the future; and a device setting value calculation unit configured to calculate the device setting value for the device to be used in the ground work to be carried out in the future, based on the first information and the second information.

With such a work vehicle management system as well, it is possible to suitably perform ground work.

Also, a work vehicle management program according to the present invention is characterized by a work vehicle management program to be executed by a computer for managing a work vehicle for performing ground work on a predetermined work target, the work vehicle management program causing a computer to execute: a first information acquisition function of acquiring first information including a work condition of the work target in the ground work carried out in the past, a device setting value for setting a capability of a device used in the past ground work, and a work result of the ground work performed in the past ground work; a second information acquisition function of acquiring second information including a work condition of the work target in the ground work to be carried out in the future; and a device setting value calculation function of calculating the device setting value for the device to be used in the ground work to be carried out in the future, based on the first information and the second information.

It is possible to suitably perform ground work by causing a computer in which such a work vehicle management program is installed to execute the work vehicle management program.

Also, the recording medium on which the work vehicle management program according to the present invention is recorded is a recording medium on which is recorded a work vehicle management program to be executed by a computer for managing a work vehicle for performing ground work on a predetermined work target, the work vehicle management program causing a computer to execute: a first information acquisition function of acquiring first information including a work condition of the work target in the ground work carried out in the past, a device setting value for setting a capability of a device used in the past ground work, and a work result of the ground work performed in the past ground work; a second information acquisition function of acquiring second information including a work condition of the work target in the ground work to be carried out in the future; and a device setting value calculation function of calculating the device setting value for the device to be used in the ground work to be carried out in the future, based on the first information and the second information.

It is possible to suitably perform ground work by installing a work vehicle management program on a computer via such a recording medium and causing the computer to realize the work vehicle management program.

The characteristic configuration of a management system according to the present invention is a management system for managing a work vehicle for performing ground work on a predetermined work target, the management system including: a first information acquisition unit configured to acquire first information relating to the ground work, the first information having been stored when the ground work was carried out in the past; a second information acquisition unit configured to acquire second information relating to the ground work that is currently being carried out; and a determination unit configured to determine a state of the work vehicle by comparing the first information and the second information.

With such a characteristic configuration, the state of the work vehicle performing the ground work is determined based on the information relating to the ground work carried out in the past and the information relating to the ground work currently being carried out, and therefore it is possible to suitably manage the work vehicle according to the state of the work vehicle.

Also, it is preferable that the first information includes information relating to the work target in the ground work that has already been carried out, and information relating to the work vehicle obtained when the ground work was carried out, and the second information includes information relating to the work target in the ground work that is currently being carried out.

With such a configuration, it is possible to determine the state of the work vehicle with use of not only the information relating to the past and the current work targets but also the information relating to the past ground work. Accordingly, it is possible to more suitably determine the state of the work vehicle.

Also, it is preferable that the determination unit determines whether or not the work vehicle is abnormal as the state of the work vehicle.

With such a configuration, if the work vehicle is not abnormal, ground work can be continuously performed, and if the work vehicle is abnormal, maintenance can be performed.

Also, it is preferable that the determination unit determines a maintenance time of the work vehicle as the state of the work vehicle.

With such a configuration, even if maintenance is not needed immediately, it is possible to predict the time when maintenance of the work vehicle is needed, and therefore it is possible to prevent the work vehicle from breaking down.

Also, it is preferable that a notification unit configured to perform notification of a determination result of the determination unit is included.

With such a configuration, the operator can recognize the determination result. Accordingly, even if there is an abnormality in the work vehicle or maintenance is required, it is possible to prevent the abnormality or maintenance from being overlooked.

Also, it is preferable that a storage unit configured to continuously store a determination result of the determination unit is included.

With such a configuration, by checking the determination result stored in the storage unit, it is possible to easily identify the cause of the failure or the cause requiring maintenance.

Also, it is preferable that the determination of the state of the work vehicle is performed by inputting the first information and the second information to a neural network that has undergone training to determine the state of the work vehicle based on the first information and predetermined information relating to the ground work.

With such a configuration, it is possible to more appropriately determine the state of the work vehicle. Accordingly, it is possible to manage the work vehicle more appropriately.

Also, another characteristic configuration of the management system according to the present invention is a management system for managing a work vehicle for performing ground work on a predetermined work target, the management system including: a first information acquisition unit configured to acquire first information relating to the ground work, the first information having been stored when the ground work was carried out in the past; a second information acquisition unit configured to acquire second information relating to the ground work that is currently being carried out; and a determination unit configured to determine a state of the work vehicle by comparing the first information and the second information, in which the determination unit inputs the first information and the second information to a neural network that has undergone at least one of training to output a determination result indicating that the work vehicle is abnormal if information relating to the ground work performed when the vehicle is abnormal is input as teacher data, and training to output a determination result of a maintenance time of the work vehicle if information relating to the ground work performed when maintenance of the work vehicle is needed is input as teacher data.

With such a characteristic configuration as well, the work vehicle can be managed more appropriately, similarly to the management system described above.

Also, the management method according to the present invention is a management method for managing a work vehicle for performing ground work on a predetermined work target, the management method including: a first information acquisition step of acquiring first information relating to the ground work, the first information having been stored when the ground work was carried out in the past; a second information acquisition step of acquiring second information relating to the ground work that is currently being carried out; and a determination step of determining a state of the work vehicle by comparing the first information and the second information.

With such a management method as well, it is possible to manage a work vehicle capable of performing ground work.

Also, the management program according to the present invention is a management program to be executed by a computer for managing a work vehicle for performing ground work on a predetermined work target, the management program causing a computer to execute: a first information acquisition function of acquiring first information relating to the ground work, the first information having been stored when the ground work was carried out in the past; a second information acquisition function of acquiring second information relating to the ground work that is currently being carried out; and a determination function of determining a state of the work vehicle by comparing the first information and the second information.

It is possible to manage a work vehicle capable of performing ground work by causing a computer on which such a management program is installed to execute the management program.

Also, a recording medium on which the management program according to the present invention is recorded is a recording medium on which is recorded a management program to be executed by a computer for managing a work vehicle for performing ground work on a predetermined work target, the management program causing a computer to execute: a first information acquisition function of acquiring first information relating to the ground work, the first information having been stored when the ground work was carried out in the past; a second information acquisition function of acquiring second information relating to the ground work that is currently being carried out; and a determination function of determining a state of the work vehicle by comparing the first information and the second information.

It is possible to manage a work vehicle capable of performing ground work by installing a management program on a computer via such a recording medium and causing the computer to realize the management program.

Furthermore, the management method according to the present invention is a management method for managing a work vehicle for performing ground work on a predetermined work target, the management method including: a first information acquisition step of acquiring first information relating to the ground work, the first information having been stored when the ground work was carried out in the past; a second information acquisition step of acquiring second information relating to the ground work that is currently being carried out; and a determination step of determining a state of the work vehicle by comparing the first information and the second information, in which the determination step is performed by inputting the first information and the second information are input to a neural network that has undergone at least one of training to output a determination result that the work vehicle is abnormal if information relating to the ground work performed when the vehicle is abnormal is input as teacher data, and training to output a determination result of a maintenance time of the work vehicle if information relating to the ground work performed when maintenance of the work vehicle is needed is input as teacher data.

With such a management method as well, it is possible to manage a work vehicle capable of performing ground work.

Also, a management program according to the present invention is a management program to be executed by a computer for managing a work vehicle for performing ground work on a predetermined work target, the management program including: a first information acquisition function of acquiring first information relating to the ground work, the first information having been stored when the ground work was carried out in the past; a second information acquisition function of acquiring second information relating to the ground work that is currently being carried out; and a determination function of determining a state of the work vehicle by comparing the first information and the second information, in which the determination function is performed by inputting the first information and the second information to a neural network that has undergone at least one of training to output a determination result that the work vehicle is abnormal if information relating to the ground work performed when the work vehicle is abnormal has been input as teacher data, and training to output a determination result of a maintenance time of the work vehicle if information relating to the ground work performed when maintenance of the work vehicle is needed has been input as teacher data.

It is possible to manage a work vehicle capable of performing ground work by causing a computer on which such a management program is installed to execute the management program.

Also, the recording medium on which a management program according to the present invention is recorded is a recording medium on which is recorded a management program to be executed by a computer for managing a work vehicle for performing ground work on a predetermined work target, the management program including: a first information acquisition function of acquiring first information relating to the ground work, the first information having been stored when the ground work was carried out in the past; a second information acquisition function of acquiring second information relating to the ground work that is currently being carried out; and a determination function of determining a state of the work vehicle by comparing the first information and the second information, in which the determination function is performed by inputting the first information and the second information to a neural network that has undergone at least one of training to output a determination result that the work vehicle is abnormal if information relating to the ground work performed when the work vehicle is abnormal has been input as teacher data, and training to output a determination result of a maintenance time of the work vehicle if information relating to the ground work performed when maintenance of the work vehicle is needed has been input as teacher data.

It is possible to manage a work vehicle capable of performing ground work by installing a management program on a computer via such a recording medium and causing the computer to realize the management program.

### BRIEF DESCRIPTION OF THE DRAWINGS

FIG. 1 is a side view of a combine including a threshing apparatus according to a first embodiment.

FIG. 2 is a plan view of the combine including the threshing apparatus according to the first embodiment.

FIG. 3 is a vertical cross-sectional side view of the threshing apparatus according to the first embodiment.

FIG. 4 is a layout drawing of a secondary material discharge port according to the first embodiment.

FIG. 5 is a functional block diagram of a control system of a combine according to the first embodiment.

FIG. 6 is a configuration diagram of a threshing state management unit according to the first embodiment.

FIG. 7 is an enlarged schematic view of a captured image of a threshed material according to the first embodiment.

FIG. 8 is an enlarged schematic diagram of a label image of a threshed material according to the first embodiment.

FIG. 9 is a configuration diagram of a threshing state management unit in another embodiment according to the first embodiment.

FIG. 10 is a configuration diagram of a threshing state management unit in another embodiment according to the first embodiment.

FIG. 11 is a configuration diagram of a threshing state management unit in another embodiment according to the first embodiment.

FIG. 12 is a side view of a combine including a threshing apparatus according to a second embodiment.

FIG. 13 is a plan view of the combine including the threshing apparatus according to the second embodiment.

FIG. 14 is a vertical cross-sectional side view of the threshing apparatus according to the second embodiment.

FIG. 15 is a schematic view showing a layout of a yield measurement device and a taste value measurement device in a grain tank according to the second embodiment.

FIG. 16 is a functional block diagram of a control system of the combine according to the second embodiment.

FIG. 17 is a configuration diagram of a threshing loss management unit according to the second embodiment.

FIG. 18 is an enlarged schematic diagram of a captured image of a threshed material according to the second embodiment.

FIG. 19 is an enlarged schematic diagram of a label image of a threshed material according to the second embodiment.

FIG. 20 is a configuration diagram showing another configuration of the threshing loss management unit according to the second embodiment.

FIG. 21 is a configuration diagram showing yet another configuration of the threshing loss management unit according to the second embodiment.

FIG. 22 is a side view of a combine according to a third embodiment.

FIG. 23 is a plan view of the combine according to the third embodiment.

FIG. 24 is a vertical cross-sectional side view of a threshing apparatus included in the combine according to the third embodiment.

FIG. 25 is a block diagram showing functional parts that perform processing relating to computation of a device setting value according to the third embodiment.

FIG. 26 is an illustrative diagram of an effect on the device setting value according to the third embodiment.

FIG. 27 is a side view of a combine according to a fourth embodiment.

FIG. 28 is a plan view of the combine according to the fourth embodiment.

FIG. 29 is a vertical cross-sectional side view of a threshing apparatus included in the combine according to the fourth embodiment.

FIG. 30 is a block diagram showing functional parts that perform processing relating to determination of a state of a work vehicle according to the fourth embodiment.

### DESCRIPTION OF THE INVENTION

### First Embodiment

Hereinafter, preferred embodiments of the present invention will be described with reference to the drawings. In this embodiment, the threshing state management system is mounted in a combine that performs threshing processing on grain culms reaped while traveling, and determines a control parameter for threshing processing based on the threshing processing state output based on a captured image of the threshed material.

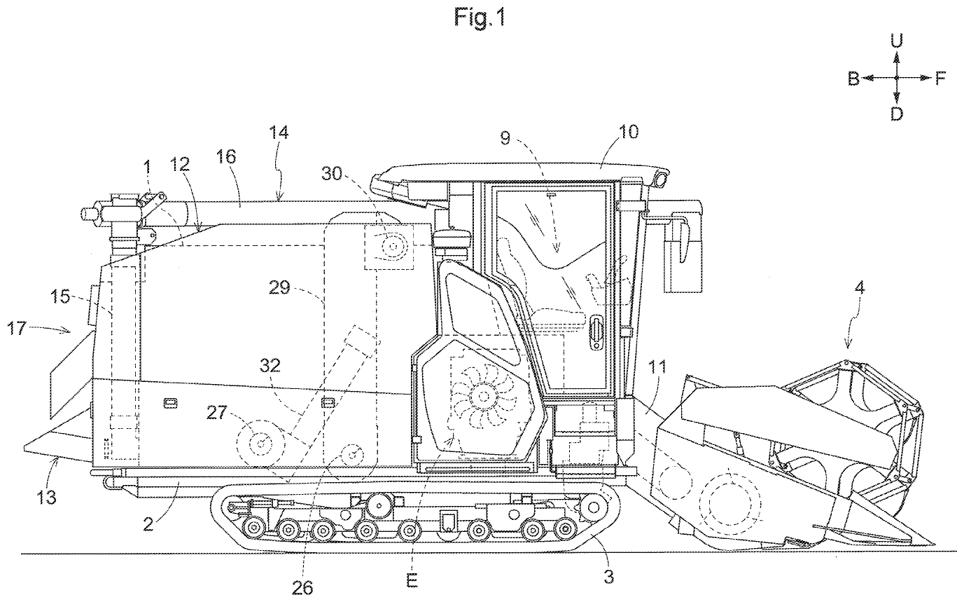

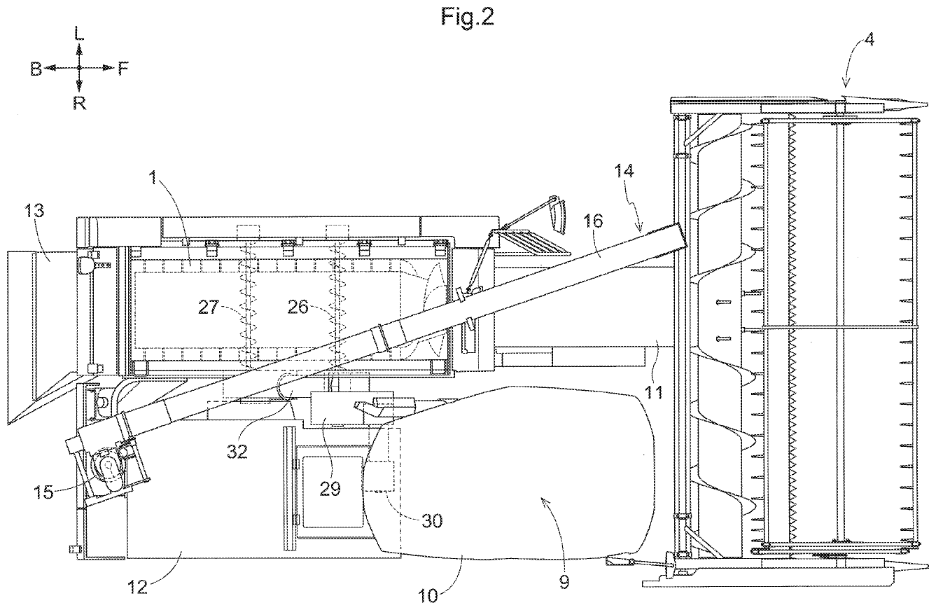

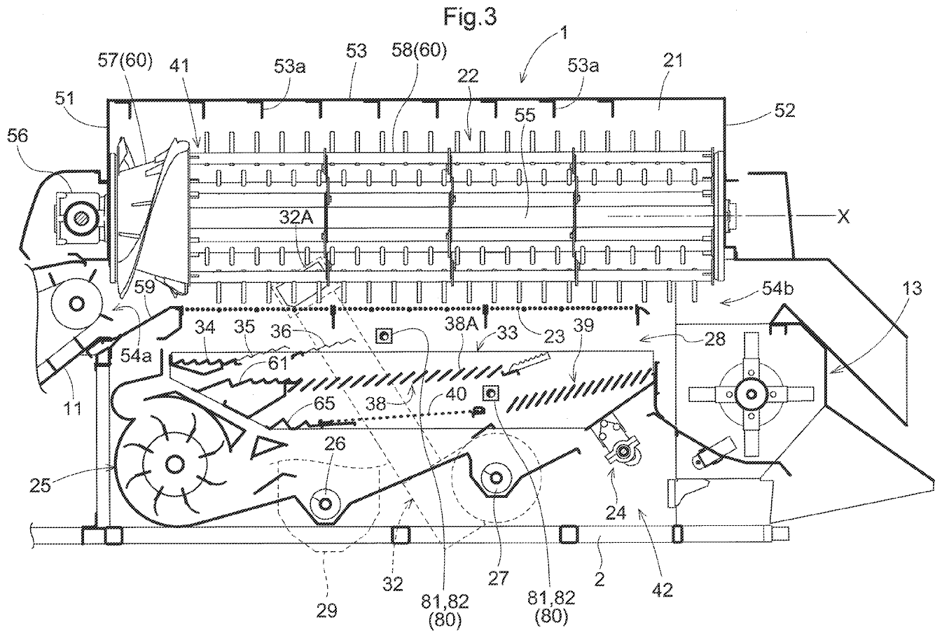

FIG. 1 is a side view of a combine. FIG. 2 is a plan view of the combine. Also, FIG. 3 is a cross-sectional view of a threshing apparatus 1. Note that hereinafter, the combine of the present embodiment is a normal combine, but of course, it may also be a head-feeding combine.

Here, in order to facilitate comprehension, in the present embodiment, unless otherwise specified, “front” (the direction of arrow F shown in FIG. 1) means frontward in the body front-rear direction (traveling direction), and “rear” (the direction of arrow B shown in FIG. 1) means rearward in the body front-rear direction (traveling direction). Also, “up” (the direction of arrow U shown in FIG. 1) and “down” (the direction of arrow D shown in FIG. 1) are in a positional relationship in the body vertical direction (vertical direction), and indicate relationships in the above-ground height. Furthermore, the left-right direction or the lateral direction is the body transverse direction (body width direction) orthogonal to the body front-rear direction, that is, “left” (the direction of arrow L shown in FIG. 2) and “right” (the direction of arrow R shown in FIG. 2) mean the left and right directions of the body of the combine, respectively.

As shown in FIGS. 1 and 2, the combine includes a body frame 2 and a crawler traveling apparatus 3. The combine has a reaping section 4 for reaping planted grain culms in the front of a traveling body 17.

Rearward of the reaping section 4, the combine has a threshing apparatus 1 that performs threshing processing on the reaped grain culms, and a feeder 11 for conveying the reaped grain culms toward the threshing apparatus 1 is provided spanning between the reaping section 4 and the threshing apparatus 1. A grain tank 12 for storing the threshed grains is provided on the side of the threshing apparatus 1, and a straw shredding apparatus 13 is provided rearward of the threshing apparatus 1.

A driving section 9 covered by a cabin 10 is arranged on the front right side of the traveling body 17. An engine E is provided below the driving section 9. The motive power of the engine E is transmitted to the crawler traveling apparatus 3, the threshing apparatus 1, and the like by a motive power transmission structure (not shown). Furthermore, the combine has a grain discharging apparatus 14 for discharging the grains in the grain tank 12 to the outside.

The grain discharging apparatus 14 includes a vertical conveying section 15 that conveys the grains in the grain tank 12 upward, and a lateral conveying section 16 that conveys the grains from the vertical conveying section 15 toward the outside of the body of the combine. The grain discharging apparatus 14 is pivotable about the axis of the vertical conveying section 15. The lower end of the vertical conveying section 15 is in communication with the bottom of the grain tank 12. The end of the lateral conveying section 16 on the vertical conveying section 15 side is in communication with and connected to the upper end of the vertical conveying section 15 and is supported in such a manner as to be swingable up and down.

As shown in FIG. 3, the threshing apparatus 1 includes a threshing drum section 41 for threshing reaped grain culms and a sorting section 42. The threshing drum section 41 is arranged at the upper portion of the threshing apparatus 1, and the sorting section 42 is arranged below the threshing drum section 41. The sorting section 42 includes a shake sorting mechanism 24, a primary material collection section 26, a secondary material collection section 27, and a secondary material returning section 32.

The threshing drum section 41 has a threshing drum 22 accommodated in the threshing chamber 21 and a receiving net 23 laid below the threshing drum 22. The threshing chamber 21 is formed as a space surrounded by a front wall 51 on the front side, a rear wall 52 on the rear side, left and right side walls, and a top plate 53 covering the upper portion. The threshing chamber 21 has a supply port 54a through which reaped grain culms are supplied at a lower position on the front wall 51, and a guiding bottom plate 59 is arranged below the supply port 54a. The threshing chamber 21 also has a debris discharge port 54b on the lower side of the rear wall 52.

The threshing drum 22 has a drum body 60 and a rotation support shaft 55 that are integrally rotated by the driving rotation force from a rotation drive mechanism 56. The drum body 60 is formed by integrating a raking section 57 at the front end and a threshing section 58 located at a position behind the raking section 57.

The top plate 53 has, on its inner surface (lower surface) a plurality of plate-shaped debris transport valves 53a provided at predetermined intervals along the front-rear direction. The plurality of debris transport valves 53a can adjust the rearward movement force acting on the reaped culms that rotate together with the threshing drum 22 in the threshing chamber 21.

The threshed material processed by the threshing drum section 41 includes grains, rachis branches, straw waste, and the like. The primary material is threshed material mainly containing grains, and the secondary material is threshed material containing grains that are not sufficiently processed into simple grains, rachis branches, straw waste, and the like.

In the threshing drum section 41, the harvested material from the feeder 11 is supplied to the threshing chamber 21 via the supply port 54a. The supplied reaped grain culms are raked along the guiding bottom plate 59 by a spiral blade of the raking section 57 and are subjected to threshing processing.

Grains, short straw waste, and the like obtained through the threshing processing leak through the receiving net 23 and fall to the sorting section 42. In contrast to this, the processed material (grain culms, long straw waste, etc.) that cannot leak through the receiving net 23 is discharged from the debris discharge port 54b to the outside of the threshing chamber 21.

The shake sorting mechanism 24 shakes the frame-shaped sieve case 33 in the front-rear direction with an eccentric cam mechanism using an eccentric shaft or the like. The sorting section 42 is provided with a winnower 25 that generates a sorting wind from front to rear. The sieve case 33 is shaken to sort the grains (primary materials) from the threshed material in an environment where the sorting wind is supplied from the winnower 25. Also, the primary material collection section 26 and the secondary material collection section 27 are arranged below the sieve case 33.

The primary material collected by the primary material collection section 26 is conveyed upward (lifted) to the grain tank 12 by a primary material collection/conveying section 29. The primary material conveyed by the primary material collection/conveying section 29 is conveyed to the right by a storage screw 30 (see FIG. 1) and is supplied to the grain tank 12 (see FIG. 1).

The secondary material collection section 27 is formed as a secondary material screw that conveys the collected secondary material in a lateral direction. The secondary material collected by the secondary material collection section 27 is conveyed diagonally upward and to the front by the secondary material return section 32 and is returned to the upper side of the sieve case 33.

The sieve case 33 includes a first grain pan 34, a plurality of first sieve lines 35, a second sieve line 36, a first chaff sieve 38, a second chaff sieve 39, a grain sieve 40, an upper grain pan 61, and a lower grain pan 65.

The first chaff sieve 38 having a plurality of chaff lips 38A is arranged rearward of the upper grain pan 61, and a second chaff sieve 39 is arranged rearward of the first chaff sieve 38. Note that the plurality of chaff lips 38A are arranged side by side along the conveying direction (rearward direction) in which the processed material is conveyed, and each of the plurality of chaff lips 38A is arranged in an inclined orientation of being more diagonally upward toward the rear end side. The lower grain pan 65 is arranged below the front end of the first chaff sieve 38, and the grain sieve 40, which is a net-like body, is arranged at a position continuous with the rear of the lower grain pan 65. The second chaff sieve 39 is arranged below the rear end of the first chaff sieve 38 and rearward of the grain sieve 40. The rear end of the sieve case 33 (the right end in FIG. 3) and the rear end of the receiving net 23 form a discharging section 28.

The first chaff sieve 38 allows the grains included in the threshed material to leak through, while simultaneously conveying the threshed material to the rear side by wind sorting performed with a sorting wind and specific gravity sorting performed accompanying shaking. Culms such as straw waste are delivered to the second chaff sieve 39, are sent out from the rear end of the second chaff sieve 39 to the rear of the sieve case 33, and are discharged toward the waste straw shredding apparatus 13 from the discharging section 28. The culms discharged from the discharging section 28 are shredded by the waste straw shredding apparatus 13 and are discharged to the outside of the threshing apparatus 1. Also, the grains leaking directly to the second chaff sieve 39 via the receiving net 23 are sorted into grains and culms such as straw waste by the second chaff sieve 39.

Processed material containing a large amount of grains is received on the upper surface of grain sieve 40. Since straw waste and the like are sent rearward on the upper surface of the grain sieve 40, most of the threshed material that leaks from the grain sieve 40 is grains, which flow down to the primary material collection section 26 and are collected, and are stored in the grain tank 12 by the primary material collection/conveying section 29. Straw waste and the like in the threshed material that did not leak through the grain sieve 40 are sent rearward by the sorting wind.

In contrast to this, the threshed material that leaked from the portion at the rearmost end of the grain sieve 40 or the threshed material that fell from the second chaff sieve 39 flows down to the secondary material collection section 27, is collected, and is returned to the upstream side of the shake sorting mechanism 24 by the secondary material returning section 32. Then, debris such as straw waste, which serves as a third processed material generated by the sorting processing, is sent rearward from the rear end of the sieve case 33, and is discharged from the discharging section 28 to the waste straw shredding apparatus 13.

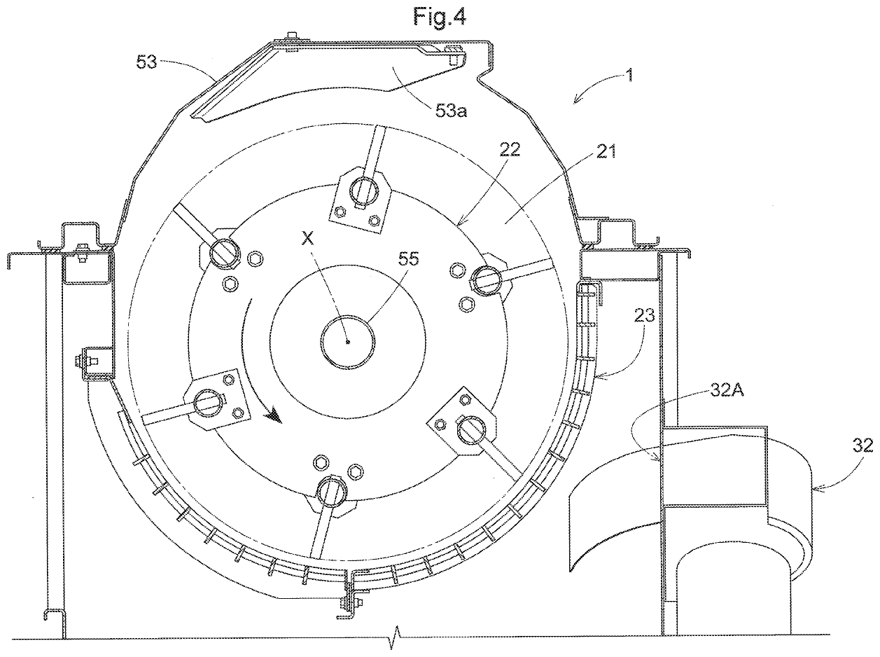

As shown in FIG. 4, the secondary material is returned to a position on a side of the receiving net 23 in the threshing drum section 41. The secondary material discharge port 32A of the secondary material returning section 32 is provided at a position on the outer side in the radial direction of the arc-shaped receiving net 23, and the secondary material is discharged at this position.

As described above, the sorting section 42 has a function of sorting grains from the threshed material, but the sorting capability of the sorting section 42 is changeable. The sorting capability of the shake sorting mechanism 24 can be expressed by the ratio of the amount of the primary material collected by the primary material collection section 26 to the amount of the threshed material that has leaked from the receiving net 23, that is, the sorting degree (or the sorting efficiency).

The sorting capability for sorting grains from the threshed material by the sorting section 42 is changeable by adjusting the opening degree of each of the plurality of chaff lips 38A provided in the first chaff sieve 38 and adjusting the air volume of the winnower 25. Also, in the present embodiment, since the attachment angle of the debris transport valve 53a with respect to the top plate 53 is changeable, the sorting capability is also changeable by adjusting the angle of the debris transport valve 53a. Furthermore, changes in the sorting capability due to the opening degree of the chaff lips 38A and the adjustment of the air volume of the winnower 25 are also related to the amount of threshed material and the amount of returning of the secondary material. The amount of threshed material increases as the amount of reaped grain culms increases, but if the crop state is the same, the faster the vehicle speed is, the larger the amount of the reaped grain culms will be. Due to this, examples of parameters that influence the threshing performance in the threshing apparatus 1 including the sorting capability include the opening degree of the chaff lips 38A, the air volume of the winnower 25, the angle of the debris transport valve 53a, the return amount of the secondary material, and the vehicle speed. The threshing processing state in the threshing apparatus 1 that is required in order to determine these parameters is detected by the constituent components of the threshing state management system.

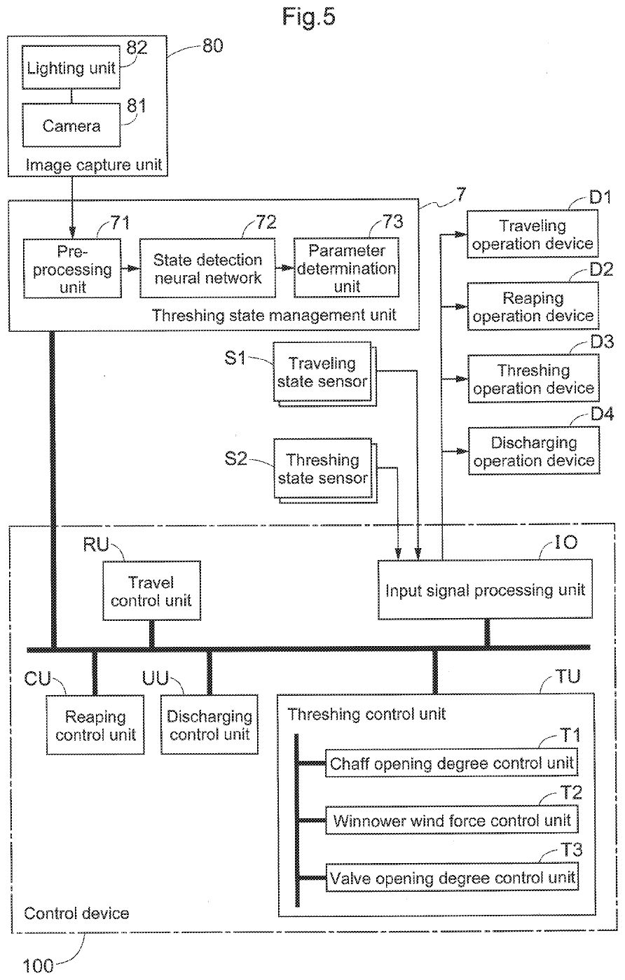

FIG. 5 is a functional block diagram of a control system of the combine. FIG. 5 shows a control device 100, an image capture unit 80, a threshing state management unit 7, various sensors, and various operation devices. A threshing state management system that manages the state of the threshing apparatus 1 is constructed by the image capture unit 80 and the threshing state management unit 7.

The various operation devices include a traveling operation device D1, a reaping operation device D2, a threshing operation device D3, a discharging operation device D4, and the like. The traveling operation device D1 includes an engine operation device, a gear change operation device, and a steering operation device. The reaping operation device D2 includes an operation device that creates the movement of the reaping section 4 and the feeder 11. The threshing operation device D3 is an operation device that creates movement of the threshing drum 22, the shake sorting mechanism 24, the chaff lips 38A, the winnower 25, the debris transport valve 53a, the primary material collection/conveying section 29, and the second item returning section 32, and the like. The discharge operation device D4 includes an operation device that creates the movement of the grain discharging apparatus 14.

Among the various sensors, the sensors particularly relating to the present invention are a traveling state sensor S1 and a threshing state sensor S2. The traveling state sensor S1 detects the operating state of various traveling operation devices D1. The threshing operation device D3 detects the operating states of the threshing drum 22, the shake sorting mechanism 24, the chaff lips 38A, the winnower 25, the primary material collection/conveying section 29, the secondary material returning section 32, and the like. Note that in this embodiment, the traveling state sensor S1 includes a GNSS sensor having a satellite positioning function that receives satellite radio waves and calculates position coordinates.

The control device 100 includes a traveling control unit RU, a reaping control unit CU, a threshing control unit TU, and a discharge control unit UU. The travel control unit RU generates a control signal relating to travel control, and sends the control signal to the travel operation device D1 via an input/output signal processing unit IO to control the traveling of the traveling body 17. In this embodiment, the travel control unit RU includes a vehicle position calculation function that calculates the vehicle position in a field based on the position coordinates output from the GNSS unit, a travel route calculation function that calculates a travel route based on the vehicle position over time, and an automatic traveling function that performs automatic traveling based on the vehicle position. The reaping control unit CU generates a control signal relating to reaping control, and sends the control signal to the reaping operation device D2 via the input/output signal processing unit IO to control the operation of the reaping work.

The threshing control unit TU generates a control signal relating to threshing control, and sends the control signal to the threshing operation device D3 via the input/output signal processing unit IO to control the operation of the threshing work. The threshing control unit TU has a chaff opening degree control unit T1 that adjusts the opening degree of the chaff lips 38A, a winnower wind force control unit T2 that adjusts the wind force of the winnower 25, a valve angle control unit T3 that adjusts the valve angle of the debris transport valve 53a, and the like.

The discharge control unit UU generates a control signal relating to discharge control for discharging grains from the grain tank 12, and sends the control signal to the discharge operation device D4 via the input/output signal processing unit IO to control the operation of the grain discharge work.

The above-mentioned traveling state sensor Si and threshing state sensor S2 also send signals and data to the control device 100 via the input/output signal processing unit IO.

The threshing state management unit 7 inputs a captured image of the threshed material in the threshing apparatus 1 sent from the image capture unit 80, and outputs the threshing processing state of the threshing apparatus 1. The image capture unit 80 includes at least one camera 81 using a CCD image sensor or a CMOS image sensor, and a lighting unit 82 that illuminates the image capture field of view of the camera 81.

The camera 81 is arranged at a position where a captured image suitably showing the state of the threshed material can be captured, for example, a position where an image of an upper region of the first chaff sieve 38 can be captured, or a position where an image of a gap region between the first chaff sieve 38 and the grain sieve 40 can be captured (see FIG. 3).

The threshing state management unit 7 includes a pre-processing unit 71, a state detection neural network 72, and a parameter determination unit 73. The pre-processing unit 71 performs pre-processing such as trimming, color adjustment, and resolution change on the captured image from the image capture unit 80. Furthermore, the threshing apparatus 1 is closed from the outside, and even if the inside thereof is illuminated, debris other than grains is flying around, and therefore it is difficult to maintain constant image capture conditions. For this reason, normalization of the captured image is performed by the pre-processing unit 71. The pre-processing unit 71 further converts the captured image on which the pre-processing has been performed into data suitable for input to the neural network, and provides the captured image to the state detection neural network 72 as image input data.

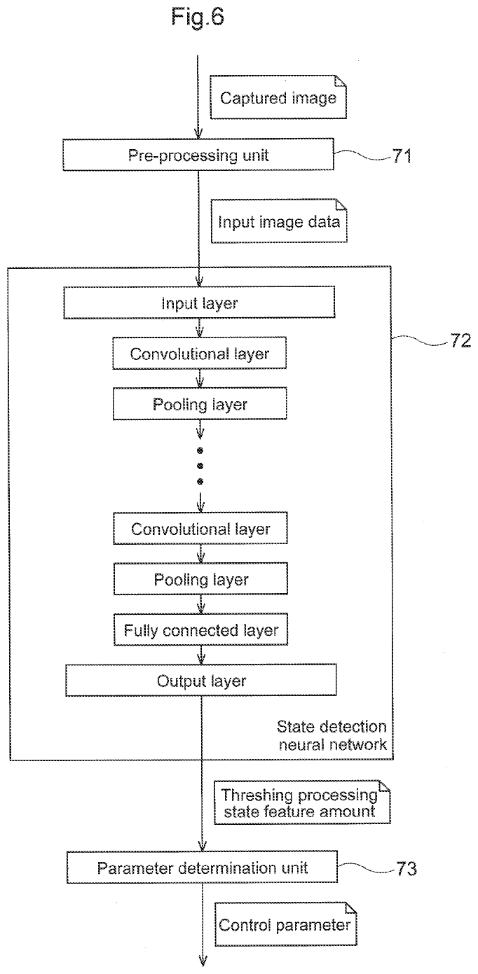

In the first embodiment of the threshing state management unit 7 shown in FIG. 6, the state detection neural network 72 is constituted by a convolutional neural network, preferably deep learning, includes a plurality of convolutional layers, a plurality of pooling layers, and one or more fully connected layers, with an input layer provided on the input side and an output layer provided on the output side. The convolutional layer and the pooling layer repeat multiple times.

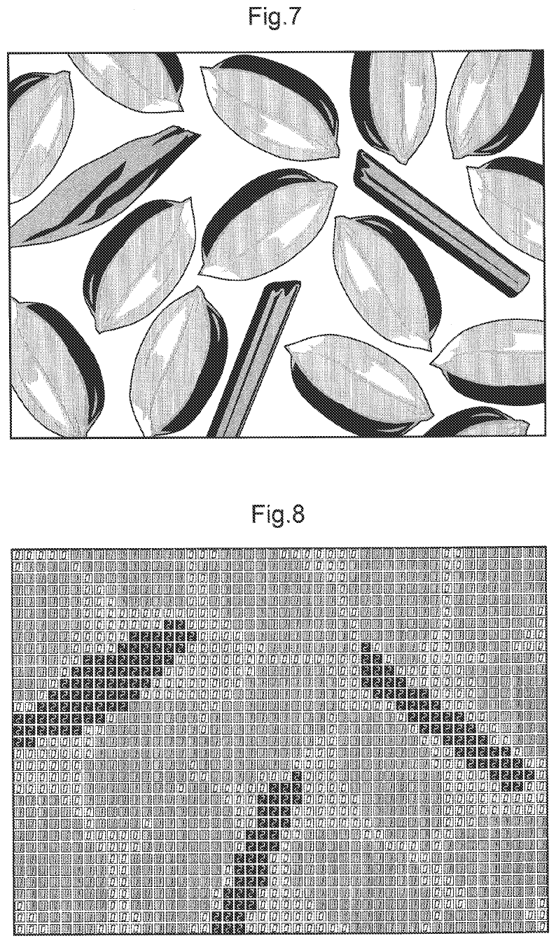

The state detection neural network 72 inputs the image input data generated by the pre-processing unit 71 based on a color captured image, and outputs a threshing processing state feature amount indicating the threshing processing state. An example of the output threshing processing state feature amount is a label image (threshed material distribution image). In the label image, for example, the threshed material in the captured image is divided into grains and non-grains. A pixel indicating a grain is assigned “1”, a pixel indicating a non-grain is assigned “2”, and a pixel indicating the background is assigned “0”. Note that the non-grains include not only rachis branches and straw waste, but also grains having an unspecified shape and grain color, and the like. FIG. 7 shows a partially enlarged schematic diagram of a captured image of the threshed material in a gradation image. FIG. 8 is a label image corresponding to the partially enlarged portion of the captured image shown in FIG. 7. FIGS. 7 and 8 are schematic views for facilitating understanding, and do not correspond to an actual state.

The construction of the state detection neural network 72 is realized by supervised learning using a large number of learning samples (captured images for learning and their label images) serving as training data. A learning sample is constituted by an actual captured image and a label image (estimated threshing processing state) created based on the estimated threshing processing state artificially estimated based on the training captured image by an expert based on the captured image. Note that in a neural network such as deep learning, the more training samples there are, the higher the reliability of the output is. For this reason, in order to increase the number of training samples, not only are the learning captured image obtained by using the actual captured image and its label image used as the training sample, but also a captured image and its label image obtained by implementing image processing for rotation or translation on this training sample are used as additional training samples. Note that what is actually input to the state detection neural network 72 as training data is the learning image input data generated by the pre-processing unit 71 based on the training captured image.

Furthermore, a parameter of a normal distribution or a Gaussian distribution indicating the distribution of grains or non-grains in the threshed material may be output as the threshing processing state, which is the output of the state detection neural network 72. Alternatively, the state detection neural network 72 may be constituted by a semantic segmentation method, the estimation degree of the grains, the non-grains, and the background may be output for each pixel, and image data (vector data) in which the grains, the non-grains, and the background are separated by their contours may be output.

Note that since most of the threshed material to be recognized in the captured image is grain, in order to perform more precise recognition, the pre-processing unit 71 may divide the captured image into a plurality of regions (patch regions) and generate image input data for each region. Alternatively, the image input data may be divided into a plurality of patches in the input layer of the state detection neural network 72.

The parameter determination unit 73 obtains the threshed material distribution state from the label image output from the output layer of the state detection neural network 72 (in actuality, it is vector data in which a pixel value into which the identification value of the threshed material is substituted is used as an element). Also, if the distribution state of the threshed material is different from the distribution state of a reference by a predetermined value or more and it is determined that the threshing performance needs to be improved, the threshing control parameters of the threshing apparatus 1 for improving the threshing performance are determined based on this distribution state. For example, as the ratio of non-grains in the threshed material increases, the threshing processing is considered to be insufficient, and more careful threshing processing is performed through adjustment of the debris transport valve 53a and the like. Also, if the ratio of rachis branches, straw waste, and the like is high, the opening degree of the chaff lips 38A is reduced and the wind force of the winnower 25 is increased so that the rachis branches and straw waste do not fall to the primary material collection section 26.

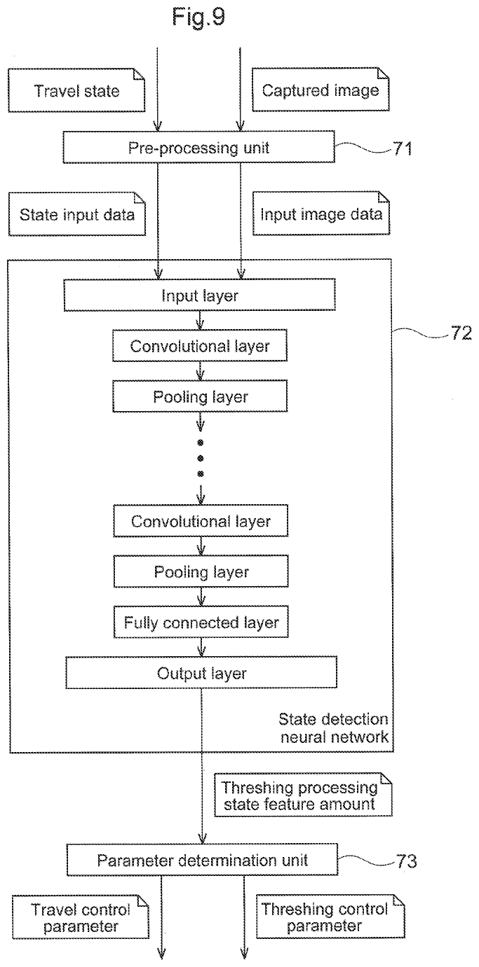

In the second embodiment shown in FIG. 9, not only the captured image but also the detection signal of the traveling state sensor 51 is input to the threshing state management unit 7. The pre-processing unit 71 generates state input data indicating the traveling state (vehicle speed, engine speed, etc.) based on the detection signal of the traveling state sensor 51. The state detection neural network 72 receives the input image data and the state input data as input, and outputs a threshing processing state feature amount. Since the threshing processing state feature amount also includes the relationship between the traveling state and the threshing processing state, the parameter determination unit 73 obtains the threshed material distribution state from the threshing processing state feature amount, and determines the traveling control parameter and the threshing control parameter. In this embodiment, in order to improve the threshing performance, it is also possible to adjust not only the threshing apparatus 1 but also the vehicle speed and the engine speed.

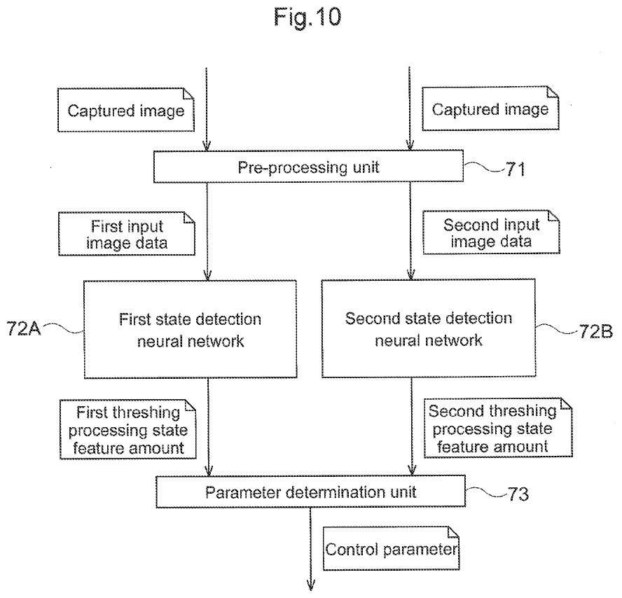

In the third embodiment shown in FIG. 10, individual captured images from two cameras 81 having different image capture fields of view are input to the pre-processing unit 71. In this embodiment, the image capture field of view of each camera 81 is an upper region of the first chaff sieve 38 and a gap region between the first chaff sieve 38 and the grain sieve 40 (lower region of the first chaff sieve 38). Since the mixture of grains and non-grains is different in these two regions, the first state detection neural network 72A for the upper region and the second state detection neural network 72B for the lower region are prepared separately. The first input image data based on the captured image of the upper region is input to the first state detection neural network 72A, and the first threshing processing state feature amount is output. The second input image data based on the captured image of the lower region is input to the second state detection neural network 72B, and the second threshing processing state feature amount is output. The parameter determination unit 73 obtains the threshed material distribution state based on the first threshing processing state feature amount and the second threshing processing state feature amount, and determines the threshing control parameter. Note that as a modification of this embodiment, three or more cameras 81 may also be prepared, and captured images having three or more different image capture fields of view may also be used. In this configuration, the first input image data, the second input image data, . . . , which are individual pieces of image input data corresponding to the captured images from each camera 81, are input to the first state detection neural network 72A, the second state detection neural network 72B, . . . , which correspond to the two cameras 81 that are the image capture sources. Furthermore, the first threshing processing state feature amount (first threshing processing state), the second threshing processing state feature amount (second threshing processing state), . . . , which are output from the first state detection neural network 72A, the second state detection neural network 72B, . . . , are provided to the parameter determination unit 73.

In the third embodiment shown in FIG. 10, a state detection neural network 72 is prepared for each of the captured images captured by the plurality of cameras 81. Alternatively, a configuration may also be adopted in which all of the input image data generated based on the plurality of captured images having these different image capture fields of view are input to the same state detection neural network 72.

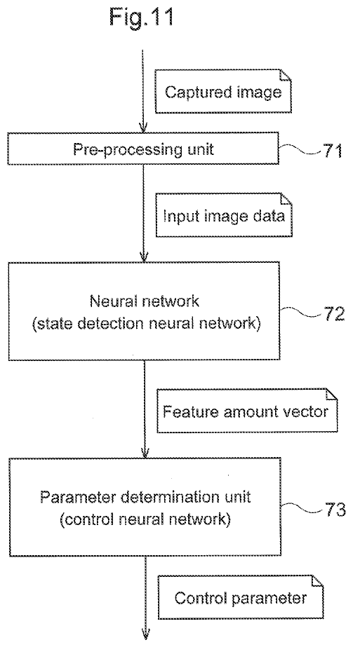

In the fourth embodiment shown in FIG. 11, the parameter determination unit 73 is also constructed by the neural network. That is, the threshing state management unit 7 of this embodiment is constituted by the pre-processing unit 71, the state detection neural network 72, and the parameter determination unit 73 that functions as a control neural network. Since the output layer of the state detection neural network 72 and the input layer of the control neural network (parameter determination unit 73) are directly connected, the output data of the state detection neural network 72 is the input data of the control neural network. For this reason, the output data of the state detection neural network 72 and the input data of the control neural network are common feature amount vectors.

### Other Embodiments

In the above-described embodiment, deep learning, in which input data based on one captured image or a plurality of captured images captured simultaneously are used as input, was used as a neural network. Instead of this, a neural network in which a time-series input image data group based on a time-series captured image may also be used.

In the above-described embodiment, the pre-processing unit 71 and the state detection neural network 72 had different configurations, but the pre-processing unit 71 may also be incorporated in the state detection neural network 72. Furthermore, the pre-processing unit 71, the state detection neural network 72, and the parameter determination unit 73 may also be formed in one piece.

In the above-described embodiment, a threshing state management system was described taking, as an example, a case where the threshing apparatus 1 is mounted in the combine. Instead of this, it is possible to mount the threshing state management system of the present invention in a work vehicle in which the threshing apparatus 1 is different from a combine harvester, or to incorporate the threshing state management system of the present invention into a fixed-type threshing apparatus 1.

Although a combine was described in the above-described embodiment, the processing performed by the functional parts in the above-described embodiment may also be adopted as a threshing state management method. In such a case, the threshing state management method can be a threshing state management method for managing a state of the threshing apparatus 1 that performs threshing processing on grain culms reaped while traveling, the threshing state management method including: an image capture step of capturing an image of threshed material threshed by the threshing apparatus 1 with the image capture unit 80; a threshing processing state output step of outputting a threshing state in the threshing apparatus 1 in a state detection neural network based on image input data generated based on the captured image from the image capture unit 80; a parameter determination step of determining a control parameter of the threshing apparatus 1 based on the threshing processing state; and a control step of controlling the threshing apparatus 1 with the threshing control unit based on the control parameter.

The functional parts in the above-described embodiment may also be adopted as a threshing state management program. In such a case, the threshing state management program can be a threshing state management program for managing a state of the threshing apparatus 1 that performs threshing processing on grain culms reaped while traveling, the threshing state management program causing a computer to execute: an image capture function of capturing an image of threshed material threshed by the threshing apparatus 1 with the image capture unit 80; a threshing processing state output function of outputting a threshing processing state in the threshing apparatus 1 with a state detection neural network based on image input data generated based on the captured image from the image capture unit 80; a parameter determination function of determining a control parameter of the threshing apparatus 1 based on the threshing processing state; and a control function of controlling the threshing apparatus 1 with the threshing control unit based on the control parameter.

Such a threshing state management program can also be recorded on a recording medium.

### Second Embodiment

Hereinafter, preferred embodiments of the present invention will be described with reference to the drawings. In this embodiment, the harvester is a combine that performs threshing processing on grain culms reaped while traveling, and the harvester management system is a threshing management system provided in this combine.

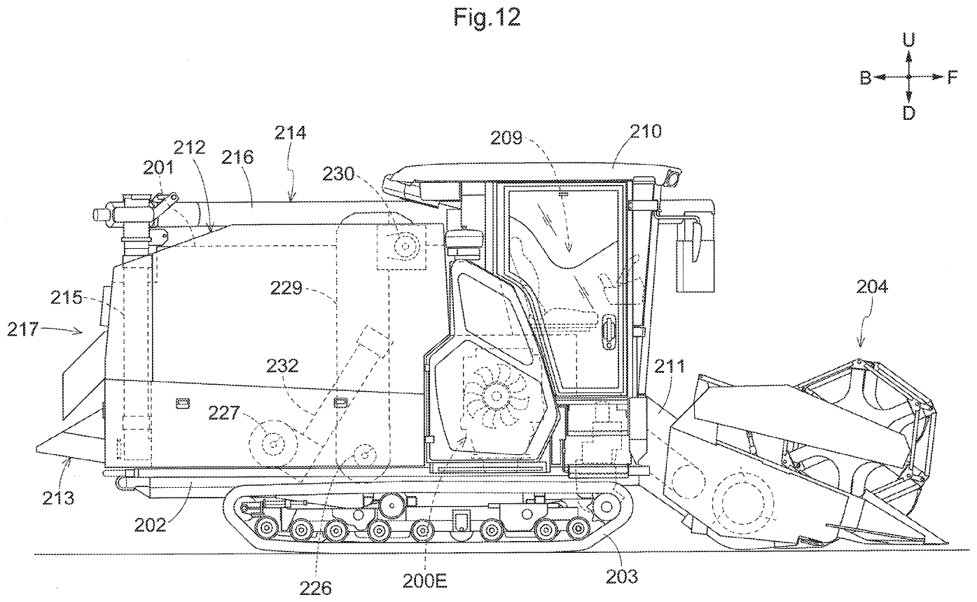

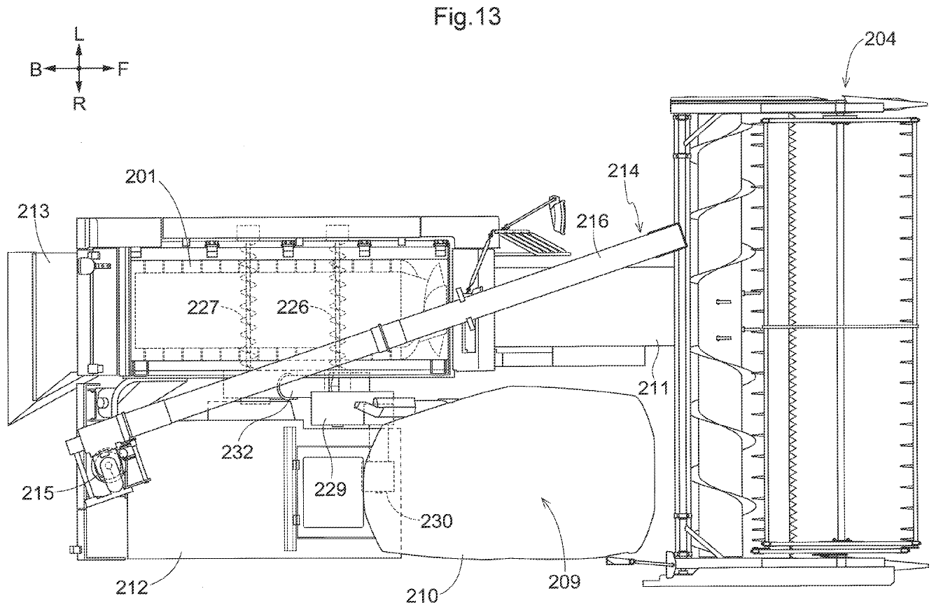

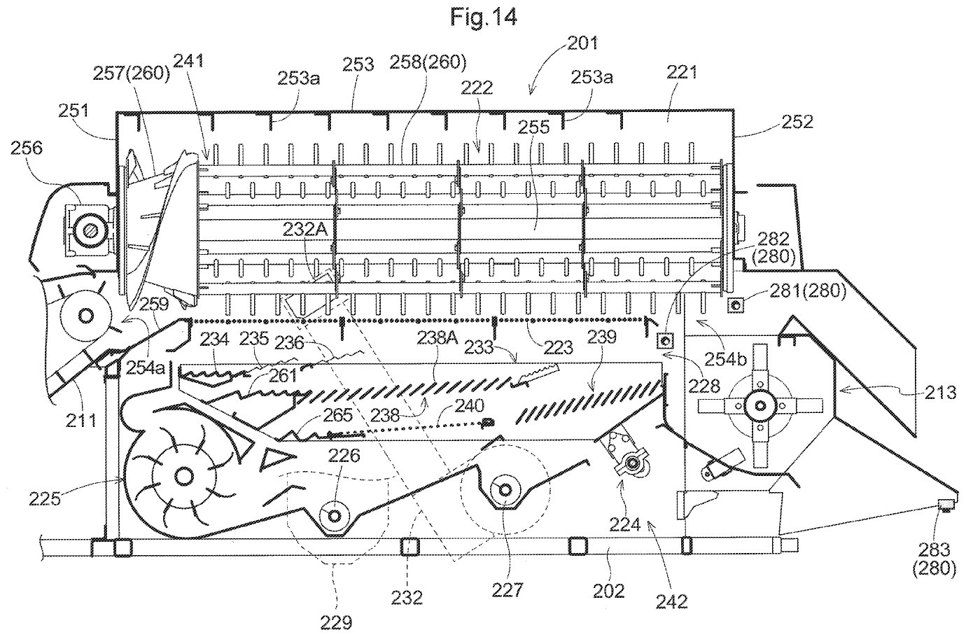

FIG. 12 is a side view of the combine. FIG. 13 is a plan view of the combine. Also, FIG. 14 is a cross-sectional view of a threshing apparatus 201. Note that hereinafter, the combine of the present embodiment is a normal combine, but of course, it may be a head-feeding combine.

Here, in order to facilitate understanding, in the present embodiment, unless otherwise specified, it is assumed that “front” (direction of arrow F shown in FIG. 12) means frontward in the body front-rear direction (traveling direction), and “rear” (direction of arrow B shown in FIG. 12) means rearward in the body front-rear direction (traveling direction). Also, “up” (direction of arrow U shown in FIG. 12) and “down” (direction of arrow D shown in FIG. 12) are positional relationships in the vertical direction (orthogonal direction) of the body, and indicate a relationship in the height above ground. Furthermore, it is assumed that the left-right direction or the lateral direction means the body lateral crossing direction (body width direction) perpendicular to the body front-rear direction, that is, “left” (direction of arrow L shown in FIG. 13) and “right” (direction of arrow R shown in FIG. 13) respectively mean the left direction and the right direction of the body.

As shown in FIGS. 12 and 13, the combine includes a body frame 202 and a crawler traveling apparatus (an example of a traveling apparatus) 203. The combine has a reaping section (an example of a harvesting section) 204 for reaping planted grain culms in the front of a traveling body 217.

Rearward of the reaping section 204, the combine has a threshing apparatus 201 that performs threshing processing on the reaped grain culms, and a feeder (an example of a conveying apparatus) 211 for conveying the reaped grain culms toward the threshing apparatus 201 is provided spanning between the reaping section 204 and the threshing apparatus 201. A grain tank (an example of a storage section) 212 for storing threshed grains is provided on the side of the threshing apparatus 201, and a waste straw shredding apparatus 213 is provided rearward of the threshing apparatus 201.

A driving section 209 covered by a cabin 210 is arranged on the front right side of the traveling body 217. An engine 200E is installed below the driving section 209. The motive power of the engine 200E is transmitted to the crawler traveling apparatus 203, the threshing apparatus 201, and the like by a motive power transmission structure (not shown). Furthermore, a grain discharging apparatus 214 for discharging the grains in the grain tank 212 to the outside is provided.

The grain discharging apparatus 214 includes a vertical conveying section 215 that conveys the grains in the grain tank 212 upward, and a lateral conveying section 216 that conveys the grains from the vertical conveying section 215 to the outside of the body of the combine. The grain discharging apparatus 214 is pivotable about the axis of the vertical conveying section 215. The lower end of the vertical conveying section 215 is in communication with and connected to the bottom of the grain tank 212. The end of the lateral conveying section 216 on the vertical conveying section 215 side is in communication with and connected to the upper end of the vertical conveying section 215 and is supported in such a manner as to be swingable up and down.

As shown in FIG. 14, the threshing apparatus 201 includes a threshing drum section 241 for threshing the reaped grain culms and a sorting section 242. The threshing drum section 241 is arranged at the upper portion of the threshing apparatus 201, and the sorting section 242 is arranged below the threshing drum section 241. The sorting section 242 includes a shake sorting mechanism 224, a primary material collection section 226, a secondary material collection section 227, and a secondary material returning section 232.

The threshing drum section 241 includes a threshing drum 222 accommodated in a threshing chamber 221 and a receiving net 223 laid under the threshing drum 222. The threshing chamber 221 is formed as a space surrounded by a front wall 251 on the front side, a rear wall 252 on the rear side, left and right side walls, and a top plate 253 covering the upper portion. The threshing chamber 221 has a supply port 254a through which the reaped grain culms are supplied at a lower position on the front wall 251, and a guiding bottom plate 259 is arranged below the supply port 254a. The threshing chamber 221 also has a debris discharge port 254b on the lower side of the rear wall 252.

The threshing drum 222 has a drum body 260 and a rotation support shaft 255 that are integrally rotated by a driving rotation force from a rotation driving mechanism 256. The drum body 260 is formed by integrating a raking section 257 at the front end and a threshing processing section 258 located at a position behind the raking section 257.

The top plate 253 has, on its inner surface (lower surface), a plurality of plate-shaped debris transport valves 253a at predetermined intervals along the front-rear direction. In the threshing chamber 221, a rearward movement force acts on the reaped grain culms that rotate together with the threshing drum 222. The plurality of debris transport valves 253a can adjust this rearward movement force.

The threshed material processed by the threshing drum section 241 includes grains, rachis branches, straw waste, and the like. Also, primary material is threshed material mainly containing grains, and secondary material is threshed material containing grains that are not sufficiently processed into simple grains and rachis branches, straw waste, and the like.

In the threshing drum section 241, the harvested material from the feeder 211 is supplied to the threshing chamber 221 via a supply port 254a. The supplied reaped grain culms are raked along the guiding bottom plate 259 by the spiral blade of the raking section 257 and are subjected to threshing processing.

Grains, short straw waste, and the like obtained through the threshing processing leak from the receiving net 223 and fall to the sorting section 242. By contrast, the processed material (grain culm, long straw waste, etc.) that cannot leak from the receiving net 223 is discharged from the debris discharge port 254b to the outside of the threshing chamber 221.

The shake sorting mechanism 224 shakes the frame-shaped sieve case 233 in the front-rear direction with an eccentric cam mechanism using an eccentric shaft or the like. The sorting section 242 is provided with a winnower 225 that generates a sorting wind from the front to the rear. The sieve case 233 is shaken to sort the grains (primary material) from the threshed material in an environment where the sorting wind is supplied from the winnower 225. Also, a primary material collection section 226 and a secondary material collection section 227 are arranged below the sieve case 233.

The primary material collected by the primary material collection section 226 is conveyed (lifted) upward toward the grain tank 212 by the primary material collection/conveying section 229. The primary material conveyed by the primary material collection/conveying section 229 is conveyed to the right by a storage screw 230 (see FIG. 12) and supplied to the grain tank 212 (see FIG. 12).

The secondary material collection section 227 is formed as a secondary material screw that conveys the collected secondary material in the lateral direction. The secondary material collected by the secondary material collection section 227 is conveyed diagonally upward and to the front by the secondary material returning section 232 and is returned to the upper part of the sieve case 233.

The sieve case 233 includes a first grain pan 234, a plurality of first sieve lines 235, a second sieve line 236, a first chaff sieve 238, a second chaff sieve 239, a grain sieve 240, an upper grain pan 261, and a lower grain pan 265.

The first chaff sieve 238 having a plurality of chaff lips 238A is arranged rearward of the upper grain pan 261, and the second chaff sieve 239 is arranged rearward of the first chaff sieve 238. Note that the plurality of chaff lips 238A are arranged side by side along the conveying direction (rearward direction) in which the processed material is conveyed, and each of the plurality of chaff lips 238A is arranged in an inclined orientation of being located diagonally upward toward the rear end side. The lower grain pan 265 is arranged below the front end of the first chaff sieve 238, and the grain sieve 240, which is a net-like body, is arranged at a position continuous with the rear of the lower grain pan 265. The second chaff sieve 239 is arranged below the rear end of the first chaff sieve 238 and rearward of the grain sieve 240. The discharging section 228 is formed by the rear end of the sieve case 233 (the right end in FIG. 14) and the rear end of the receiving net 223.

The first chaff sieve 238 allows the grains included in the threshed material to leak through while at the same time conveying the threshed material to the rear side due to wind sorting performed by the sorting wind and specific gravity sorting performed by shaking. Culms such as straw waste are delivered to the second chaff sieve 239, are sent out from the rear end of the second chaff sieve 239 to the rear of the sieve case 233, and are discharged from the discharging section 228 toward the waste straw shredding apparatus 213. The culms discharged from the discharging section 228 are shredded by the waste straw shredding apparatus 213 and are discharged to the outside of the threshing apparatus 201. Also, the grains leaking directly to the second chaff sieve 239 via the receiving net 223 are sorted into grains and culms such as straw waste by the second chaff sieve 239.

The processed material that includes many grains is received on the top surface of grain sieve 240. Since straw waste and the like are sent rearward on the upper surface of the grain sieve 240, most of the threshed material leaking from the grain sieve 240 is grains, which flow down to and are collected in the primary material collection section 226, and are stored in the grain tank 212 by the primary material collection/conveying section 229. Of the threshed material that did not leak from the grain sieve 240, straw debris is sent rearward by the sorting wind.

In contrast to this, the threshed material that leaked from the part at the rearmost end of the grain sieve 240 or the threshed material that fell from the second chaff sieve 239 flows down to and is collected in the secondary material collection section 227, and is returned to the upstream side of the shake sorting mechanism 224 by the secondary material returning section 232. Then, debris such as straw waste generated through the sorting processing is sent rearward from the rear end of the sieve case 233, and is discharged from the discharging section 228 to the waste straw shredding apparatus 213.

The secondary material is returned to a position on the side of the receiving net 223 in the threshing drum section 241, at which the receiving net 223 is not passed through. The secondary material discharging port 232A of the secondary material returning section 232 for returning the secondary material is provided at a position on the outer side in the radial direction of the arc-shaped receiving net 223, and the secondary material is discharged at this position.

The sorting capability for sorting grains from the threshed material by the sorting section 242 is changeable by adjusting the opening degree of each of the plurality of chaff lips 238A provided in the first chaff sieve 238 and adjusting the air volume of the winnower 225. Also, in the present embodiment, since the attachment angle of the debris transport valve 253a with respect to the top plate 253 is changeable, the sorting capability is also changeable also by adjusting the angle of the debris transport valve 253a. Furthermore, changes in the sorting capability due to the opening degree of the chaff lips 238A and the adjustment of the air volume of the winnower 225 are also related to the amount of threshed material and the amount of returning of the secondary material. If the amount of reaped grain culms is large, the amount of threshed material is large, but if the crop state is the same, the faster the vehicle speed is, the larger the amount of reaped grain culms will be. Due to this, examples of parameters that influence the threshing performance including the sorting capability in the threshing apparatus 201 include the opening degree of the chaff lips 238A, the air volume of the winnower 225, the angle of the debris transport valve 253a, the return amount of the secondary material, and the vehicle speed.

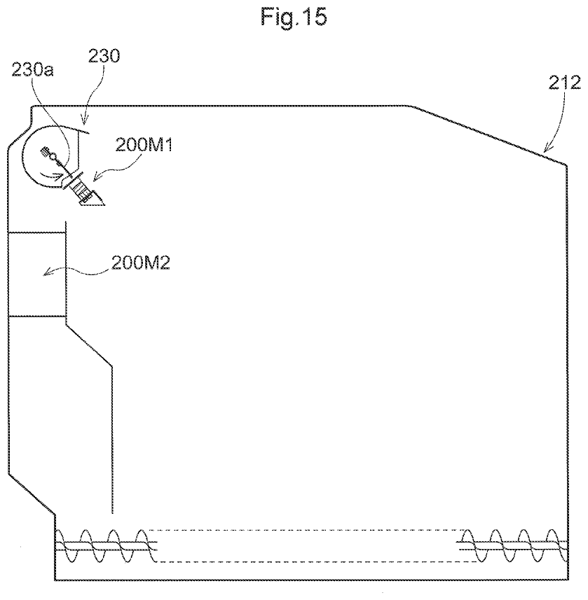

In FIG. 15, a yield measurement device 200M1 for measuring the yield (harvest amount), which is the amount of grains introduced into the grain tank 212 from the threshing apparatus 201 through the primary material collection/conveying section 229 (see FIG. 12) and the storage screw 230 is shown as an example of a harvest amount measurement unit. Furthermore, a taste value measurement device 200M2 for measuring the quality (moisture, protein amount, etc.) of grains introduced into the grain tank 212 is also shown.

The yield measurement device 200M1 is incorporated in a grain release apparatus 230a provided at the terminal end of the storage screw 230. The grain release apparatus 230a diffuses and releases the conveyed grains into the inside of the grain tank 212 by a rotary plate. The yield measurement device 200M1 calculates the flow rate of grains based on a signal of a load cell that is distorted by the collision force of the grains diffused and released each time the rotating plate is rotated.

Furthermore, the yield measurement device 200M1 computes the yield per unit time (a type of unit harvest amount), which is a unit yield, based on the flow rate of the grains in a predetermined cycle, which is the rotation cycle of the rotating plate of the grains introduced into the grain tank 212.

The taste value measurement device 200M2 temporarily stores some of the grain diffused and released by the grain release apparatus 230a, emits light to the stored grains, and performs stereoscopic analysis on the light that has returned through the grains, and thereby measures the taste value (moisture and protein) of the grains Such temporary storage of the grains and measurement of the taste value are performed periodically.

In this embodiment, the harvest loss is grain loss, and in particular, the threshing loss (threshing loss amount), which is used as an index indicating the threshing performance in the threshing apparatus 201, is taken as an example. The threshing loss amount can be divided into the threshing drum loss amount and the sorting loss amount. In this embodiment, the threshing drum loss amount is the amount of grains discharged from the rear end of the threshing chamber 221 together with straw waste (waste straw). The threshing drum loss amount includes the amount of grains discharged together with the straw without being threshed, and the amount of grains discharged from the rear end of the threshing chamber 221 together with straw waste despite being threshed. Furthermore, the sorting loss amount is the amount of grains discharged from the rear end of the sorting section 242 together with the straw waste even though the grains have been threshed and dropped to the sorting section 242. Such a threshing loss amount can be measured by an impact detection sensor such as a known pressure sensor, but in this embodiment, as will be described in detail below, it is calculated with use of a neural network in which a captured image is used as input. Furthermore, the threshing loss amount per unit harvest amount, that is, per unit yield, is calculated with use of the calculated threshing loss amount and the yield measured by the yield measurement device 200M1.

For example, the loss rate (loss rate per unit travel), which is the loss amount per unit yield, is calculated based on the ratio of the yield (unit yield) measured while the combine performing the harvesting work travels for a predetermined time or a predetermined distance to the threshing loss amount calculated during the traveling. By assigning this loss rate to the travel route, the loss rate in a predetermined region of the field or the loss rate of the entire field is calculated. In this embodiment, in the loss region where the loss occurs, the image capture unit 280 for capturing an image of the loss region is used as the detection unit for detecting the loss.

The captured image for calculating the threshing loss amount is an image captured by the image capture unit 280 for which the loss region where the threshing loss occurs is the image capture field of view. In this embodiment, the loss region suitable for recognizing the threshing drum loss is the rear end of the threshing drum 222 or the rear portion of the threshing drum 222, and the loss region suitable for recognizing the sorting loss is the upper portion of the second chaff sieve 239 at the rear end of the sieve case 233. Of course, other areas where threshing loss can be recognized can be used as loss regions. Since the amount of grains mixed in with the straw discharged from the vehicle body is also a kind of threshing loss, the cutting traces rearward of the vehicle body may also be used as the loss region.

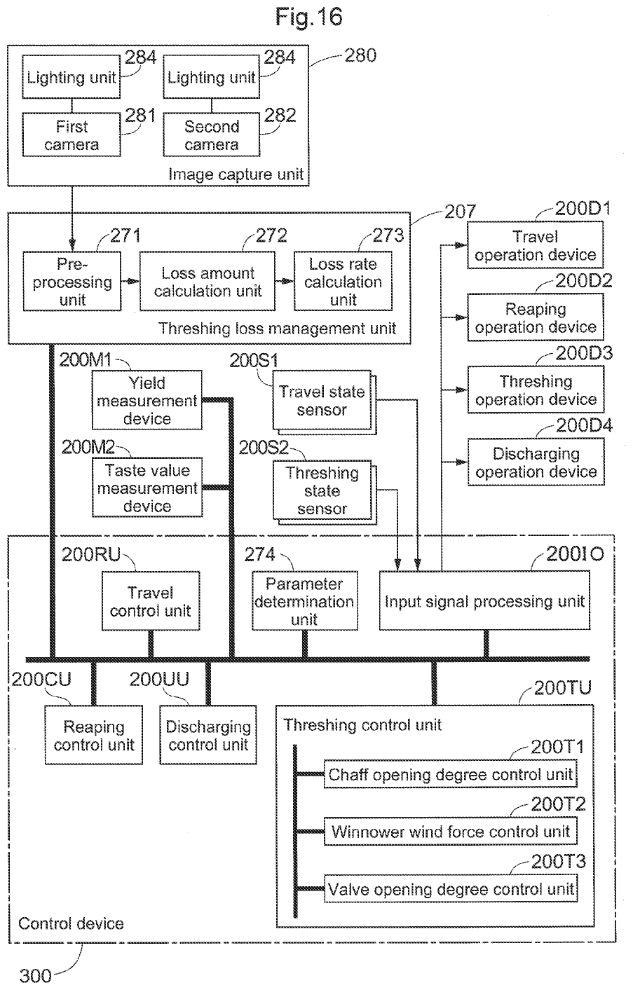

FIG. 16 is a functional block diagram of a control system of the combine. FIG. 16 shows the control device 300, the image capture unit 280, the threshing loss management unit 207, the yield measurement device 200M1, the taste value measurement device 200M2, various sensors, and various operation devices. Here, a threshing loss management system is constructed by the image capture unit 280, the threshing loss management unit 207, and the yield measurement device 200M1.

The various operation devices include a travel operation device 200D1, a reaping operation device 200D2, a threshing operation device 200D3, a discharging operation device 200D4, and the like. The traveling operation device 200D1 includes an engine operation device, a gear change operation device, and a steering operation device. The reaping operation device 200D2 includes an operation device that creates the movement of the reaping section 204 and the feeder 211. The threshing operation device 200D3 includes an operation device that creates the movement of the threshing drum 222, the shake sorting mechanism 224, the chaff lips 238A, the winnower 225, the debris transport valve 253a, the primary material collection/conveying section 229, the second returning section 232, and the like. The discharging operation device 200D4 includes an operation device that creates the movement of the grain discharging apparatus 214.

Among the various sensors, the sensors particularly related to the present invention are the traveling state sensor 200S1 and the threshing state sensor 200S2. The traveling state sensor 200S1 detects the operation state of the various traveling operation devices 200D1. The threshing state sensor 200S2 detects the operation state of the threshing drum 222, the shake sorting mechanism 224, the chaff lips 238A, the winnower 225, the primary material collection/conveying section 229, the secondary material returning section 232, and the like. Note that in this embodiment, the traveling state sensor 200S1 includes a GNSS sensor having a satellite positioning function that receives satellite radio waves and calculates position coordinates.

The control device 300 includes a traveling control unit 200RU, a reaping control unit 200CU, a threshing control unit 200TU, and a discharging control unit 200UU. The traveling control unit 200RU generates a control signal relating to travel control and sends the control signal to the travel operation device 200D1 via the input/output signal processing unit 20010 to control the traveling of the traveling body 217. In this embodiment, the travel control unit 200RU also has a vehicle position calculation function that calculates the vehicle position in the field based on the position coordinates output from the GNSS unit, a travel route calculation function that calculates the travel route based on the vehicle position over time, and an automatic traveling function that performs automatic traveling based on the vehicle position. The reaping control unit CU generates a control signal relating to reaping control and sends the control signal to the reaping operation device 200D2 via the input/output signal processing unit 200IO to control the operation of the reaping work.

The threshing control unit 200TU generates a control signal relating to threshing control and sends the control signal to the threshing operation device 200D3 via the input/output signal processing unit 200IO to control the operation of the threshing work. The threshing control unit 200TU has a chaff opening degree control unit 200T1 that adjusts the opening degree of the chaff lips 238A, a winnower wind force control unit 200T2 that adjusts the wind force of the winnower 225, a valve angle control unit 200T3 that adjusts the valve angle of the debris transport valve 253a, and the like.

The discharging control unit 200UU generates a control signal relating to discharging control for discharging grains from the grain tank 212 and sends the control signal to the discharging operation device 200D4 via the input/output signal processing unit 200IIO to perform the operation of the grain discharge work.

The above-mentioned traveling state sensor 200S1 and threshing state sensor 200S2 also send signals and data to the control device 300 via the input/output signal processing unit 200IO.

The threshing loss management unit 207 receives input of a captured image of the loss region sent from the image capture unit 280 and outputs a loss rate, which is a loss amount per unit yield. In this embodiment, the image capture unit 280 has a first camera 281 and a second camera 282. Each camera comes with a lighting unit 284. The first camera 281 captures an image of a terminal end region of the threshing drum 222 (a threshing drum terminal end region including the rear of the threshing drum 222), which is a loss region suitable for the threshing drum loss. The second camera 282 captures an image of the rear end region of the sieve case 233 (the rear end region of the sieve case including the upper part of the second chaff sieve 239), which is a loss region suitable for the sorting loss. Furthermore, it is also possible to prepare a plurality of first cameras 281 to capture images of the loss region suitable for the threshing drum loss at a plurality of image capture angles so that captured images of a plurality of different image capture fields of view are sent out. Similarly, it is also possible to prepare a plurality of second cameras 282 to capture images of a loss region suitable for the sorting loss at a plurality of image capture angles so that captured images of a plurality of different image capture fields of view are sent out. The number of cameras is not limited.

The threshing loss management unit 207 includes a pre-processing unit 271, a loss amount neural network 272 serving as a loss amount calculation unit, and a loss rate calculation unit 273. The pre-processing unit 271 performs pre-processing such as trimming, color adjustment, and resolution change on the captured image from the image capture unit 280. Furthermore, the threshing apparatus 201 is closed from the outside, and even if the inside thereof is illuminated, debris other than grains is flying around, and therefore it is difficult to maintain constant image capture conditions. For this reason, the normalization of the captured image is performed by the pre-processing unit 271. The pre-processing unit 271 further converts the pre-processed captured image into data suitable for input to the neural network, and provides the data to the loss amount neural network 272 as image input data.

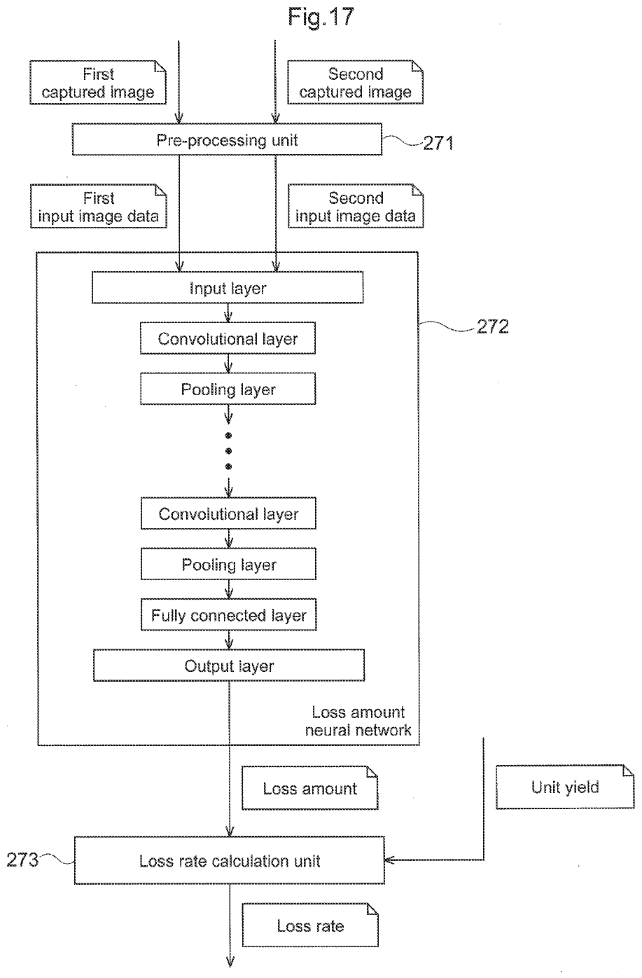

As shown in FIG. 17, the loss amount neural network 272 is composed of a convolutional neural network, preferably deep learning, includes a plurality of convolutional layers, a plurality of pooling layers, and one or more fully connected layers, and is provided with an input layer on the input side and an output layer on the output side. The convolutional layer and the pooling layer repeat multiple times.

In the example of FIG. 17, for simplification of description, a color captured image of the first camera 281 (first captured image) and a color captured image of the second camera 282 (second captured image) are used as captured images. The pre-processing unit 271 generates the first image input data from the first captured image and generates the second image input data from the second captured image. The loss amount neural network 272 uses the first image input data and the second image data as inputs, and outputs the loss amount.

The construction of the loss amount neural network 272 is realized through supervised learning using a large number of training samples (training captured images and their loss amounts) as training data. A training sample is constituted by an actual captured image and an estimated loss amount actually estimated by an expert based on the captured image. Note that in a neural network such as deep learning, the more training samples there are, the higher the reliability of the output is. For this reason, in order to increase the number of training samples, not only are the learning captured images obtained by re-using the actual captured images used as the training samples, but also images obtained by carrying out image processing for rotation or translation on the training samples are used as additional training samples with the same estimated loss amount. Note that what is actually input to the loss amount neural network 272 as training data is the training image input data generated by the pre-processing unit 71 based on the training captured image.

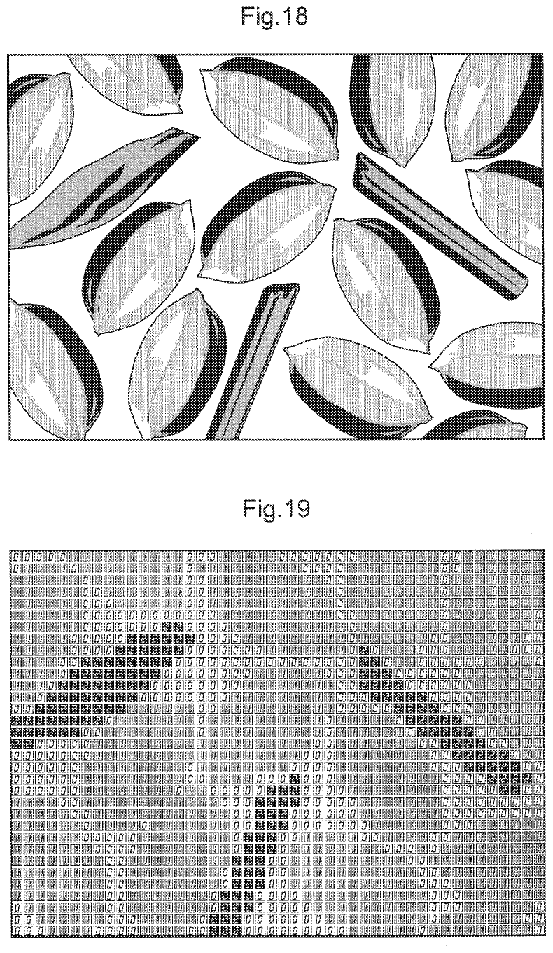

Instead of a mode in which image input data is received as input and the loss amount is directly output, it is also possible to adopt a mode in which a label image in which the threshed material in the captured image is divided into grains and non-grains is output, and the loss amount is calculated based on this label image. In such a mode, the fully connected layer is divided, a preceding fully connected layer outputs a label image, and a subsequent fully connected layer outputs a loss amount based on the label image. At that time, the actual captured image and the loss amount calculated based on the label image created based on the classification of the grains and the non-grains performed by the expert based on the captured image are used as the training data. FIG. 18 shows a partially enlarged schematic diagram of a captured image of the threshed material in a tone image. FIG. 19 is a label image corresponding to a partially enlarged portion of the captured image shown in FIG. 18. In the label image shown in FIG. 19, a grain is indicated by “1”, an abnormal grain is indicated by “2”, and the background is indicated by “0”. Grains have the unique shape and color of the grains, and non-grains include not only rachis branches, straw waste, and the like, but also defective grains that have an irregular shape and color. FIGS. 18 and 19 are schematic views for facilitating understanding, and do not correspond to an actual state.

Furthermore, it is also possible to adopt a configuration in which, instead of the loss amount, which is the output of the loss amount neural network 272, parameters of a normal distribution or a Gaussian distribution showing the distribution of grains or non-grains in the threshed material are calculated as the threshing processing state, and the loss amount is calculated based on this distribution. Alternatively, when the loss amount neural network 272 is configured as a semantic segmentation network, a label image showing the degree of estimation of grains, non-grains, and the background is generated for each pixel, and therefore the loss amount may be calculated based on that label image and output.

Note that since most of the threshed material to be recognized in the captured image is grains, in order to perform more precise recognition, the captured image may be divided into a plurality of regions (patch regions) by the pre-processing unit 271, and image input data may be generated for each region. Alternatively, the image input data may also be divided into a plurality of patches in the input layer of the loss amount neural network 272.

The loss rate calculation unit 273 is not only provided with the loss amount from the loss amount neural network 272, but is also provided with the yield from the yield measurement device 200M1. As a result, the loss rate calculation unit 273 calculates the loss rate, which is the loss amount per unit yield. This loss rate also includes the loss rate obtained based on the yield per unit time, the loss rate obtained based on the yield per unit travel, and the loss rate obtained based on the yield of the entire field. Furthermore, since the travel route information is also provided to the loss rate calculation unit 273 from the travel control unit 200RU, the loss rate obtained based on the yield in a predetermined region of the field can also be calculated. Such a loss rate can be linked to the travel route calculated by the travel control unit 200RU. As a result, the yield, taste value, and loss amount are recorded for each minute section of the field.

Since the loss rate is an important factor indicating the threshing performance, the parameter determination unit 274 determines the threshing control parameter of the threshing apparatus 201 for improving the threshing performance during work travel based on the loss rate calculated during the work travel, and provides the threshing control parameter to the threshing control unit 200TU. The threshing control unit 200TU, for example, performs adjustment of the opening degree of the chaff lips 238A, adjustment of the wind force of the winnower 225, adjustment of the vehicle speed, adjustment of the debris transport valve 253a, and the like during work travel such that the received loss rate approaches the appropriate loss rate. Due to this, the loss rate is calculated continuously or at a predetermined repetition timing during the operation of the combine. Also, the loss amount and the loss rate obtained in work travel in one field are recorded together with the traveling information, the work information, and the like of the combine.

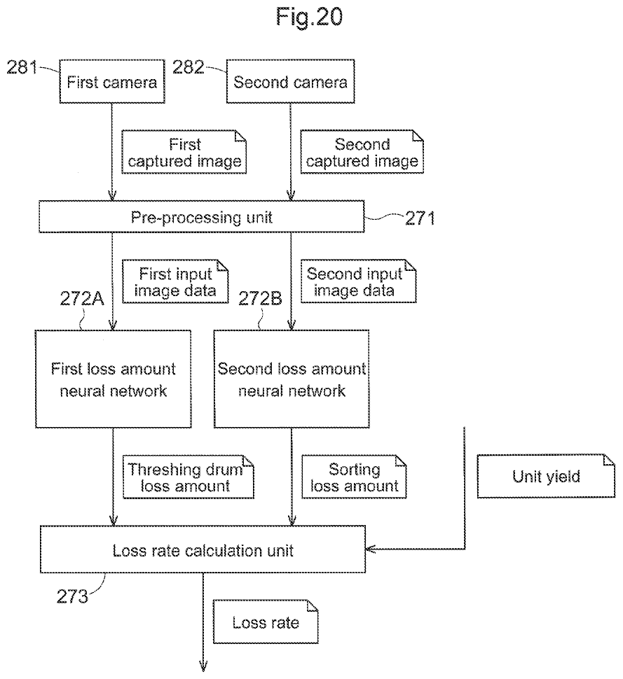

In the configuration of the loss amount neural network 272 shown in FIG. 17, the first input image data and the second input image data generated based on the first captured image and the second captured image are input to the input layer of one common loss amount neural network 272. Instead of this, as shown in FIG. 20, the first loss amount neural network 272A and the second loss amount neural network 272B may also be included as the loss amount neural network 272 in correspondence with the first camera 281 and the second camera 282, which are the image capture sources of the first captured image and the second captured image. In this configuration, the first input image data based on the first captured image is input to the first loss amount neural network 272A, and the second input image data based on the second captured image is input to the second loss amount neural network 272B. As a result, the first loss amount neural network 272A calculates the threshing drum loss amount, and the second loss amount neural network 272B calculates the sorting loss amount. The loss rate calculation unit 273 calculates the total loss rate based on the threshing drum loss amount and the sorting loss amount. Here as well, the first captured image and the second captured image may include captured images at different image capture angles and captured images in different image capture fields of view.

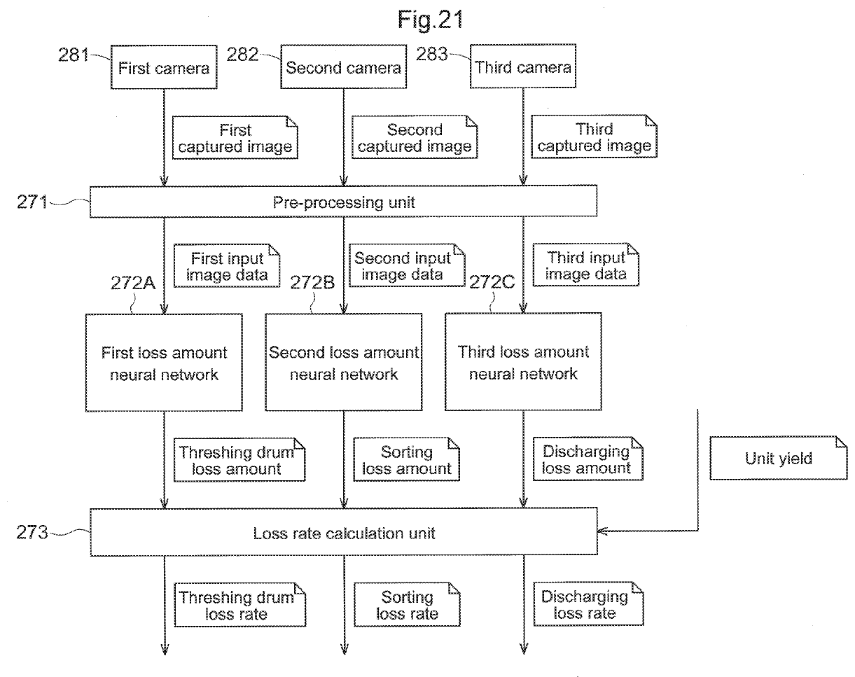

Furthermore, in the configuration shown in FIG. 21, a third camera 283 is prepared in addition to the first camera 281 and the second camera 282 shown in FIG. 20. The third camera 283 is arranged at the discharging section region where non-grains such as straw are discharged from the threshing apparatus 201, for example, at the entrance of the waste straw shredding apparatus 213. Alternatively, the third camera 283 may also be arranged at a position for capturing an image of the cutting traces rearward of the vehicle body. Furthermore, in the configuration shown in FIG. 21, a third loss amount neural network 272C is included. This third loss amount neural network 272C receives input of third input image data generated based on the captured image of a third camera 283, which captures an image of the discharging section region where non-grains such as straw are discharged from the threshing apparatus 201, or the cutting traces rearward of the vehicle body, and calculates the release loss amount, which represents the amount of grains mixed in with the straw released from the vehicle body to the field site. The loss rate calculation unit 273 calculates the loss rate based on the threshing drum loss amount, the sorting loss amount, the release loss amount, and the yield. Of course, here as well, the loss rate calculation unit 273 can additionally obtain the release loss rate based on the release loss amount and the yield. Here as well, the first captured image, the second captured image, and the third captured image may also include captured images at different image capture angles and captured images in different image capture fields of view. Furthermore, a fourth camera, a fifth camera, . . . may be prepared and the threshing loss management unit 207 may include a group of a number of loss amount neural networks corresponding thereto.

In the configurations shown in FIGS. 20 and 21, the loss rate calculation unit 273 calculates many types of loss rates. The parameter determination unit 274 may be made into a neural network in order to determine the threshing control parameters of the threshing apparatus 201 based on these many types of loss rates. The loss rate calculation unit 273 made into a neural network uses the loss rates in various regions as input data and outputs threshing control parameters.

### Other Embodiments

In the above-described embodiment, the loss rate calculated by the loss rate calculation unit 273 was used to adjust the control parameters of various control devices constituting the combine. Instead of this, it is also possible to adopt a configuration in which the loss rate calculated moment by moment by the loss rate calculation unit 273 during work is displayed on a meter panel or a display, and the driver suitably adjusts the control parameters of the various control devices while viewing the displayed loss rate. At that time, it is more convenient if the loss rate is displayed together with an index indicating a traveling state such as an engine speed and a vehicle speed and an index indicating a working state such as a reaping height.

In the above-described embodiment, the adjustment amounts of various devices of the threshing apparatus 201 (the opening degree of the chaff lips 238A, the air volume of the winnower 225, the angle of the debris transport valve 253a, and the return amount of the secondary material), the travel control amount (vehicle speed), and the like were given as examples of targets of the control parameters determined based on the loss rate. Other than these, the parameter determination unit 274 can also determine at least one control parameter of the crawler traveling apparatus 203, the reaping section 204, and the various conveying apparatuses.

In the above-described embodiment, the detection unit for detecting the loss was the image capture unit 280 constituted by a camera, and the captured image was used for calculating the loss amount. The detection unit is not limited to only the image capture unit 280, but various sensors provided in the constituent members of the combine such as the reaping section 204, the feeder 211, the threshing apparatus 201, and the primary material collection/conveying section 229 may function as a detection unit, and those detection signals serving as the detection result of the detection unit may also be used for calculating the loss amount. Furthermore, the detection unit may be a combination of the image capture unit 280 and various sensors.

In the above-described embodiment, the loss amount calculation unit calculated the threshing drum loss amount and the sorting loss amount. However, loss also occurs, for example, during the conveying of the grain culms in the reaping section 204 or during the conveying of the grain culms in the feeder 211. Accordingly, the loss amount calculation unit may also calculate the loss amount in the reaping section 204 or various conveying apparatuses and the like such as the feeder 211 and the primary material collection/conveying section 229. In this case, the threshing loss management unit 207 is configured as a harvester loss management unit, and the loss rate calculation unit 273 also calculates the loss rate corresponding to the respective loss amounts. For example, it is also possible to adopt a configuration in which the reaped grain culms sent from the reaping section 204 to the threshing apparatus 201 by the feeder 211 regards the reaped grain culms and unhulled rice that disappear in the reaping and conveying process as the initial loss, and determines the amount of this initial loss and its loss rate.

In the above-described embodiment, the loss amount calculation unit was constituted by a neural network, but instead of the neural network, an image recognition unit that distinguishes between grains and non-grains in the captured image and calculates the loss amount based on the identification information may also be used.

In the above-described embodiment, deep learning, in which input image data obtained based on one captured image or a plurality of captured images captured simultaneously are used as input, was used as a neural network. Instead of this, a neural network in which time-series input image data obtained based on time-series captured images is used as input may also be used.

In the above-described embodiment, the pre-processing unit 271 and the loss amount neural network 272 had different configurations, but the pre-processing unit 271 may also be incorporated into the loss amount neural network 272. Furthermore, the pre-processing unit 271, the loss amount neural network 272, and the loss rate calculation unit 273 may also be formed integrally.

In the above-described embodiment, the threshing state management system was described taking, as an example, a case where the threshing apparatus 201 is mounted in a combine. Instead of this, it is possible to mount the threshing management system of the present invention in a work vehicle in which the threshing apparatus 201 is different from the combine, or to incorporate the threshing management system of the present invention into a fixed-type threshing apparatus 201.

In the above-described embodiment, the combine was given as an example of a harvester, but the present invention is also applicable to other harvesters, for example, harvesters for harvesting other agricultural products such as corn, potatoes, and carrots.

The functional parts in the above-described embodiment may also be adopted as a harvester management program. In such cases, the harvester management program can cause a computer to realize a measurement function of measuring a harvest amount of a harvested material while harvesting work is performed by a harvester including a harvesting section configured to harvest a crop in a field and a storage section configured to store the harvested material harvested by the harvesting section, a loss amount calculation function of calculating a loss amount indicating an amount of loss that occurs while the harvested material is conveyed from the harvesting section to the storage section, while the harvesting work is performed by the harvester, and a loss rate calculation function of calculating a loss rate, which is the loss amount per unit harvest amount, based on the harvest amount and the loss amount, while the harvesting work is performed by the harvester.

Such a harvester management program can also be recorded on a recording medium.

### Third Embodiment

The work vehicle according to the present invention performs ground work on a pre-set work target. The pre-set work target is an object on which the work vehicle performs work with use of a functional part, an apparatus, or the like included in the work vehicle. Specifically, if the work vehicle is a combine, it is a harvester, if it is a rice transplanter, it is an object to be planted, and if the tractor performs cultivating or reaping, it is a field or the like. Also, if the work vehicle is a construction machine, it corresponds to soil, rock, wood, or the like. Ground work is work performed on a field or work site. In the present embodiment, a combine 420 will be described as an example of a work vehicle.

The combine according to the present invention can inspect the quality of the grains during the harvesting of the grains Hereinafter, the combine 420 of the present embodiment will be described.

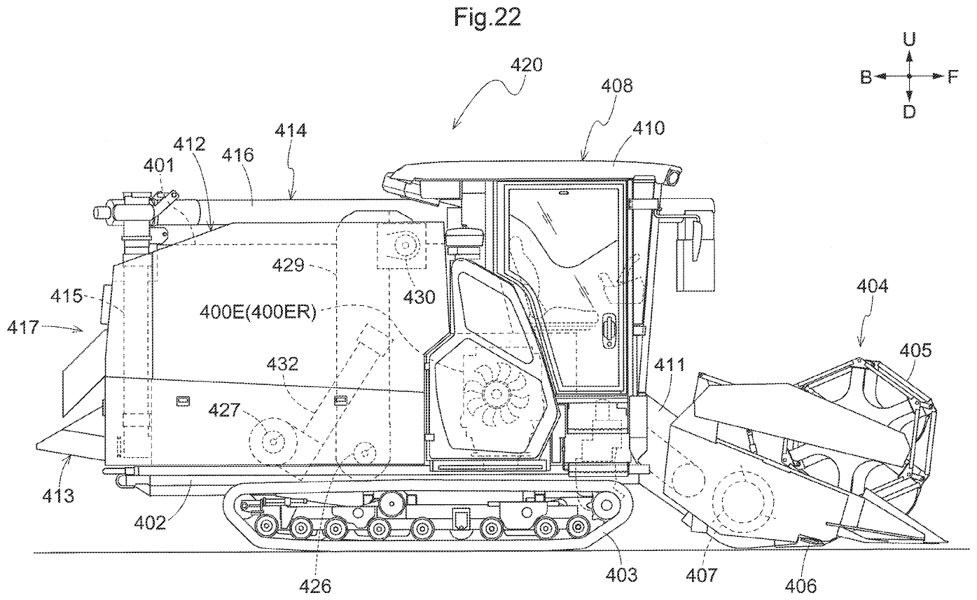

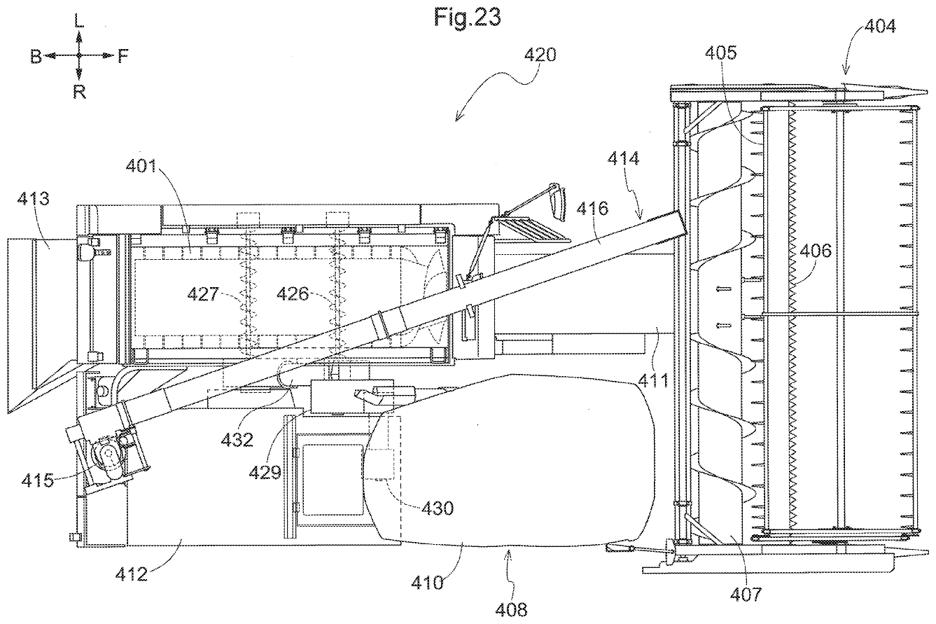

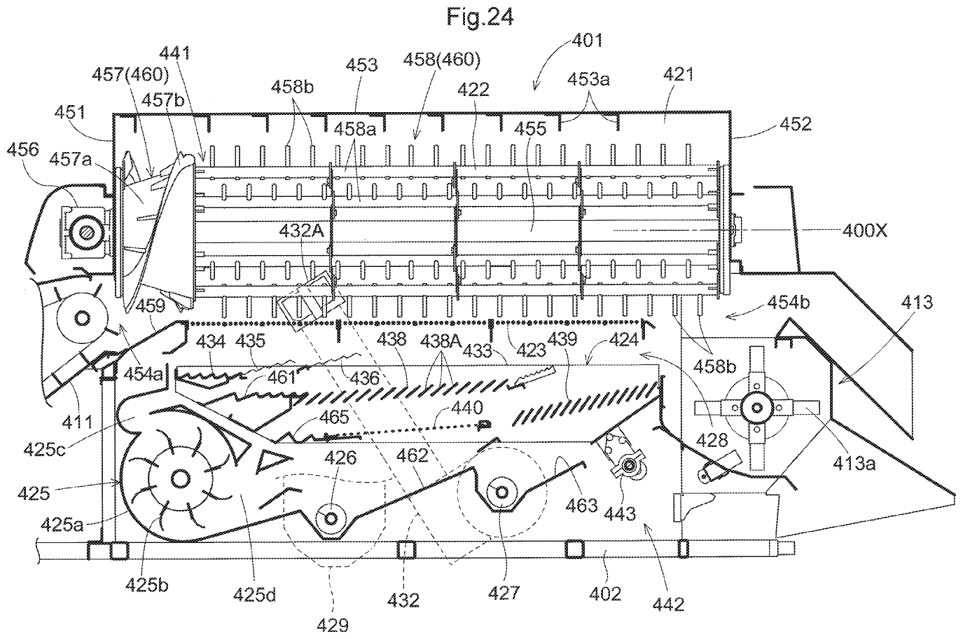

FIG. 22 is a side view of the combine 420, and FIG. 23 is a plan view of the combine 420. Also, FIG. 24 is a cross-sectional view of a threshing apparatus 401 included in the combine 420. Note that hereinafter, the combine 420 will be described by taking a so-called normal combine as an example. Of course, the combine 420 may also be a head-feeding combine.

Here, in order to facilitate understanding, in the present embodiment, unless otherwise specified, “front” (direction of arrow F shown in FIG. 22) means frontward in the body front-rear direction (traveling direction), and “rear” (direction of arrow B shown in FIG. 22) means rearward in the body front-rear direction (traveling direction). Also, “up” (direction of arrow U shown in FIG. 22) and “down” (direction of arrow D shown in FIG. 22) are positional relationships in the body vertical direction (vertical direction), and indicate a positional relationship in the above-ground height. Furthermore, the left-right direction or the lateral direction is the body crossing direction (body width direction) orthogonal to the body front-rear direction, that is, “left” (direction of arrow L shown in FIG. 23) and “right” (direction of arrow R shown in FIG. 23) mean the left direction and the right direction of the body, respectively.

As shown in FIGS. 22 and 23, the combine 420 includes a body frame 402 and a crawler traveling apparatus 403. The combine 420 has a reaping section 404 for reaping planted grain culms in the front of a traveling body 417. The reaping section 404 has a raking reel 405 for raking in the planted grain culms, a cutting blade 406 for cutting the planted grain culms, and an auger 407 for raking in the reaped grain culms.

The combine 420 has a driving section 408 on the front right side of the traveling body 417. The driving section 408 is provided with a cabin 410 in which a driver rides. The combine 420 has an engine room 400ER below the cabin 410, and the engine room 400ER accommodates not only an engine 400E but also an exhaust purification apparatus, a cooling fan, a radiator, and the like. The motive power of the engine 400E is transmitted to the crawler traveling apparatus 403, and a threshing unit 441, a sorting unit 442, and the like, which will be described later, by a motive power transmission structure (not shown).

The threshing apparatus 401 that performs threshing processing on the reaped grain culms is provided rearward of the reaping section 404. The combine 420 has a feeder 411 that extends between the reaping section 404 and the threshing apparatus 401 and conveys the reaped grain culms to the threshing apparatus 401. The combine 420 has a grain tank 412 for storing the grains that have been threshed on a side of the threshing apparatus 401. The grain tank 412 is swingable and openable/closeable about an axis extending in the vertical direction, between a work position and a maintenance position. The combine 420 has a waste straw shredding apparatus 413 with a rotary blade 413a behind the threshing apparatus 401.

The combine 420 is provided with a grain discharging apparatus 414 for discharging the grains in the grain tank 412 to the outside. The grain discharging apparatus 414 includes a vertical conveying section 415 for conveying the grains in the grain tank 412 upward, and a lateral conveying section 416 for conveying the grain from the vertical conveying section 415 to the outside of the body of the combine. The grain discharging apparatus 414 is pivotable about an axis of the vertical conveying section 415. The lower end of the vertical conveying section 415 is in communication with and connected to the bottom of the grain tank 412. The end of the lateral conveying section 416 on the vertical conveying section 415 side is in communication with and connected to the upper end of the vertical conveying section 415 and is supported in such a manner as to be swingable up and down.

In the present embodiment, the threshing apparatus 401 is provided in the traveling body 417. The threshing apparatus 401 includes the threshing unit 441 and the sorting unit 442 as described above. The threshing unit 441 threshes the reaped grain culms reaped by the reaping section 404. The grains that have been threshed by the threshing unit 441 are discharged as threshed material. The sorting unit 442 sorts the threshed material discharged from the threshing unit 441 to obtain sorted material. Accordingly, the threshing unit 441 and the sorting unit 442 are provided in the traveling body 417. The threshing unit 441 is arranged at the upper portion of the threshing apparatus 401, and a receiving net 423 is provided below the threshing unit 441. The sorting unit 442 is arranged below the threshing unit 441 and sorts grains from the threshed material that has leaked from the receiving net 423. The sorting unit 442 includes a shake sorting apparatus 424, a primary material collection section 426, a secondary material collection section 427, and a secondary material returning section 432.

The threshing unit 441 accommodates a threshing drum 422 in a threshing chamber 421, and has a receiving net 423 below the threshing drum 422. The threshing chamber 421 is formed as a space surrounded by a front wall 451 on the front side, a rear wall 452 on the rear side, left and right side walls, and a top plate 453 covering the upper portion. The threshing chamber 421 has a supply port 454a through which the harvested material is supplied at a lower position on the front wall 451, and a guiding bottom plate 459 is arranged below the supply port 454a. The threshing chamber 421 also has a debris discharge port 454b on the lower side of the rear wall 452.

The threshing drum 422 has a drum body 460 and a rotation support shaft 455. As shown in FIG. 24, the drum body 460 is formed by integrating a raking section 457 at the front end and a threshing section 458 located at a position behind the raking section 457. The raking section 457 includes a double-helical spiral blade 457b on the outer periphery of a tapered base 457a whose diameter decreases toward the front end of the threshing drum 422. The threshing section 458 has a plurality of rod-shaped threshing tooth support members 458a and a plurality of threshing teeth 458b. The plurality of rod-shaped threshing tooth support members 458a are provided spaced apart from each other at predetermined intervals in the peripheral direction of the cylindrical drum body 460. Each of the plurality of threshing teeth 458b protrudes from the outer periphery of each of the plurality of threshing tooth support members 458a, and the threshing teeth 458b are attached spaced apart from each other at a predetermined interval along a rotation axis 400X in a front-rear-facing orientation.

The drum body 460 is coaxial with the rotation axis 400X, and rotates integrally with the rotation support shaft 455 that penetrates through the front wall 451 and the rear wall 452 in the front-rear direction. That is, the front end of the rotation support shaft 455 is rotatably supported by the front wall 451 via a bearing, and similarly, the rear end of the rotation support shaft 455 is rotatably supported by the rear wall 452 via the bearing. In this threshing unit 441, the driving rotational force is transmitted from a rotation driving mechanism 456 to the front end of the rotation support shaft 455.

The top plate 453 has, on its inner surface (lower surface), a plurality of plate-shaped debris transport valves 453a provided at predetermined intervals along the front-rear direction. The plurality of debris transport valves 453a are provided in an orientation that is inclined with respect to the rotation axis 400X in a plan view in such a manner as to exert a force that moves the processed material rotating together with the threshing drum 422 to the rear side in the threshing chamber 421. In the present embodiment, the attachment angle of the debris transport valve 453a with respect to the top plate 453 is changeable. The feed amount of the processed material in the drum body 460 is changeable by changing this angle.

The receiving net 423 is arc-shaped in a view in the direction of the rotational axis 400X in such a manner as to surround a region extending from the lower side to both sides of the threshing drum 422, and has a configuration in which gaps through which the processed material can leak are formed by combining a plurality of vertical frames arranged at predetermined intervals along the front-rear direction, and a lateral frame in a front-rear-facing orientation supported with respect to the vertical frames.

In the combine 420 of the present embodiment, the reaped grain culms supplied to the threshing chamber 421 are referred to as harvested material, and the harvested material threshed in the threshing chamber 421 is referred to as processed material (which corresponds to “threshed material”). The processed material includes grains, cut straw, and the like. Also, the primary material is processed material mainly containing grains, and the secondary material is processed material containing grains that are not sufficiently processed into simple grains, cut straw, and the like.

In the threshing unit 441, the harvested material from the feeder 411 is supplied to the threshing chamber 421 via the supply port 454a. The supplied harvested material is raked toward the rear side of the threshing drum 422 along the guiding bottom plate 459 by the spiral blade 457b of the raking section 457, and is supplied to the threshing section 458. In the threshing section 458, threshing is performed as a result of the harvested material being subjected to threshing processing by the threshing teeth 458b and the receiving net 423 as the threshing drum 422 rotates.

While the threshing is performed in this manner, the processed material rotates together with the threshing drum 422, whereby the processed material comes into contact with the debris transport valves 453a and is subjected to threshing processing while being conveyed to the rear portion of the threshing chamber 421. The grains, short pieces of cut straw, and the like obtained through the threshing processing leak through the receiving net 423 and fall into the sorting unit 442. In contrast to this, the processed material (grain culms, long pieces of cut straw, etc.) that cannot leak through the receiving net 423 is discharged from the debris discharge port 454b to the outside of the threshing chamber 421.

As shown in FIG. 24, the sorting unit 442 includes the shake sorting apparatus 424 that sorts grains (primary material) from the processed material by shaking in an environment where sorting wind is supplied from a winnower 425. Also, a primary material collection section 426 and a secondary material collection section 427 are arranged below the shake sorting apparatus 424.

The winnower 425 is provided in the sorting unit 442 and generates a sorting wind along the conveying direction of the processed material. The winnower 425 accommodates a winnower main body, which has a plurality of rotary blades 425b, inside a fan case 425a. The fan case 425a has, in its upper part, an upper discharge port 425c for sending the sorting wind along the upper surface of the upper grain pan 461 and a rear discharge port 425d for sending the sorting wind rearward.

The primary material collection section 426 collects the processed material as the primary material. The processed material is guided to the primary material collection section 426 by the primary material guiding section 462. The primary material collection section 426 is configured as a primary material screw that laterally conveys the primary material (the grains of the primary material) guided by the primary material guide section 462. The primary material collected by the primary material collection section 426 is conveyed upward (lifted) to the grain tank 412 by the primary material collection/conveying section 429. Accordingly, the sorted material sorted by the sorting unit 442 is conveyed to and stored in the grain tank 412. The primary material conveyed by the primary material collection/conveying section 429 is conveyed to the right by the storage screw 430 and supplied to the grain tank 412. The primary material collection/conveying section 429 corresponds to a bucket-type conveyor.

The secondary material collection section 427 collects, as secondary material, the processed material that has not been sorted as the sorted material among the threshed material. The sorted material is grains sorted by the shake sorting apparatus 424, which will be described in detail later. For this reason, the processed material that was not sorted as the sorted material corresponds to the grains, grain culms, long pieces of cut straw, and the like that were not sorted by the shake sorting apparatus 424, and is called the secondary material. Such secondary material is guided to the secondary material collection section 427 by the secondary material guide section 463. The secondary material collection section 427 is configured as a secondary material screw that laterally conveys the secondary material guided by the secondary material guide section 463. The secondary material collected by the secondary material collection section 427 is conveyed diagonally upward and frontward by the secondary material returning section 432 and thus is returned to the upper side (upstream side) of the shake sorting apparatus 424. The secondary material reduction section 32 corresponds to a screw-type conveyor.

The primary material collection section 426 and the secondary material collection section 427 are driven by the motive power of the engine 400E transmitted by a power transmission structure (not shown).

The motive power of the engine 400E is transmitted to the primary material collection section 426, is transmitted from the primary material collection section 426 to the primary material collection/conveying section 429, and is transmitted from the primary material collection/conveying section 429 to the storage screw 430. The primary material collection/conveying section 429 is provided on the right side of the threshing apparatus 401 (outside of the right wall).

The motive power of the engine 400E is transmitted to the secondary material recovery section 427, and is transmitted from the secondary material collection section 427 to the secondary material returning section 432. The secondary material returning section 432 is provided on the right side of the threshing apparatus 401 (outside of the right wall).

The shake sorting apparatus 424 sorts grains from the processed material. The shake sorting apparatus 424 is arranged below the receiving net 423, and the processed material leaks from the receiving net 423. This shake sorting apparatus 424 includes a frame-shaped sieve case 433 that is shaken in the front-rear direction by an eccentric-cam-type shake driving mechanism 443 that uses an eccentric shaft or the like, the frame-shaped sieve case 433 being formed in a rectangular shape in a view from above.

The sieve case 433 includes a first grain pan 434, a plurality of first sieve lines 435, a second sieve line 436, a first chaff sieve 438, a second chaff sieve 439, a grain sieve 440, an upper grain pan 461, and a lower grain pan 465.

The first chaff sieve 438, which has a plurality of chaff lips 438A, is arranged rearward of the upper grain pan 461, and a second chaff sieve 439 is arranged rearward of the first chaff sieve 438. Note that the plurality of chaff lips 438A are arranged side by side along the conveying direction (rearward direction) in which the processed material is conveyed, and each of the plurality of chaff lips 438A is arranged in an inclined orientation that is diagonally upward toward the rear end side. In the present embodiment, the opening degree of each of the chaff lips 438A is changeable. The opening degree being changeable means that the inclined orientation is changed. Specifically, the closer the chaff lips 438A are to being parallel to the front-rear direction, the smaller the opening degree is, and the closer the chaff lips 438A are to being parallel to the vertical direction, the larger the opening degree is. The lower grain pan 465 is arranged below the front end of the first chaff sieve 438, and the grain sieve 440, which is a net-like body, is arranged at a position continuous with the rear side of the lower grain pan 465. The second chaff sieve 439 described above is below the rear end of the first chaff sieve 438 and is arranged rearward of the grain sieve 440.

The sieve case 433 has an air passage through which the sorting wind supplied from the upper discharge port 425c of the winnower 425 is supplied along the upper surface of the upper grain pan 461 and an air passage through which the sorting wind supplied from the rear discharge port 425d of the winnower 425 is supplied along the upper surface of the lower grain pan 465. The rear end of the shake sorting apparatus 424 (the right end in FIG. 24) and the rear end of the receiving net 423 form a discharging section 428.

In the shake sorting apparatus 424 of the present embodiment, the sorting wind from the winnower 425 is supplied from the body front side to the body rear side, and the processed material inside of the sieve case 433 is conveyed rearward relative to the body of the combine due to the sieve case 433 being shaken by the shake driving mechanism 443. For this reason, in the following description, in the shake sorting apparatus 424, the upstream side in the conveying direction of the processed material is referred to as the front end or the front side, and the downstream side is referred to as the rear end or the rear side.

The grain sieve 440 is configured as a net-like body in which a plurality of wire members made of metal are combined in a net-like manner, and allows grains to leak from the mesh. A first chaff sieve 438 is provided above the grain sieve 440, and the grains that flow between the chaff lips 438A of the first chaff sieve 438 leak to the grain sieve 440.

Due to such a configuration, the processed material that leaks from the receiving net 423 in the sorting unit 442 and is received by the upper grain pan 461 is supplied to the front end of the first chaff sieve 438 accompanying the shaking of the sieve case 433. Also, the sieve case 433 receives most of the processed material leaking from the receiving net 423.

The first chaff sieve 438 allows the grains included in the processed material to leak through while at the same time conveying the processed material to the rear side through wind sorting by the sorting wind and specific gravity sorting accompanying shaking. Culms such as cut straw in the processed material subjected to such sorting are delivered to the second chaff sieve 439, are sent out from the rear end of the second chaff sieve 439 to the rear of the sieve case 433, and are discharged from the discharging section 428 toward the waste straw shredding apparatus 413. The culms discharged from the discharging section 428 are shredded by the waste straw shredding apparatus 413 and are discharged to the outside of the threshing apparatus 401. Also, the grains leaking directly to the second chaff sieve 439 via the receiving net 423 are sorted into grains and culms such as cut straw by the second chaff sieve 439.

Here, considering the state of the processed material leaking from the receiving net 423, grains, grains that are not sufficiently processed into simple grains, or small pieces of straw in the harvested material supplied to the threshing chamber 421 leak from the receiving net 423 at an early stage when conveyed inside the threshing chamber 421. For this reason, the amount of leakage of the processed material in the upstream region in the conveying direction of the receiving net 423 tends to be larger than that in the downstream region in the conveying direction. Also, as described above, since the processed material is supplied from the upper grain pan 461 to the front end of the first chaff sieve 438, the amount of the processed material that leaks from the front end of the first chaff sieve 438 is larger than that on the rear end side.

Also, the processed material that leaked from the front end side of the first chaff sieve 438 is removed by sending a portion thereof to the rear side by the sorting wind immediately after leaking, and the processed material containing a large amount of grains is received on the upper surface of the grain sieve 440. Furthermore, since the wind pressure of the sorting wind and the shaking force act on the processed material supplied to the grain sieve 440, the straw and the like contained in the processed material is sent rearward on the upper surface of the grain sieve 440 and many grains are included in the processed material leaking from the grain sieve 440. The grains that leaked from the grain sieve 440 flow down from the primary material guiding section 462 to the primary material collection section 426, are collected therein, and are stored in the grain tank 412 by the primary material collection/conveying section 429.

Also, the processed material from the region rearward of the first chaff sieve 438 is supplied to the grain sieve 440, but the cut straw in the processed material that did not leak in the grain sieve 440 is sent rearward by the sorting wind, and therefore the sorting processing is performed without significantly reducing the sorting efficiency in the region on the rear side of the grain sieve 440.

Also, the primary material (grains) that leaked in front of the rearmost end of the grain sieve 440 flows down from the primary material guiding section 462 to the primary material collection section 426, is collected therein, and is stored by the primary material collection/conveying section 429 in the grain tank 12.

In contrast to this, the processed material that leaked from the portion at the rearmost end of the grain sieve 440 or the processed material that fell from the second chaff sieve 439 flows down from the secondary material guiding section 463 to the secondary material collection section 427, is collected, and is returned to the upstream side of the shake sorting apparatus 424 by the secondary material returning section 432. Then, debris such as straw waste serving as the third processed material generated by the sorting processing is sent rearward from the rear end of the shake sorting apparatus 424, and is discharged from the discharging section 428 to the waste straw shredding apparatus 413.

As described above, the secondary material is returned to the upstream side, which is the front portion of the shake sorting apparatus 424, by the secondary material returning section 432. Specifically, the secondary material is returned to a position that is on the side of the receiving net 423 in the threshing unit 441, and at which the secondary material does not pass through (does not flow through) the receiving net 423. Accordingly, the secondary material discharging port 432A of the secondary material returning section 432 is provided at a position on the outer side in the radial direction of the arc-shaped receiving net 423, and the secondary material is discharged at this position.

As described above, in the combine 420, the threshing unit 441 and the sorting unit 442 included in the threshing apparatus 401 perform threshing work on the reaped grain culms reaped in the field. Accordingly, in the combine 420, the above-mentioned “ground work” corresponds to the threshing work.

Also, as described above, grains that are not sufficiently processed into simple grains or small pieces of straw in the harvested material supplied to the threshing chamber 421 leak from the receiving net 423 at an early stage when they are conveyed inside the threshing chamber 421, and some of the leaked processed material is removed by being sent to the rear side by the sorting wind. Also, the processed material containing a large amount of grains is received on the upper surface of the grain sieve 440, and the straw and the like contained in the processed material are removed by being sent rearward on the upper surface of the grain sieve 440. However, depending on the amount of reaped grain culms supplied to the threshing apparatus 401 and the parameters that set the capability of each part of the threshing unit 441 and the sorting unit 442 (e.g., the air volume of the sorting wind, the opening degree of the chaff lips 438A, and the like described above), grains that are not sufficiently processed into simple grains, straw, and the like (hereinafter referred to as “foreign matter”) reach the primary material collection/conveying section 429 via the primary material guiding section 462 in some cases, and such foreign matter is stored in the grain tank 412.

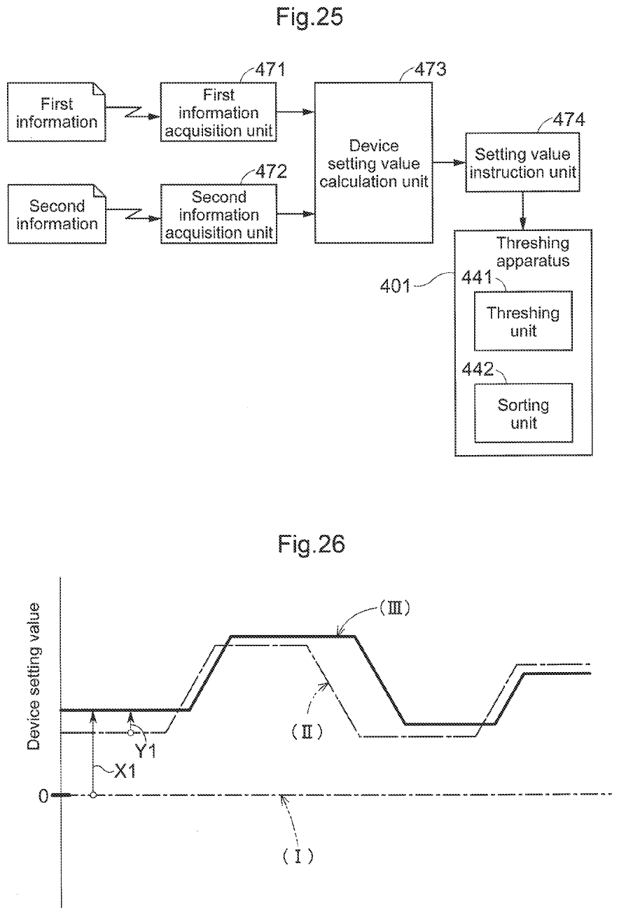

Since such foreign matter reduces the sorting degree (or sorting efficiency) of the threshing apparatus 401, it is preferable that the amount of foreign matter conveyed to the grain tank 412 is small. In view of this, the combine 420 of the present embodiment can reduce the amount of foreign matter stored in the grain tank 412. Hereinafter, the reduction of the amount of such foreign matter will be described with reference to FIG. 25.

In order to realize the above-described functions, the combine 420 includes a first information acquisition unit 471 that acquires first information including the work conditions of the work target in ground work carried out in the past, device setting values that set the capability of the device used in the past ground work, and the work result of the ground work performed in the past ground work.

The work target in the ground work carried out in the past is the threshing work performed when the combine 420 harvested a crop in the field in the past. The work condition is position information indicating the position of the work site where the ground work is performed in the present embodiment. Accordingly, the work condition of the work target in the ground work carried out in the past corresponds to the position information indicating the position of the field where the combine 420 performed the threshing work when the crop was harvested in the field in the past. Such position information is information indicating the latitude, longitude, and altitude of the field, and for example, when the combine 420 performs harvesting work in the field, the position information may be acquired by a GPS device (not shown) and stored in the storage unit of the combine 420, or it may be stored in a server connected by a network.

Also, the device used in the past ground work is the device used in the threshing work performed by the combine 420 when harvesting crops in the field in the past, that is, the threshing apparatus 401. Accordingly, the device setting value for setting the device capability is a control parameter of the threshing apparatus 401 that performs threshing processing, and specifically corresponds to a threshing setting parameter according to which the threshing capability of the threshing unit 441 included in the threshing apparatus 401 is settable or a sorting parameter according to which the sorting capability of the sorting unit 442 is settable. The threshing parameter according to which the threshing capability in the threshing unit 441 is settable is the setting value for setting the rotation speed of the rotation support shaft 455 of the threshing drum 422 and the setting value for setting the attachment angle of the debris transport valve 453a with respect to the top plate 453. Also, the sorting parameter according to which the sorting capability in the sorting unit 442 is settable corresponds to the setting value for setting the air volume of the sorting wind from the winnower 425, the setting value for setting the opening degree of the chaff lips 438A, and the setting value for setting the shake speed and shake amount of the shake driving mechanism 443 for shaking the shake sorting apparatus 424.

Therefore, the device setting value for setting the capability of the device used in the past ground work corresponds to the setting value for setting the rotation speed of the rotation support shaft 455 of the winnower 422 used in the threshing work performed when the combine 420 harvested the crop in the field in the past, the setting value for setting the attachment angle of the debris transport valve 453a with respect to the top plate 453, the setting value for setting the air volume of the sorting wind from the winnower 425, the setting value for setting the opening degree of the chaff lips 438A, and the setting value for setting the shake speed and shake amount of the shake driving mechanism 443 that shakes the shake sorting apparatus 424. Such setting values may also be stored in the storage unit of the combine 420, or may be stored in a server connected by a network.

Also, the work result of the ground work performed in the past ground work is the result of the threshing work performed when the combine 420 harvested the crop in the field in the past. Specifically, it is the calculation result of the amount of foreign matter stored in the grain tank 412. The amount of such foreign matter can also be calculated, for example, based on a captured image of the processed material that has been subjected to threshing processing in the threshing apparatus 1 and conveyed to the grain tank 412, or can be calculated based on a captured image of a state when the stored grain is discharged from the grain tank 412 of the combine 420 to the grain transport vehicle via the grain discharging apparatus 414. Of course, it can also be calculated by other methods.

In the present embodiment, the above-described position information indicating the position of the field where the threshing work was performed when the crop was harvested in the field in the past, the setting value of the device used in the threshing work performed in the past, and the result of the threshing work performed when the crop was harvested in the field in the past are treated as the first information and are acquired by the first information acquisition unit 471.

Also, the combine 420 is also provided with a second information acquisition unit 472 that acquires the second information including the work conditions of the work target in the ground work to be performed in the future. The above-described first information is information relating to the ground work carried out in the past. On the other hand, the second information acquisition unit 472 acquires the information relating to the ground work to be carried out in the future as the second information. Specifically, the work condition of the work target in the ground work to be carried out in the future corresponds to position information, which indicates the position of the work site where ground work is to be carried out in the future, the position information indicating the position of a field where the combine 420 is to perform threshing work when harvesting the crop in the field in the future. Such position information is information indicating the latitude, longitude, and altitude of the field, and can be acquired by, for example, a GPS device (not shown) when the combine 420 performs harvesting work in the field, or if a work plan has been assigned to the combine 420 in advance, the position information can also be acquired based on information in which such a work plan is stored.

Furthermore, the combine 420 includes a device setting value calculation unit 473 that calculates a device setting value for the device to be used in the ground work to be performed in the future based on the first information acquired by the first information acquisition unit 471 and the second information acquired by the second information acquisition unit 472. The device setting value for the device to be used in the ground work to be carried out in the future corresponds to a setting value for setting the rotation speed of the rotation support shaft 455 of the threshing drum 422 to be used in the threshing work performed when the combine 420 harvests a crop in the field in the future, a setting value for setting the attachment angle of the debris transport valve 453a with respect to the top plate 453, a setting value for setting the air volume of the sorting wind from the winnower 425, a setting value for setting the opening degree of the chaff lips 438A, and a setting value for setting the shake speed and shake amount of the shake driving mechanism 443 that shakes the shake sorting apparatus 424.

Here, the first information includes position information indicating the position of the field where the threshing work was performed when the crop was harvested in the field in the past as described above, a setting value for the device used in the threshing work performed in the past, and the result of threshing work performed when a crop was harvested in the field in the past. On the other hand, the second information includes position information indicating the position of the field where the combine 420 is to perform the threshing work in the future. In view of this, the device setting value calculation unit 473 extracts the first information including the position information that matches or is similar to the position information included in the second information, and furthermore calculates the setting value for the device used when there is little foreign matter mixed in, based on the result of the threshing work included in the first information. Note that in this case, it is preferable that the device setting value calculation unit 473 extracts not only the position information but also the first information that matches the type of the harvested object and calculates the setting value.

Here, it is preferable that the device setting calculation unit 473 calculates the device setting value for the device to be used in the ground work to be carried out in the future by inputting the first information and the second information to a neural network that has undergone training to calculate the device setting value based on the first information and a predetermined work condition. Here, the neural network is an algorithm that imitates the human brain and is executed by a computer, and for example, outputs a result of calculating a device setting value as a result similar to that obtained through distinction made by a human brain when the above-mentioned first information and the second information are input. As the neural network of the present embodiment, a neural network that has been trained in advance is used such that a device setting value according to which mixing-in of foreign matter is reduced can be calculated.

Specifically, in the present embodiment, a neural network is used in which training is performed such that a calculation result of a device setting value for a device that does not contain foreign matter is output when a predetermined working condition is input as teacher data regardless of whether or not foreign matter has been mixed in. That is, before the above-mentioned second information is input to the neural network, the device setting values and labels according to which foreign matter is not mixed in and the device setting values and labels according to which foreign matter is included are provided in advance, and the characteristics of the device setting values for each label are learned. As a result, if the second information is provided, it is possible to easily calculate the device setting value according to which foreign matter is not mixed in (device setting value according to which foreign matter is reduced). Note that this training can also be continuously performed in the combine 20 without using the teacher data when the threshing processing is actually performed. In this manner, the device setting value calculation unit 473 calculates the device set value with use of the neural network.

It is preferable that the device setting value calculation unit 473 continuously calculates the device setting value while the ground work is carried out. That is, it is preferable that the device setting value calculation unit 473 continuously calculates the device setting value when the combine 420 is performing the harvesting work (threshing work). This makes it possible to calculate the device setting value according to the changed second information even if the second information has been changed.

Furthermore, it is preferable that the device setting value calculation unit 473 automatically calculates the device setting value as the ground work is carried out. That is, it is preferable that when the combine 420 is performing the harvesting work (threshing work), the device setting value calculation unit 473 continuously calculates the device setting value regardless of, for example, whether or not there is an operator instruction.

It is preferable that the combine 420 includes a setting value instruction unit 474 that applies the calculated device setting value to the device when carrying out ground work in the future. The device setting value for the device is calculated by the above-described device setting value calculation unit 473, and is transmitted to the setting value instruction unit 474 before the combine 420 performs the threshing operation. The setting value instruction unit 474 sets the calculated device setting value in the device before the combine 420 performs the threshing operation.

As described above, in the present embodiment, the position information of the field is included as the condition of the work target. In view of this, it is preferable that the setting value instruction unit 474 applies the device setting value if a work site where the ground work was performed in the past and a work site where the ground work is to be performed in the future are the same. As a result, the device setting values suitable for the threshing work can be set in the threshing unit 441 and the sorting unit 442, and therefore the threshing work can be appropriately performed.

As described above, in the present embodiment, the device setting value for the device to be used in the ground work to be carried out in the future is set based on the device setting value used in the past ground work. As a result, as illustrated in FIG. 26, setting to the device setting value (III) for the device to be used in the ground work to be carried out in the future based on the device setting value (II) used in the past ground work results in an amount of change (Y1 in FIG. 26) that is smaller than the amount of change (X1 in FIG. 26) set for the device setting value (III) for the device to be used in the ground work to be carried out in the future based on the initial value (e.g., ±0) indicated by (I). Accordingly, the device setting value can be set quickly, and the amount of change can be made small, and therefore the setting value can be set accurately.

### Other Embodiments

In the above-described embodiment, the work vehicle was described taking, as an example, a normal combine, but the work vehicle may also be a head-feeding combine. Also, the work vehicle may be a rice transplanter or a tractor. Also, it may be an agricultural machine other than these, or it may be a construction machine.

In the above-described embodiment, it was described that the combine 420 includes a setting value instruction unit 474 that applies the calculated device setting value to the device when ground work is performed in the future, but the combine 420 need not include a setting value instruction unit 474. In such a case, for example, a display device may be provided in the combine 420, and the display device may display the device setting value calculated by the device setting value calculation unit 473 as advice to the operator. As a result, the operator can manually change the device setting value for the device, and the ground work can be appropriately performed.

Also, in the above-described embodiment, the setting value instruction unit 474 was described as applying the device setting value if the work site where the past ground work was performed and the work site where the ground work is to be performed in the future are the same, but even if the work site where past ground work was performed and the work site where ground work is to be performed in the future are not the same, the setting value instruction unit 474 can apply the device setting value if the interval between the work site where past ground work was performed and the work site where ground work is to be performed in the future is within a predetermined distance, and the setting value instruction unit 474 can apply the device setting value regardless of the distance.

In the above-described embodiment, the device setting value calculation unit 473 was described as continuously calculating the device setting value during the execution of the ground work, but the device setting value calculation unit 473 can also calculate the device setting value at only a predetermined timing (e.g., the start time of the ground work, etc.).

In the above-described embodiment, the device setting value calculation unit 473 was described as automatically calculating the device setting value as the ground work is performed, but the device setting value calculation unit 473 can also calculate the device setting value, for example, in response to an operator instruction (e.g., in response to a switch operation).

In the above-described embodiment, it was described that the work condition of the work target includes the position information indicating the position of the work site where the ground work is performed, but the work condition of the work target may also not include the position information. In such a case, for example, as described in the above embodiment, the work condition can also include the type of the crop to be harvested, information indicating the status of the work site (field), or information indicating the season, the temperature, the weather, or the like.

In the above-described embodiment, the ground work was described as being threshing work for performing threshing processing on reaped grain culms reaped in a field, but the ground work need not be threshing work as described above, and for example, may be rice planting work, cultivation work, or mowing work. The ground work may also be only sorting work.

In the above-described embodiment, the calculation of the device setting value was described as being performed with use of a neural network, but the calculation may also be performed without using the neural network.

As described above, this work vehicle was described taking the combine 420 as an example, but if the work vehicle is the combine 420, the calculation of the device setting value can also be performed based on the quality of the grains conveyed from the threshing apparatus 401 to the grain tank 412. The work vehicle can be configured as follows.

The work vehicle includes: a threshing unit 441 that threshes reaped grain culms and discharges the threshed material, a sorting unit 442 that sorts grains from the discharged threshed material as a threshing material, a grain tank 412 to which the sorted material is conveyed and in which the stored material is stored, an image capture unit that acquires a captured image of the inside of a conveying path for conveying the sorted material from the sorting unit 442 to the grain tank 412, a first work condition information acquisition unit that acquires first work condition information indicating a work condition for when the reaped grain culms were threshed and the grains were sorted, a control parameter information acquisition unit that acquires control parameter information indicating a threshing control parameter for determining a threshing capability of the threshing unit 441 set for the threshing unit 441 when the reaped grain culms were threshed, and a sorting control parameter for determining the sorting capability of the sorting unit 442 set for the sorting unit 442 when the sorted material was sorted, an evaluation result acquisition unit that acquires an evaluation result obtained by evaluating whether or not the sorted material included in the captured image is normal grains that satisfy a desired quality, a second work condition information acquisition unit that acquires second work condition information indicating the work condition for when reaped grain culms are to be threshed and grains are to be sorted in the future, and a control parameter calculation unit that calculates a threshing control parameter to be set when threshing the reaped grain culms and a sorting control parameter to be set when sorting grains, based on the first work condition information, the control parameter information, the evaluation result, and the second work condition information.

Also, in the above-described configuration, it is preferable that the calculated threshing control parameter and sorting control parameter are used for the threshing of the reaped grain culms and the sorting of the grains harvested in the same field as that in which the reaped grain culms used in the calculation was harvested.

Also, in the above-described configuration, it is preferable that the control parameter calculation unit continuously performs calculation during the threshing of the reaped grain culms and during the sorting of grains

Also, in the above-described configuration, it is preferable that the calculated threshing control parameter and sorting control parameter are automatically applied during the operation of the threshing unit 441 and the sorting unit 442.

Also, in the above-described configuration, it is preferable that the first working condition information includes the first position information indicating the position where the sorted material was harvested in the field, and the second working condition information includes the second position information indicating the position in the field where the reaped grain culms to be threshed in the future was harvested.

Also, in the above-described configuration, it is preferable that the threshing unit 441 is provided with a threshing drum 422 having a tubular drum body 460 with an outer periphery to which a plurality of threshing teeth 458b are attached, and a threshing drum axis supporting the drum body 460, a threshing control parameter is a control parameter for setting the feed amount of reaped grain culms in the drum body, the sorting unit 442 is provided with a chaff sieve having a plurality of chaff lips 438A that are arranged side by side in the conveying direction in which the threshed material is conveyed, and that have a changeable opening degree, and a winnower 425 that generates a sorting wind along the conveying direction, and the sorting control parameter is a control parameter for setting the opening degree of the chaff lips 438A and the air volume of the sorting wind.

Also, in the above-described configuration, it is preferable that the evaluation of whether or not the sorted material included in the captured image is normal grains is performed by inputting image data generated based on the captured image to a neural network that has undergone training to distinguish normal grains from the sorted material.

Also, it is preferable that the neural network is trained such that if training image data generated based on the captured image in which normal grains are included is input as teacher data, a distinction result indicating that normal grains are included in the sorted material is output, and the neural network is trained such that if training image data generated based on a captured image in which foreign matter other than normal grains is included, a distinction result indicating that foreign matter is included in the sorted material is output.

Although a work vehicle was described in the embodiment above, the processing performed by the functional parts in the above-described embodiment may also be adopted as a work vehicle management method. In such a case, the work vehicle management method is a work vehicle management method for managing a work vehicle for performing ground work on a predetermined work target, the work vehicle management method including: a first information acquisition step of acquiring first information including a work condition of the work target in the ground work carried out in the past, a device setting value for setting a capability of a device used in the past ground work, and a work result of the ground work performed in the past ground work; a second information acquisition step of acquiring second information including a work condition of the work target in the ground work to be carried out in the future; and a device setting value calculation step of calculating the device setting value for the device to be used in the ground work to be carried out in the future, based on the first information and the second information.

In the above-described embodiment, a work vehicle was described, but the processing performed by the functional parts in the above-described embodiment may also be adopted as a work vehicle management system. In such a case, the work vehicle management system is a work vehicle management system for managing a work vehicle for performing ground work on a predetermined work target, the work vehicle management system including: a first information acquisition unit 471 configured to acquire first information including a work condition of the work target in the ground work carried out in the past, a device setting value for setting a capability of a device used in the past ground work, and a work result of the ground work performed in the past ground work; a second information acquisition unit 472 configured to acquire second information including a work condition of the work target in the ground work to be carried out in the future; and a device setting value calculation unit 473 configured to calculate the device setting value for the device to be used in the ground work to be carried out in the future, based on the first information and the second information.

The functional parts in the above-described embodiment may also be adopted as a work vehicle management program. In such a case, the work vehicle management program can cause a computer to realize a work vehicle management program to be executed by a computer for managing a work vehicle for performing ground work on a predetermined work target, the work vehicle management program causing a computer to execute: a first information acquisition function of acquiring first information including a work condition of the work target in the ground work carried out in the past, a device setting value for setting a capability of a device used in the past ground work, and a work result of the ground work performed in the past ground work; a second information acquisition function of acquiring second information including a work condition of the work target in the ground work to be carried out in the future; and a device setting value calculation function of calculating the device setting value for the device to be used in the ground work to be carried out in the future, based on the first information and the second information.

Such a work vehicle management program can also be recorded on a recording medium.

### Fourth Embodiment

The management system according to the present invention manages a work vehicle that performs ground work on a pre-set work target. The pre-set work target is an object on which the work vehicle performs work with use of a functional part, a device, or the like included in the work vehicle. Specifically, if the work vehicle is a combine, the work target is a harvested material, if it is a rice transplanter, the work target is a planted object, and if a tractor performs cultivating or mowing, the work target is a field or the like. Also, if the work vehicle is a construction machine, it corresponds to soil, rock, wood, or the like. Ground work is work performed on a field or work site. In the present embodiment, the combine 20 will be described as an example of a work vehicle.

The management system according to the present invention can determine the state of the work vehicle. Hereinafter, a management system 700 of the present embodiment will be described.

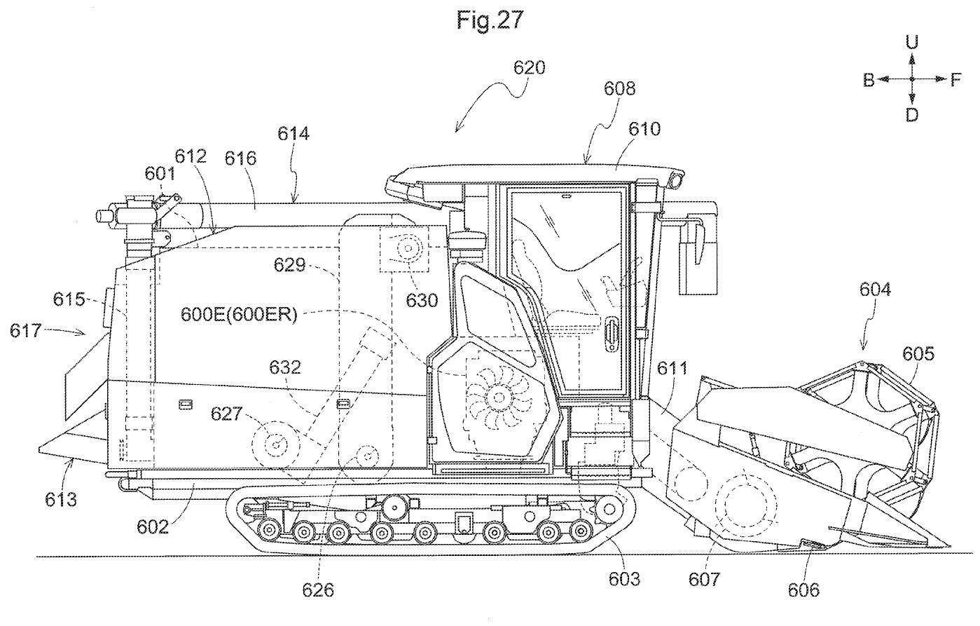

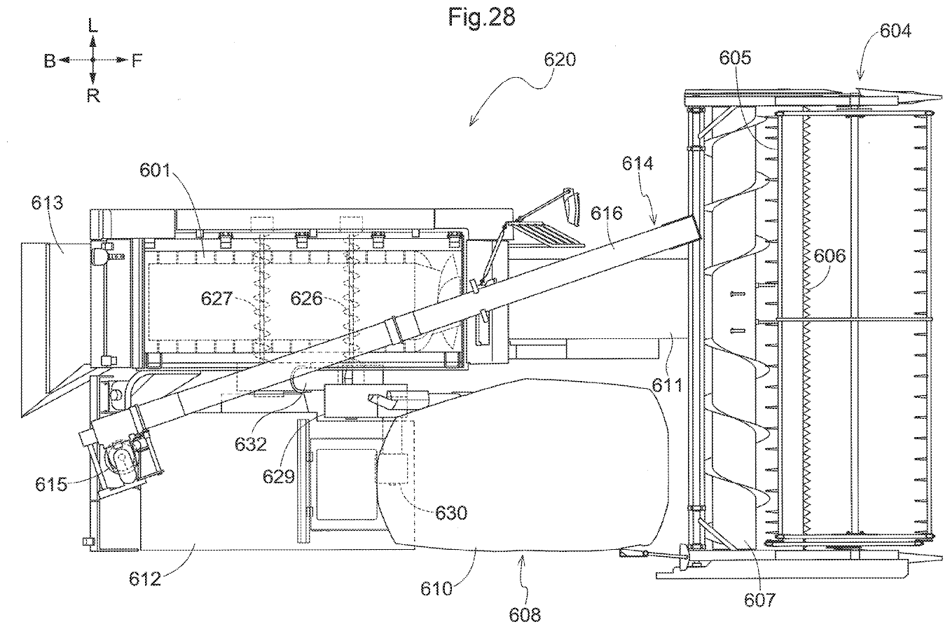

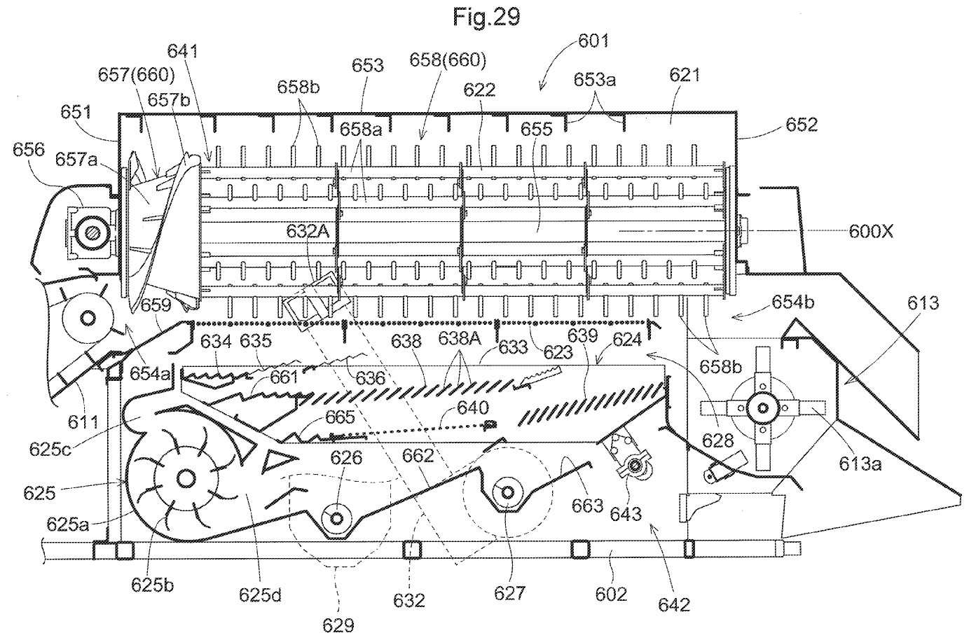

FIG. 27 is a side view of a combine 620 to be managed by the management system 700, and FIG. 28 is a plan view of the combine 620. Also, FIG. 29 is a cross-sectional view of a threshing apparatus 601 included in the combine 620. Note that hereinafter, the combine 620 will be described taking a so-called normal combine as an example. Of course, the combine 620 may also be a head-feeding combine.

Here, in order to facilitate understanding, in the present embodiment, unless otherwise specified, “front” (direction of arrow F shown in FIG. 27) means frontward in the body front-rear direction (traveling direction), and “rear” (direction of arrow B shown in FIG. 27) means rearward in the body front-rear direction (traveling direction). Also, “up” (direction of arrow U shown in FIG. 27) and “down” (direction of arrow D shown in FIG. 27) are positional relationships in the vertical direction (orthogonal direction) of the body, and indicate relationships in the above-ground height. Furthermore, the left-right direction or the lateral direction is the body crossing direction (body width direction) orthogonal to the body front-rear direction, that is, “left” (direction of arrow L shown in FIG. 28) and “right” (direction of arrow R shown in FIG. 28) mean the left direction and the right direction of the body, respectively.

As shown in FIGS. 27 and 28, the combine 620 includes a body frame 602 and a crawler traveling apparatus 603. The combine 620 has a reaping section 604 for reaping planted grain culms in the front of a traveling body 617. The reaping section 604 has a raking reel 605 for raking in the planted grain culms, a cutting blade 606 for cutting the planted grain culms, and an auger 607 for raking in the reaped grain culms.

The combine 620 has a driving section 608 on the front right side of the traveling body 617. The driving section 608 includes a cabin 610 in which a driver rides. The combine 620 has an engine room 600ER below the cabin 610, and the engine room 600ER accommodates not only an engine 600E but also an exhaust purification device, a cooling fan, a radiator, and the like. The motive power of the engine 600E is transmitted to a crawler traveling apparatus 603, and a threshing unit 641, a sorting unit 642, and the like, which will be described later, by a motive power transmission structure (not shown).

The threshing apparatus 601 that performs threshing processing on the reaped grain culms is provided rearward of the reaping section 604. The combine 620 has a feeder 611 that extends between the reaping section 604 and the threshing apparatus 601 and conveys the reaped grain culms to the threshing apparatus 601. The combine 620 has a grain tank 612 for storing the grains that have been threshed on a side of the threshing apparatus 601. The grain tank 612 is swingable and openable/closeable about an axis extending in the vertical direction, between a work position and a maintenance position. The combine 620 has a waste straw shredding apparatus 613 with a rotary blade 613a behind the threshing apparatus 601.

The combine 620 is provided with a grain discharging apparatus 614 for discharging the grains in the grain tank 612 to the outside. The grain discharging apparatus 614 includes a vertical conveying section 615 that conveys the grains in the grain tank 612 upward, and a lateral conveying section 616 that conveys the grains from the vertical conveying section 615 to the outside of the body of the combine. The grain discharging apparatus 614 is pivotable about the axis of the vertical conveying section 615. The lower end of the vertical conveying section 615 is in communication with and connected to the bottom of the grain tank 612. The end of the lateral conveying section 616 on the vertical conveying section 615 side is in communication with and connected to the upper end of the vertical conveying section 615 and is supported in such a manner as to be swingable up and down.

In the present embodiment, the threshing apparatus 601 is provided in the traveling body 617. The threshing apparatus 601 includes the threshing unit 641 and the sorting unit 642 as described above. The threshing unit 641 threshes the reaped grain culms reaped by the reaping section 604. The grains that have been threshed by the threshing unit 641 are discharged as threshed material. The sorting unit 642 sorts the threshed material discharged from the threshing unit 641 to obtain sorted material. Accordingly, the threshing unit 641 and the sorting unit 642 are provided in the traveling body 617. The threshing unit 641 is arranged at the upper portion of the threshing apparatus 601 and a receiving net 623 is provided below the threshing unit 641. The sorting unit 642 is arranged below the threshing unit 641 and sorts grains from the threshed material that has leaked from the receiving net 623. The sorting unit 642 includes a shake sorting apparatus 624, a primary material collection section 626, a secondary material collection section 627, and a secondary material returning section 632.

The threshing unit 641 accommodates a threshing drum 622 in a threshing chamber 621, and has a receiving net 623 below the threshing drum 622. The threshing chamber 621 is formed as a space surrounded by a front wall 651 on the front side, a rear wall 652 on the rear side, left and right side walls, and a top plate 653 covering the upper portion. The threshing chamber 621 has a supply port 654a to which the harvested material is supplied at a lower position on the front wall 651, and a guiding bottom plate 659 is arranged below the supply port 654a. The threshing chamber 621 also has a debris discharge port 654b on the lower side of the rear wall 652.

The threshing drum 622 has a drum body 660 and a rotation support shaft 655. As shown in FIG. 29, the drum body 660 is formed by integrating a raking section 657 at the front end and a threshing processing section 658 at a position behind the raking section 657. The raking section 657 includes a double-helical spiral blade 657b on the outer periphery of a tapered base 657a whose diameter becomes smaller toward the front end side of the threshing drum 622. The threshing processing section 658 has a plurality of rod-shaped threshing tooth support members 658a and a plurality of threshing teeth 658b. The plurality of rod-shaped threshing tooth support members 658a are provided spaced apart from each other at predetermined intervals in the peripheral direction of the drum body 660. Each of the plurality of threshing teeth 658b protrudes from the outer periphery of each of the plurality of threshing tooth support members 658a, and the threshing teeth 658b are attached spaced apart from each other at predetermined intervals along the rotation axis 600X in a front-rear-facing orientation.

The drum body 660 is coaxial with the rotation axis 600X, and rotates integrally with the rotation support shaft 655 that penetrates through the front wall 651 and the rear wall 652 in the front-rear direction. That is, the front end of the rotation support shaft 655 is rotatably supported by the front wall 651 via a bearing, and similarly, the rear end of the rotation support shaft 655 is rotatably supported by the rear wall 652 via a bearing. In this threshing unit 641, the driving rotational force is transmitted from the rotational drive mechanism 656 to the front end of the rotation support shaft 655.

The top plate 653 has, on its inner surface (lower surface), a plurality of plate-shaped debris transport valves 653a provided at predetermined intervals along the front-rear direction. The plurality of debris transport valves 653a are provided in an orientation that is inclined with respect to the rotation axis 600X in a plan view in such a manner as to exert a force that moves the processed material rotating together with the threshing drum 622 to the rear side in the threshing chamber 621. In the present embodiment, the attachment angle of the debris transport valve 653a with respect to the top plate 653 is changeable. The feed amount of the processed material in the drum body 660 is changeable by changing this angle.

The receiving net 623 is arc-shaped in a view in the direction of the rotational axis 600X in such a manner as to surround the region spanning from the lower side to both sides of the threshing drum 622, and has a configuration in which gaps through which the processed material can leak are formed by combining a plurality of vertical frames arranged at predetermined intervals along the front-rear direction and a lateral frame in a front-rear-facing orientation supported with respect to the vertical frames.

In the combine 620 of the present embodiment, the reaped grain culms supplied to the threshing chamber 621 are referred to as a harvested material, and the harvested material threshed in the threshing chamber 621 is referred to as a processed material (corresponds to “threshed material”). The processed material includes grains, cut straw, and the like. Also, the primary material is the processed material that mainly contains grains, and the secondary material is the processed material that contains grains that are not sufficiently processed into simple grains, cut straw, and the like.

In the threshing unit 641, the harvested material from the feeder 611 is supplied to the threshing chamber 621 via the supply port 654a. The supplied harvested material is raked toward the rear side of the threshing drum 622 along the guiding bottom plate 659 by the spiral blade 657b of the raking section 657, and is supplied to the threshing section 658. In the threshing section 658, threshing is performed as a result of the harvested material being subjected to threshing processing by the threshing teeth 658b and the receiving net 623 as the threshing drum 622 rotates.

While the threshing is performed in this manner, the processed material rotates together with the threshing drum 622, whereby the processed material comes into contact with the debris transport valve 653a and is subjected to threshing processing while being conveyed to the rear portion of the threshing chamber 621. The grains, short pieces of cut straw, and the like obtained through the threshing processing leak through the receiving net 623 and fall into the sorting unit 642. In contrast to this, the processed material (grain culms, long pieces of cut straw, etc.) that cannot leak through the receiving net 623 is discharged from the debris discharge port 654b to the outside of the threshing chamber 621.

As shown in FIG. 29, the sorting unit 642 includes a shake sorting apparatus 624 that sorts grains (primary material) from the processed material by shaking in an environment where a sorting wind is supplied from a winnower 625. Also, a primary material collection section 626 and a secondary material collection section 627 are arranged below the shake sorting apparatus 624.

The winnower 625 is provided in the sorting unit 642 and generates a sorting wind along the conveying direction of the processed material. The winnower 625 is constituted by accommodating a winnower main body having a plurality of rotary blades 625b inside the fan case 625a. An upper discharge port 625c for sending the sorting wind along the upper surface of the upper grain pan 661 and a rear discharging port 625d for sending the sorting wind rearward are formed on the upper portion of the fan case 625a.

The primary material collection section 626 collects the processed material as the primary material. The processed material is guided to the primary material collection section 626 by the primary material guiding section 662. The primary material collection section 626 is configured as a primary material screw that laterally conveys the primary material (the grains of the primary material) guided by the primary material guiding section 662. The primary material collected by the primary material collection section 626 is conveyed upward (lifted) to the grain tank 612 by the primary material collection/conveying section 629. Accordingly, the sorted material sorted by the sorting unit 642 is conveyed to and stored in the grain tank 612. The primary material conveyed by the primary material collection/conveying section 629 is conveyed to the right by the storage screw 630 and supplied to the grain tank 612. The primary material collection/conveying section 629 corresponds to a bucket-type conveyor.

The secondary material collection section 627 collects, as the secondary material, the processed material that has not been sorted as the sorted material among the threshed material. The sorted material is grains sorted by the shake sorting apparatus 624, although the details will be described later. For this reason, the processed material that was not sorted as the sorted material corresponds to the grains, grain culms, long pieces of cut straw, and the like that were not sorted by the shake sorting apparatus 624, and is called the secondary material. Such secondary material is guided to the secondary material collection section 627 by the secondary material guiding section 663. The secondary material collection section 627 is configured as a secondary material screw that laterally conveys the secondary material guided by the secondary material guiding section 663. The secondary material collected by the secondary material collection section 627 is conveyed diagonally upward and frontward by the secondary material returning section 632 and thus is returned to the upper side (upstream side) of the shake sorting apparatus 624. The secondary material returning section 632 corresponds to a screw-type conveyor.

The primary material collection section 626 and the secondary material collection section 627 are driven by the motive power of the engine 600E transmitted by a motive power transmission structure (not shown).

The motive power of the engine 600E is transmitted to the primary material collection section 626, is transmitted from the primary material collection section 626 to the primary material collection/conveying section 629, and is transmitted from the primary material collection/conveying section 629 to the storage screw 630. The primary material collection/conveying section 629 is provided on the right side of the threshing apparatus 601 (outside of the right wall).

The motive power of the engine 600E is transmitted to the secondary material collection section 627, and is transmitted from the secondary material collection section 627 to the secondary material returning section 632. The secondary material returning section 632 is provided on the right side of the threshing apparatus 601 (outside of the right wall).

The shake sorting apparatus 624 sorts grains from the processed material. The shake sorting apparatus 624 is arranged below the receiving net 623, and the processed material leaks from the receiving net 623. This shake sorting apparatus 624 includes a frame-shaped sieve case 633 that is shaken in the front-rear direction by an eccentric-cam-type shake driving mechanism 643 that uses an eccentric shaft or the like, the frame-shaped sieve case 633 being formed in a rectangular shape in a view from above.

The sieve case 633 includes a first grain pan 634, a plurality of first sieve lines 635, a second sieve line 636, a first chaff sieve 638, a second chaff sieve 639, a grain sieve 640, an upper grain pan 661, and a lower grain pan 665.

The first chaff sieve 638, which has a plurality of chaff lips 638A, is arranged rearward of the upper grain pan 661, and a second chaff sieve 639 is arranged rearward of the first chaff sieve 638. Note that the plurality of chaff lips 638A are arranged along the conveying direction (rearward direction) in which the processed material is conveyed, and each of the plurality of chaff lips 638A is arranged in an inclined orientation of being inclined upward toward the rear end side. In the present embodiment, the opening degree of each of the chaff lips 638A is changeable. The opening degree being changeable means that the inclined orientation is changed. Specifically, the closer the chaff lips 638A are to being parallel to the front-rear direction, the smaller the opening degree is, and the closer the chaff lips 638A are to being parallel to the vertical direction, the larger the opening degree is. The lower grain pan 665 is arranged below the front end of the first chaff sieve 638, and the grain sieve 640, which is a net-like body, is arranged at a position continuous with the rear side of the lower grain pan 665. The second chaff sieve 639 described above is below the rear end of the first chaff sieve 638 and is arranged rearward of the grain sieve 640.

The sieve case 633 has an air passage through which the sorting wind supplied from an upper discharge port 625c of the winnower 625 is supplied along the upper surface of the upper grain pan 661 and an air passage through which the sorting wind supplied from a rear discharge port 625d of the winnower 625 is supplied along the upper surface of the lower grain pan 665. The rear end of the shake sorting apparatus 624 (the right end in FIG. 29) and the rear end of the receiving net 623 form a discharging section 628.

In the shake sorting apparatus 624 of the present embodiment, the sorting wind from the winnower 625 is supplied from the body front side to the body rear side, and the processed material inside of the sieve case 633 is conveyed to the body rear side due to the sieve case 633 being shaken by the shake driving mechanism 643. For this reason, in the following description, in the shake sorting apparatus 624, the upstream side in the conveying direction of the processed material is referred to as a front end or a front side, and the downstream side is referred to as a rear end or a rear side.

The grain sieve 640 is configured as a net-like body in which a plurality of wire members made of metal are combined in a net-like manner, and allows grains to leak from the mesh. A first chaff sieve 638 is provided above the grain sieve 640, and the grains that flow between the chaff lips 638A of the first chaff sieve 638 leak to the grain sieve 640.

Due to such a configuration, the processed material that leaks from the receiving net 623 in the sorting unit 642 and is received by the upper grain pan 661 is supplied to the front end of the first chaff sieve 638 as the sieve case 633 shakes. Also, the sieve case 633 receives most of the processed material leaking from the receiving net 623.

The first chaff sieve 638 allows the grains contained in the processed material to leak through, while simultaneously conveying the processed material to the rear side through wind sorting by the sorting wind and specific-gravity sorting accompanying the shaking. Culms such as cut straw in the processed material subjected to such sorting are delivered to the second chaff sieve 639, are sent out from the rear end of the second chaff sieve 639 to the rear of the sieve case 633, and are discharged from the discharging section 628 toward the waste straw shredding apparatus 613. The culms discharged from the discharging section 628 are shredded by the waste straw shredding apparatus 613 and are discharged to the outside of the threshing apparatus 601. Also, the grains leaking directly to the second chaff sieve 639 via the receiving net 623 are sorted into grains and culms such as cut straw by the second chaff sieve 639.

Here, considering the state of the processed material leaking from the receiving net 623, grains, grains that are not sufficiently processed into simple grains, or small pieces of straw in the harvested material supplied to the threshing chamber 621 leak through the receiving net 623 at an early stage when conveyed inside the threshing chamber 621. For this reason, the amount of leakage of the processed material in the upstream region in the conveying direction of the receiving net 623 tends to be larger than that in the downstream region in the conveying direction. Also, as described above, since the processed material is supplied from the upper grain pan 661 to the front end of the first chaff sieve 638, the amount of the processed material leaking from the front end of the first chaff sieve 638 is larger than that on the rear end side.

Also, the processed material that leaked from the front end side of the first chaff sieve 638 is removed by sending a portion thereof to the rear side by the sorting wind immediately after leaking, and the processed material containing a large amount of grains is received on the upper surface of the grain sieve 640. Furthermore, since the wind pressure of the sorting wind and the shaking force act on the processed material supplied to the grain sieve 640, the straw and the like included in the processed material is sent rearward on the upper surface of the grain sieve 640 and many grains are included in the processed material that leaks from the grain sieve 640. The grains that leaked from the grain sieve 640 flow down from the primary material guiding section 662 to the primary material collection section 626, are collected therein, and are stored in the grain tank 612 by the primary material collection/conveying section 629.

Also, the processed material from the region on the rear side of the first chaff sieve 638 is supplied to the grain sieve 640, but the cut straw in the processed material that did not leak in the grain sieve 640 is sent rearward by the sorting wind, and therefore the sorting processing is performed without significantly reducing the sorting efficiency in the region on the rear side of the grain sieve 640.

Also, the primary material (grains) that leaked in front of the rearmost end of the grain sieve 640 flows down from the primary material guiding section 662 to the primary material collection section 626, is collected therein, and is stored in the grain tank 612 by the primary material collection/conveying section 629.

In contrast to this, the processed material that leaked from the portion at the rearmost end of the grain sieve 640 or the processed material that fell from the second chaff sieve 639 flows down from the secondary material guiding section 663 to the secondary material collection section 627 and is collected therein, and is returned to the upstream side of the shake sorting apparatus 624 by the secondary material returning section 632. Then, debris such as straw waste serving as the third processed material generated through the sorting processing is sent rearward from the rear end of the shake sorting apparatus 624, and is discharged from the discharging section 628 to the waste straw shredding apparatus 613.

As described above, the secondary material is returned to the upstream side, which is the front portion of the shake sorting apparatus 624, by the secondary material returning section 632. Specifically, the secondary material is returned to a portion on the side of the receiving net 623 in the threshing unit 641, which is a position at which the secondary material does not pass through (does not flow through) the receiving net 623. Accordingly, the secondary material discharge port 632A of the secondary material returning section 632 is provided at a position on the outer side in the radial direction of the arc-shaped receiving net 623, and the secondary material is discharged at this position.

As described above, in the combine 620, threshing work for the reaped grain culms reaped in the field is performed by the threshing unit 641 and the sorting unit 642 included in the threshing apparatus 601. Accordingly, in the combine 620, the above-described “ground work” corresponds to the threshing work.

Since the threshing unit 641 and the sorting unit 642 are used in such threshing work, there is a possibility that the state of the threshing unit 641 and the sorting unit 642 may change from a new state due to aging or the like. In such a situation, if a satisfactory result of ground work (threshing work in this embodiment) cannot be obtained, it is assumed that maintenance or the like will be carried out.

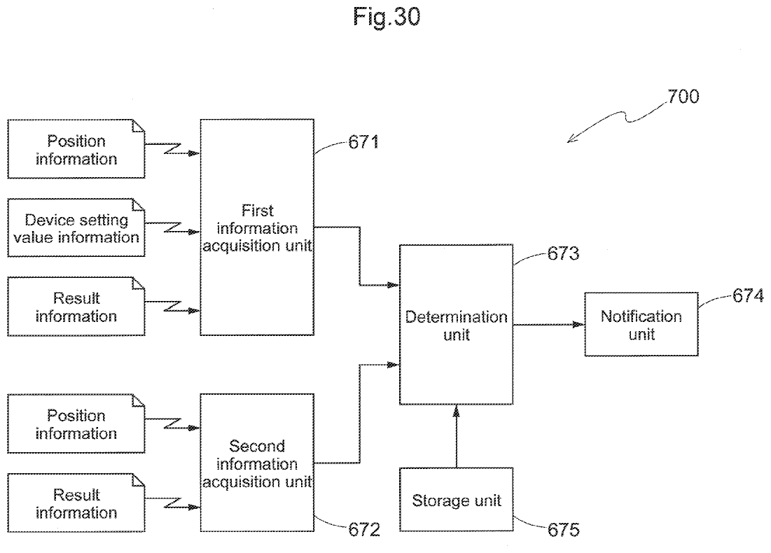

In view of this, the management system 700 of the present embodiment can determine the state of the combine 620. Hereinafter, the determination of the state of the combine 620 will be described with reference to FIG. 30. The management system 700 of the present embodiment is constituted by including each of a first information acquisition unit 671, a second information acquisition unit 672, a determination unit 673, a notification unit 674, and a storage unit 675. Each functional part is constructed with hardware, software, or both with a CPU as a core member in order to perform processing relating to determination of the state of the combine 620 described above.

The first information acquisition unit 671 acquires the first information relating to the ground work, which was stored when the ground work was carried out in the past. The ground work in the past is harvesting work performed when the combine 620 harvested the crop in the field in the past. For this reason, the first information relating to the ground work is information relating to the harvesting work performed in the past by the combine 620, and is referred to as the first information in the present embodiment.

In the present embodiment, the first information includes information relating to the work target in the ground work that has already been performed and information relating to the combine 620 at the time when the ground work was performed. The work target in the ground work that has been carried out is threshing work that was performed when the crop was harvested in the field. Accordingly, the information relating to the work target in the ground work that has already been carried out corresponds to information relating to the threshing work that was performed when the combine 620 harvested the crop in the field in the past. The information relating to the threshing work is, for example, position information indicating the position of the field where the crop that was subjected to the threshing work was harvested, and result information that indicates the result of the threshing work performed when the crop was harvested in the field. The information relating to the combine 620 obtained when the ground work was carried out is device setting value information indicating the device setting value for setting the capability of the threshing apparatus 601 used in the threshing work performed when the crop was harvested in the field.

The position information indicating the position of the field is information indicating the latitude, longitude, and altitude of the field, and for example, when the combine 620 performs harvesting work in the field, the position information may be acquired by a GPS device (not shown) and stored in the storage unit of the combine 620, or it may be stored in the management system 700 connected by a network.

The result of the threshing work performed when the crop was harvested in the field is the result of the threshing work performed when the combine 620 harvested the crop in the field in the past. Specifically, it is a calculation result of the amount of foreign matter stored in the grain tank 612. The amount of such foreign matter can also be calculated, for example, based on a captured image of the processed material that has been subjected to threshing processing in the threshing apparatus 601 and conveyed to the grain tank 612, or can be calculated based on a captured image of the situation when the stored grains are discharged from the grain tank 612 of the combine 620 to a grain transport vehicle via the grain discharging apparatus 614. Of course, the amount of foreign matter can also be calculated by other methods.

Also, the device setting value for setting the capability of the threshing apparatus 601 corresponds to a control parameter of the threshing apparatus 601 that performs the threshing processing, and specifically corresponds to a threshing setting parameter according to which the threshing capability of the threshing unit 641 included in the threshing apparatus 601 is settable or a sorting parameter according to which the sorting capability of the sorting unit 642 is settable. The threshing parameters according to which the threshing capability in the threshing unit 641 is settable correspond to the setting value for setting the rotation speed of the rotation support shaft 655 of the threshing drum 622 and the setting value for setting the attachment angle of the debris transport valve 653a with respect to the top plate 653. Also, the sorting parameters according to which the sorting capability in the sorting unit 642 is settable correspond to a setting value for setting the air volume of the sorting wind from the winnower 625, a setting value for setting the opening degree of the chaff lips 638A, and a setting value for setting the shake speed and shake amount of the shake driving mechanism 643 that shakes the shake sorting apparatus 624.

Accordingly, the device setting value for setting the capability of the threshing apparatus 601 used in the threshing work performed when the crop was harvested in the field corresponds to a setting value for setting the rotation speed of the rotation support axis 655 of the threshing drum 622 used in the threshing work performed when the combine 620 harvested the crop in the field in the past, a setting value for setting the attachment angle of the debris transport valve 653a to the top plate 653, a setting value for setting the air volume of the sorting wind from the winnower 625, a setting value for setting the opening degree of the chaff lips 638A, and a setting value for setting the shake speed and shake amount of the shake driving mechanism 643 for shaking the shake sorting apparatus 624. Such setting values may also be stored in the storage unit of the combine 620 or may be stored in the management system 700 connected by the network.

In the present embodiment, the above-mentioned position information indicating the position of the field where the threshing work was performed when the crop was harvested in the field in the past, the result information indicating the result of the threshing work performed when the crop was harvested in the field in the past, and the device setting value information indicating the setting value for the device used in the threshing work performed in the past are treated as the first information and are acquired by the first information acquisition unit 671.

The second information acquisition unit 672 acquires information relating to the ground work currently being carried out. The above-described first information is information relating to the ground work carried out in the past. On the other hand, the second information acquisition unit 672 acquires information relating to the work target in the ground work currently being carried out as the second information. Specifically, the ground work is threshing work that is currently being performed during harvesting in the field. Accordingly, the information relating to the ground work currently being carried out corresponds to the information relating to the threshing work currently carried out by the combine 620 while harvesting the crop in the field. The information relating to the threshing work is, for example, position information indicating the position of the field currently being harvested, or result information indicating the result of the threshing work currently being performed. Since the position information and the result information have been described above, description thereof will be omitted.

The determination unit 673 determines the state of the combine 620 by comparing the first information and the second information. The first information is transmitted from the first information acquisition unit 671, and the second information is transmitted from the second information acquisition unit 672. The state of the combine 620 is the state of the combine 620 from the viewpoint of whether or not the combine 620 can perform ground work on a predetermined work target as a work vehicle, and the determination unit 673 determines the state.

Specifically, the determination unit 673 determines whether or not the combine 620 is abnormal as the state of the combine 620. The combine 620 being abnormal refers to a state in which the combine 620 cannot properly travel in the field in order to perform the harvesting work, a state in which the threshing work for the harvested crop cannot be performed properly, a state in which the grains in the grain tank 612 cannot be properly discharged to the outside via the grain discharging apparatus 614, or the like. Note that in the present embodiment, not only is a state in which the above-mentioned running, threshing work, and discharging cannot be performed completely referred to as an abnormality, but a state in which the original capability cannot be exhibited is also referred to as an abnormality. The determination unit 673 compares the first information and the second information to determine whether or not the current state of the combine 620 is abnormal, that is, whether or not each functional part of the current combine 620 is the same as the state of the past functional part (whether or not the output of the current functional part falls within a predetermined range with respect to the output of the past functional part).

Also, the determination unit 673 determines the maintenance time of the combine 620 as the state of the combine 620. The maintenance time of the combine 620 is a time at which each functional part of the current combine 620 described above is expected to no longer be the same as the state of the past functional part (no longer fall within the predetermined range). For example, the current state and the past state can be continuously compared, and such a time can be predicted based on an increase or a decrease in the difference. In this manner, the determination unit 673 compares the first information and the second information and determines the time when maintenance of the combine 620 is needed.

Here, it is preferable that the determination unit 673 determines the state of the combine 620 by inputting the first information and the second information to a neural network that has undergone training to determine the state of the combine 620 based on the first information and predetermined information relating to ground work. Here, the neural network is an algorithm that imitates the human brain and is executed by a computer, and for example, outputs the result of determining the state of the combine 620 as a result similar to that obtained through distinction made by a human brain when the above-mentioned first information and the second information are input. As the neural network of the present embodiment, a neural network that has been trained in advance to be able to appropriately determine the state of the combine 620 is used.

Specifically, in the present embodiment, as the neural network, a neural network is used which has been trained such that, if the neural network receives input of information relating to the ground work performed in the case where the combine 620 is in a predetermined state as teacher data, the determination result of the degree of abnormality of the combine 620 according to the predetermined state (abnormality degree) and the determination result of the maintenance time are output. That is, before inputting the above-described second information to the neural network, for example, information and a label relating to the ground work of the combine 620 having a predetermined abnormality degree and information and a label relating to the ground work of the combine 620 that is not abnormal are provided in advance to learn the characteristics of the abnormality degree for each label. This makes it possible to easily determine whether or not the combine 620 is abnormal when the second information is provided. Note that it is also possible to continuously perform this learning in the combine 620.

Similarly, when determining the maintenance time, for example, information and a label relating to the ground work of the combine 620 that has time until the maintenance time, and information and a label relating to the ground work of the combine 620 that is to undergo maintenance are provided in advance, and the characteristics of the maintenance time for each label is learned. This makes it possible to easily determine the maintenance time of the combine 620 when the second information is provided.

In other words, it is preferable that the determination unit 673 inputs the first information and the second information to a neural network that has undergone training to output the determination result that the combine 620 is abnormal if information relating to ground work performed when the combine 620 is abnormal is input as the teacher data, and training to output the determination result of the maintenance time of the combine 620 if information relating to ground work performed when maintenance of the combine 620 is required is input as teacher data.

The notification unit 674 performs notification of the determination result of the determination unit 673. The determination result is transmitted from the determination unit 673 to the notification unit 674. For example, the notification unit 674 may be configured such that a display device is provided on the combine 620 and the determination result of the determination unit 673 is displayed on the display device. As a result, the operator can keep track of the state of the combine 620 and can take appropriate measures.

The storage unit 675 continuously stores the determination result of the determination unit 673. The above-described determination result of the determination unit 673 can be effectively utilized by being stored in the storage unit 675 of the management system 700 and being referenced, for example, when the operator analyzes the state of the combine 620. Of course, the determination result stored in the storage unit 675 can be deleted after a predetermined period of time has elapsed since the determination result was stored.

In the above-described embodiment, the work vehicle was described taking, as an example, a normal combine, but the work vehicle may also be a head-feeding combine. Also, the work vehicle may be a rice transplanter or a tractor. Also, it may be an agricultural machine other than these, or it may be a construction machine.

In the above-described embodiment, the first information was described as including information relating to the work target in the ground work that has already been carried out and information relating to the combine 620 when the ground work was carried out, and the second information was described as including information relating to the work target in the ground work that is currently being carried out, but the first information and the second information can also respectively include information other than the above-mentioned information.

In the above-described embodiment, the determination unit 673 was described as determining whether or not the combine 620 is abnormal, and determining the maintenance time of the combine 620, but the determination unit 673 can also perform either the determination of whether or not the combine 620 is abnormal or the determination of the maintenance time of the combine 620, or can perform a determination different from those above.

In the above-described embodiment, the management system 700 was described as including the notification unit 674 and the storage unit 675, but the management system 700 need not include both the notification unit 674 and the storage unit 675, and may include one of them.

In the above-described embodiment, the determination of the state of the combine 620 was described as being performed by inputting the first information and the second information to a neural network that has undergone training to output the state of the combine 620 based on the first information and predetermined information relating to ground work, but the determination of the state of the combine 620 can also be performed without using a neural network.

In the above-described embodiment, it was described that it is preferable that the determination unit 673 inputs the first information and the second information to a neural network that has undergone training to output the determination result indicating that the combine 620 is abnormal if information relating to ground work performed when the combine 620 is abnormal is input as the teacher data, and training to output the determination result of the maintenance time of the combine 620 if information relating to ground work performed when maintenance of the combine 620 is needed is input as teacher data, but it is possible to use one of the training to output the determination result indicating that the combine 620 is abnormal and the training to output the determination result of the maintenance time of the combine 620.

In the above-described embodiment, the management system was described, but the processing performed by the functional parts in the above-described embodiment may also be adopted as a management method. In such a case, the management method is a management method for managing a work vehicle for performing ground work on a predetermined work target, the management method including: a first information acquisition step of acquiring first information relating to the ground work, the first information having been stored when the ground work was carried out in the past; a second information acquisition step of acquiring second information relating to the ground work that is currently being carried out; and a determination step of determining a state of the work vehicle by comparing the first information and the second information.

The functional parts in the above-described embodiment may also be adopted as a management program. In such a case, the management program is a management program to be executed by a computer for managing a work vehicle for performing ground work on a predetermined work target, the management program causing a computer to execute: a first information acquisition function of acquiring first information relating to the ground work, the first information having been stored when the ground work was carried out in the past; a second information acquisition function of acquiring second information relating to the ground work that is currently being carried out; and a determination function of determining a state of the work vehicle by comparing the first information and the second information.

Such a management program can also be recorded on a recording medium.

The management method can also be a management method for managing a work vehicle for performing ground work on a predetermined work target, the management method including: a first information acquisition step of acquiring first information relating to the ground work, the first information having been stored when the ground work was carried out in the past; a second information acquisition step of acquiring second information relating to the ground work that is currently being carried out; and a determination step of determining a state of the work vehicle by comparing the first information and the second information, in which the determination step is performed by inputting the first information and the second information are input to a neural network that has undergone at least one of training to output a determination result that the work vehicle is abnormal if information relating to the ground work performed when the vehicle is abnormal is input as teacher data, and training to output a determination result of a maintenance time of the work vehicle if information relating to the ground work performed when maintenance of the work vehicle is needed is input as teacher data.

Furthermore, the management program can also be a management program to be executed by a computer for managing a work vehicle for performing ground work on a predetermined work target, the management program including: a first information acquisition function of acquiring first information relating to the ground work, the first information having been stored when the ground work was carried out in the past; a second information acquisition function of acquiring second information relating to the ground work that is currently being carried out; and a determination function of determining a state of the work vehicle by comparing the first information and the second information, in which the determination function is performed by inputting the first information and the second information to a neural network that has undergone at least one of training to output a determination result that the work vehicle is abnormal if information relating to the ground work performed when the work vehicle is abnormal has been input as teacher data, and training to output a determination result of a maintenance time of the work vehicle if information relating to the ground work performed when maintenance of the work vehicle is needed has been input as teacher data.

Such a management program can also be recorded on a recording medium.

### INDUSTRIAL APPLICABILITY

The present invention can be applied to a technique for controlling the state of a threshing apparatus that performs threshing processing.

The present invention can also be applied to a harvester management system for a harvester that harvests agricultural materials, a harvester including such a harvester management system, and a technique for such a harvester.

Also, the present invention can be used in a technique for performing ground work on a predetermined work target.

### DESCRIPTION OF REFERENCE SIGNS

First Embodiment
1 Threshing apparatus
21 Threshing chamber
22 Threshing drum
25 Winnower
33 Sieve case
38A Chaff lip
39 Second chaff sieve
40 Grain sieve
41 Threshing drum section
42 Sorting section
53a Debris transport valve
7 Threshing state management unit
71 Pre-processing unit
72 State detection neural network
72A First state detection neural network
72B Second state detection neural network
73 Parameter determination unit
80 Image capture unit
81 Camera
100 Control device
CU Reaping control unit
D1 Travel operation device
D3 Threshing operation device
RU Travel control unit
S1 Travel state sensor
S2 Threshing state sensor
TU Threshing control unit
T1 Chaff opening degree control unit
T2 Winnower wind force control unit
T3 Valve angle control unit

Second Embodiment
201 Threshing apparatus
204 Reaping section (harvesting section)
212 Grain tank (storage section)
221 Threshing chamber
222 Threshing drum
224 Sieve case
240 Grain sieve
241 Threshing drum section
242 Sorting section
243 Shake sorting mechanism
253a Debris transport valve
207 Threshing loss management unit
271 Pre-processing unit
272 Loss amount neural network
272A First loss amount neural network
272B Second loss amount neural network
272C Third loss amount neural network
273 Loss rate calculation unit
274 Parameter determination unit
280 Image capture unit (detection unit)
281 First camera
282 Second camera
283 Third camera
300 Control device
200CU Reaping control unit
200M1 Yield measurement device

Third Embodiment
401 Threshing apparatus (device)
420 Combine (work vehicle)
471 First information acquisition unit
472 Second information acquisition unit
473 Device setting value calculation unit
474 Setting value instruction unit

Fourth Embodiment
620 Combine (work vehicle)
671 First information acquisition unit
672 Second information acquisition unit
673 Determination unit
674 Notification unit
675 Storage unit
700 Management system

1. A threshing state management system configured to manage a state of a threshing apparatus for performing threshing processing on grain culms reaped while traveling, the threshing state management system comprising:
an image capture unit configured to capture an image of threshed material threshed by the threshing apparatus;
a state detection neural network configured to output a threshing processing state in the threshing apparatus based on image input data generated based on a captured image from the image capture unit;
a parameter determination unit configured to determine a control parameter of the threshing apparatus based on the threshing processing state; and
a threshing control unit configured to control the threshing apparatus based on the control parameter.

2. The threshing state management system according to claim 1, further comprising
a travel state sensor configured to detect a travel state, and
wherein state input data indicating the travel state generated based on a detection signal from the travel state sensor is input to the state detection neural network.

3. The threshing state management system according to claim 1,
wherein the state detection neural network is trained using, as training data, a training captured image captured during the threshing processing and an estimated threshing processing state estimated based on the training captured image.

4-9. (canceled)

10. A harvester management system for managing harvested material loss in a harvester comprising a harvesting section for harvesting a crop in a field and a storage section for storing harvested material harvested by the harvesting section, the harvester management system comprising:
a harvest amount measurement unit configured to measure a harvest amount of the harvested material;
a loss amount calculation unit configured to calculate a loss amount indicating an amount of loss that occurs while the harvested material is conveyed from the harvesting section to the storage section; and
a loss rate calculation unit configured to calculate a loss rate, which is the loss amount per unit harvest amount, based on the harvest amount and the loss amount.

11. The harvester management system according to claim 10, further comprising
a detection unit configured to detect the loss in a loss region where the loss occurs, and
wherein the loss amount calculation unit outputs the loss amount based on a detection result from the detection unit.

12. The harvester management system according to claim 11,
wherein an image capture unit configured to capture an image of the loss region in which the loss occurs is included as the detection unit, and
wherein the loss amount calculation unit is included as a neural network configured to output the loss amount based on image input data generated based on the captured image from the image capture unit.

13. The harvester management system according to claim 12,
wherein the neural network is trained using, as training data, training image input data generated based on a training captured image captured during harvesting work performed by the harvester and an estimated loss amount actually estimated based on the training captured image.

14-16. (canceled)

17. The harvester management system according to claim 10,
wherein the harvester comprises a threshing apparatus configured to perform threshing processing on the harvested material, and
wherein the loss region in which the loss occurs comprises a threshing drum terminal end region and a sieve case rear end region in the threshing apparatus.

18. The harvester management system according to claim 10,
wherein the harvester comprises a threshing apparatus configured to perform threshing processing on the harvested material, and
wherein the loss region in which the loss occurs comprises a discharging section region where non-grains that are not grains are discharged from the threshing apparatus.

19. The harvester management system according to claim 10, further comprising:
a parameter determination unit configured to determine a control parameter of the harvester based on the loss rate.

20-25. (canceled)

26. A work vehicle for performing ground work on a predetermined work target, the work vehicle comprising:
a first information acquisition unit configured to acquire first information including a work condition of the work target in the ground work carried out in the past, a device setting value for setting a capability of a device used in the past ground work, and a work result of the ground work performed in the past ground work;
a second information acquisition unit configured to acquire second information including a work condition of the work target in the ground work to be carried out in the future; and
a device setting value calculation unit configured to calculate the device setting value for the device to be used in the ground work to be carried out in the future, based on the first information and the second information.

27. The work vehicle according to claim 26, further comprising:
a setting value instruction unit configured to apply the calculated device setting value to the device when the ground work is to be carried out in the future, and
wherein the setting value instruction unit applies the device setting value in the case where a work site where the past ground work was carried out and a work site where the ground work is to be carried out in the future are the same.

28. The work vehicle according to claim 26,
wherein the device setting value calculation unit automatically and continuously calculates the device setting value while the ground work is being carried out.

29. (canceled)

30. The work vehicle according to claim 26,
wherein the work condition of the work target comprises position information indicating a position of a work site where the ground work is to be performed.

31. The work vehicle according to claim 26,
wherein the ground work is threshing work for performing threshing processing on reaped grain culms reaped in a field, and
wherein the device setting value is a control parameter of a threshing apparatus configured to perform the threshing processing.

32. The work vehicle according to claim 26,
wherein the calculation of the device setting value for the device to be used in the ground work to be carried out in the future is performed by inputting the first information and the second information to a neural network that has undergone training to calculate the device setting value based on the first information and the predetermined work condition.

33-36. (canceled)

37. A management system for managing a work vehicle for performing ground work on a predetermined work target, the management system comprising:
a first information acquisition unit configured to acquire first information relating to the ground work, the first information having been stored when the ground work was carried out in the past;
a second information acquisition unit configured to acquire second information relating to the ground work that is currently being carried out; and
a determination unit configured to determine a state of the work vehicle by comparing the first information and the second information.

38-39. (canceled)

40. The management system according to claim 37,
wherein the determination unit determines a maintenance time of the work vehicle as the state of the work vehicle.

41-42. (canceled)

43. The management system according to claim 37,
wherein the determination of the state of the work vehicle is performed by inputting the first information and the second information to a neural network that has undergone training to determine the state of the work vehicle based on the first information and predetermined information relating to the ground work.

44. The management system according to claim 37,
wherein the determination unit inputs the first information and the second information to a neural network that has undergone at least one of training to output a determination result indicating that the work vehicle is abnormal if information relating to the ground work performed when the vehicle is abnormal is input as teacher data, and training to output a determination result of a maintenance time of the work vehicle if information relating to the ground work performed when maintenance of the work vehicle is needed is input as teacher data.

45-50. (canceled)
